(19) United States
(12) Patent Application Publication
(10) Pub. No.: US 2026/0246350 A1
(43) Pub. Date: Aug. 20, 2026

(54) METHOD AND APPARATUS FOR MANUFACTURING A STATOR FOR ELECTRIC MOTORS

(71) Applicant: MARSILLI S.P.A., Castelleone (IT)

(72) Inventor: Gian Battista PARATI, Castelleone CR (IT)

(73) Assignee: MARSILLI S.P.A., Castelleone, CR (IT)

(21) Appl. No.: 19/161,558

(22) PCT Filed: Dec. 28, 2023
(86) PCT No.: PCT/IB2023/063309

§ 371 Date: Sep. 2, 2025

(30) Foreign Application Priority Data
Mar. 3, 2023 (IT) 102023000003912

(51) Int. Cl. H02K 15/043; H01F 41/061; H02K 15/066

(52) U.S. Cl. CPC H02K 15/0431; H01F 41/061; H02K 15/066

(57) ABSTRACT

A method and an apparatus for manufacturing a star yoke stator for electric motors with distributed winding, as well as a stator achieved with the method described, are described. A two-component stator is provided with a central star-shaped element provided with radial stator teeth and stator slots interposed between the teeth, and a yoke into which the star is inserted with the windings included in the stator slots. The assembly method provides for positioning the star on a rotating spindle and for inserting the linear portions of coils of wire, previously formed on a winding tool and preferably pressed and carburized, into the stator slots, so that to keep the arrangement of the wires in order. The windings are completed by alternating the movements of inserting coils into the stator slots and of rotating the star. The yoke can be coupled to the star in a final step, whenever the yoke is made in one piece, or can be constructed around the star by coupling sectors of the yoke as the windings are completed. An apparatus configured for implementing the method described is further described. The invention further concerns a stator directly obtained with the method described and an electric motor integrating the stator. Greater filling coefficient, greater efficiency, less leakage currents and reduced stator height are achieved.

### FIELD OF THE INVENTION

The present invention concerns a method and an apparatus for manufacturing a stator for electric motors, in particular a two-component stator (also known as star and yoke stator), as well as a stator manufactured with such method.

### KNOWN ART

As is known, the stators of electric motors are generally cylinder-shaped and comprise a plurality of poles formed by stator teeth arranged along the inner circumference of the cylinder and which are jutting out towards a common central axis. The central axis coincides with the rotation axis of the rotor which is combined with the stator in the completed electric motor, according to a configuration coaxial with the stator on the outside and with the rotor on the inside.

One or more windings of conducting wires, also named coils, are placed in the sectors constituted by the space between the stator teeth, more commonly named stator slots.

Among the stators, there are the concentrated winding ones, in which the conducting wires are wound on an individual stator tooth, and the distributed winding ones, in which the conducting wires are wound on two or more teeth. The present invention particularly concerns the making of a distributed winding stator.

In the known art, in order to make a distributed winding stator, the cylindrical body of the stator is made by first assembling the teeth and—aside on the outside of the body of the stator—one or more coils of conducting wire, which coils are then inserted into the stator slots of the already formed cylindrical body.

The ends of the stator teeth are commonly named pole shoes. In a conventional stator, an opening, named slot opening, of sufficient size for carrying out the insertion of the coils is present between the pole shoes of two adjacent teeth.

However, there are stators into which the insertion of the coils cannot occur in the way just described as these stators are devoid of slot openings. An example is constituted by the star yoke stators. These are two-component stators: an outer cylindrical body commonly named yoke, and an inner body, named star, generally constituted by a pack of stacked metal laminations. The star takes its name from its geometric configuration, which provides an inner cylindrical surface defined by the pole shoes of all stator teeth, and from the stator teeth themselves, which stator teeth extend radially outwardly from the inner cylindrical surface. The inner cylindrical surface of the star is substantially continuous, except for small windows or openings made to lighten the stator and minimize electromagnetic short-circuit phenomena. The coils cannot thus be inserted between the pole shoes of adjacent stator teeth but are inserted into the stator slots from the outside, before the star is in turn inserted into the yoke.

In the two-component or star yoke stators, the yoke is a cylinder whose inner surface is appropriately machined for forming seats for housing the stator teeth of the star and locking them once the coupling (by interference) between the yoke and the star is completed. Thus, in a star yoke stator, the stator slot is limited in circumferential direction by two stator teeth and radially by the inner cylindrical surface of the same star, defined by the pole shoes of the stator teeth and by the inner surface of the yoke.

An example of a star yoke stator is described in US 2015/0054378, wherein it is mentioned, in paragraph 29, that different techniques can be used for making the windings on the stator teeth according to the desired filling factor. A star yoke stator with a concentrated winding, i.e. with a coil wound on each stator tooth, is shown in this document. In this configuration, the windings can be made on the stator teeth by using a needle winding machine. If the winding was instead distributed, the coils would be made on a winding tool outside of the stator and manually inserted at a later time on two stator teeth.

Generally, as in conventional ones, it is desirable to maximize the filling factor of the sectors also in star yoke stators, i.e. being able to insert into the same sector as great of a number of conducting wires as possible, or the same number of wires of different diameter, as this would translate into an improvement in the performance of the electric motor. The filling factor is defined as the ratio between the surface of the cross section occupied by conducting wires inside a stator slot and the total area available (always considered in cross section) in the stator slot.

Maximizing the filling factor further allows to minimize, other factors being equal, the height of the stator and to thus manufacture more compact electric motors.

A further limit is constituted by the fact that, after having inserted the coils into the stators, the individual loops composing the coil are arranged so that some loops are always positioned towards the center of the stator and others always towards the outside of the stator, and this involves an increase in the leakage currents of the motor and thus a consequent drop in the efficiency of the motor itself.

WO 2022/084760, in the name of the Applicant, describes a method which allows to maximize the filling factor in different types of stators with respect to a star yoke stator. The method provides for preforming the coils on an appropriate winding tool outside of the stator, before inserting the coils into the stator slots. The method comprises:
a coil making step, in which one or more conducting wires are wound on a winding tool, so that to form at least one coil comprising at least one linear portion in turn comprising a plurality of individual linear wire portions and intended for being inserted into one of the sectors of the stator;
a coil housing step, in which the linear portion of the coil is inserted into a stator component comprising a subset of said plurality of side-by-side teeth, in particular between two side-by-side stator teeth;
a shaping step, in which the stator component which accommodated the linear portion of the coil is deformed so that to move the side-by-side stator teeth closer, so that to achieve a completed stator portion comprising the two teeth together defining the sector in which the linear portion of the coil is included and restrained;
an assembling step, in which a plurality of completed stator portions, achieved via respective housing and shaping steps, are assembled together so that to form the body of the stator complete with the windings.

After the shaping step, and thus with the coils already accommodated in the stator slots, the method further provides for performing a roto-translation R1 of a first completed stator portion with respect to a second completed stator portion. The first completed stator portion and the second completed stator portion engage the same coil. The roto-translation is performed until reaching the relative position that the first completed stator portion will have in the completed body of the stator with respect to the second completed stator portion, and the coil consequently deforms.

Alternatively to step R1, before the shaping step and thus before inserting the coils into the stator slots, the method provides for performing a roto-translation R2 of a first stator component with respect to a second stator component, until reaching the relative position that the first stator component will have in the completed body of the stator with respect to said second stator component. The method provides for deforming the coil correspondingly to the arrangement of the first stator component and of the second stator component roto-translated, and then proceeding to the coil housing step.

The method described in WO 2022/084760 is not applicable to star yoke stators, as the deformation of the star for moving the stator teeth closer and for restraining the coils in the slots is not provided in this type of stators, and it is not provided to make the star in deformable and assemblable sectors: in the star, the stator teeth extend radially to the final position each tooth assumes in the completed stator.

JP 2022 137412 A, in the name of Mitsubishi Electric Corporation, describes a method of assembling a stator starting from a linear (flat) support. The coils are preventively wound on a winding tool and are all inserted together on the linear support before winding the linear support on a cylindrical element, with a single rotation of the linear support. The deformation of the coils thus occurs contemporaneously for all coils, as a result of the winding of the linear support.

IT 102021000011564, in the name of the Applicant, describes a method for manufacturing a stator which comprises:
a step of making coils on a winding tool, for forming at least one coil comprising at least one linear wire portion intended for being inserted into a corresponding stator sector;
a pressing and carburizing step, in which the linear portion of the at least one coil is subjected to a thermal carburizing treatment and pressed for compacting the linear wire portions;
a coil housing step, in which the linear portion of the coil is inserted between two side-by-side stator teeth of a stator component;
a shaping step, in which the stator component is deformed so that to move the two side-by-side teeth closer, so that to enclose the linear portion of the coil and achieve a completed stator portion;
an assembling step, in which a plurality of completed stator portions are assembled together so that to form the body of the stator.

### SUMMARY OF THE INVENTION

Aim of the present invention consists in providing a method and an apparatus for manufacturing a star yoke stator for electric motors which allow to overcome the limits of the currently available solutions, in order to maximize the filling factor.

A further object of the present invention is to implement a method and an apparatus for manufacturing a star yoke stator which allow to achieve stators more compact in height (stack height), all factors being equal, with respect to stators manufactured with the known solutions.

The present invention concerns a method, according to claim 1, for manufacturing a star yoke stator for electric motors, in particular a two-component stator with distributed winding. The two-component stator comprises:
an outer body, named yoke, and
a body inside the yoke, named star, having an inner cylindrical surface defining a housing volume of the rotor of the electric motor and a plurality of radial stator teeth jutting out from the cylindrical surface towards the yoke and between which there are stator slots intended to accommodate windings of conducting wire.

The method comprises:
A) making coils of conducting wire, in which one or more conducting wires are wound on a winding tool so that to form at least one coil comprising at least one linear portion which in turn comprises a plurality of individual linear portions of conducting wire, which are arranged in an orderly way, and which is adapted for being inserted into a stator slot;
C) supporting the star on a rotation axis, with at least one first stator slot accessible to a manipulator of the coils;
D) inserting, by means of the manipulator, a first linear portion of the coil into the at least one first stator slot and restraining a second linear portion of the coil outside of the star;
E) rotating the star about the rotation axis by a predetermined angle, thus deforming the coil at the portions comprised between the linear portions, and making at least one second stator slot accessible to the manipulator and ready for the insertion of the respective linear portion of the coil;
F) inserting, by means of the manipulator, a second linear portion of the coil into the at least one second stator slot;
G) repeating steps D, E and F until completing the winding of the star, thus having inserted a linear portion of a coil into each stator slot;
H) constraining the star to the yoke, according to one of the two methods described below.

Step E of rotating the star is repeated until completing the stator, as a linear portion of the coil is inserted into the respective stator slot at each stop of the star. The rotation E is thus intermittent and ends whenever all stator slots have been completed with a linear portion of coil. Thus, in the solution claimed, the linear portions of the coil are inserted one at a time into the respective stator slots and the rotation E of the star, which is precisely intermittent, is synchronized with the insertion movements D and F and, in particular, the rotation E of the star is alternated with the insertion movements D and F of the manipulator. Thus, the deformation of the coil also occurs intermittently and not contemporaneously for all coils.

The rotation step thus provides for rotating the star by an angle corresponding to the angle between the first stator slot and the second stator slot (not necessarily adjacent to one another), however an angle less than 360°, and preferably less than 180°, to then stop the star and proceed with step F: during step F, the star is kept stationary.

Steps D, E and F are sequential, and step G provides for repeating them in the same sequence until completing the stator, i.e. until the stator has been equipped with all the necessary windings.

The method just described allows to achieve different advantages.

An improved filling factor of the stator sectors is one of the achievable advantages. The Applicant has calculated that the method allows to achieve, other conditions being equal, a filling factor greater of at least 20% than a star yoke stator manufactured according to the known arts, i.e. manufactured with the standard insertion of the windings into the stator slots.

The method according to the present invention further allows to manufacture stators characterized by reduced losses in the windings, about 30% less at low rotation speeds and about 20% less at high rotation speeds, with respect to a stator assembled with standard insertion of the coils into the slots, between the teeth.

As far as efficiency is concerned, when comparing the solution according to the present invention with stators achieved with the standard slot-filling technique, other conditions being equal (same size/power, same number of poles, same size of the slots between the teeth, same diameter of the conducting wires, same rotor and same stack height), a stator achieved with the method just described allows to achieve, at low rotation speeds, an efficiency of about 1-1.4% greater than a motor assembled with a standard stator.

Moreover, at low rotation speeds, a motor assembled with a stator manufactured according to the present method has a power output of about 4-5% greater than a motor with a standard stator, and even greater, also of 20%, at high rotation speeds, all conditions being equal (same size/power, same number of poles, same size of the slots between the teeth, same diameter of the conducting wires, same rotor and same stack height).

The method according to the present invention involves advantages also with respect to the axial dimension of the completed motor. Once the size of the motor is set, for example 55 kW, since the method allows to manufacture stators with an increased filling factor of the slots between the teeth, a significant decrease of the stack height comprising the stator and respective windings, is achieved. By comparing a standard stator with a stator achieved with the present method, a decrease of the stack height, which can reach 35%, is achieved.

A further advantage is constituted by the fact that the individual loops composing the coil are arranged so that a first linear portion of a coil is positioned towards the center of the stator and a second linear portion of the same coil is positioned towards the outside of the stator; a position inversion, which helps to minimize the leakage currents of the motor, is thus configured.

The method according to the present invention further allows to manufacture, in an economic and simple way, stators of electric motors complete with the respective winding, as will be described more in detail in the following description.

A further advantage of the solution described is constituted by the fact that the deformation is imparted to an individual coil at a time, i.e. for each angular movement of the star and not contemporaneously for all coils, and this allows to achieve greater constructive accuracy and improved tolerances with respect to the case described, for example JP 2022 137412 A, in which one or more coils are deformed substantially all contemporaneously. The rotation of the star to which reference is made is a rotation between two consecutive stops of the star-shaped support, which correspond precisely to the angle between the first slot and the second slot, and must not be confused with the rotation described in JP 2022 137412 A of the star-shaped support.

More in detail, in step E, the star is rotated about the rotation axis by an angle corresponding to an electric phase of the completed stator, and stopped in this angular position to accommodate a further linear portion of the coil, or further linear portions of the coil, in corresponding stator slots. Thus, the rotations from time to time imparted to the star have the purpose of offering to the manipulator new stator slots to be filled with rectilinear portions of the coil previously made on the winding tools.

In the preferred embodiment, the method further comprises a pressing or carburizing step B, otherwise optional. It is a step during which at least one of the linear portions of the coil is subjected to a pressing step, or is subjected to a thermal carburizing treatment, or to both the pressing step and the thermal carburizing treatment, in the desired order or contemporaneously, such as to compact said individual linear wire portions according to the orderly arrangement achieved during the coil forming step A. Advantageously, the wires of the linear portions of the coils which were subjected to pressing and carburizing remain aggregated, do not separate and are not displaced one relative to the other. This detail allows to make and keep the winding in the best geometric configuration possible for maximizing the filling factor, for each stator slot size to be filled, and to avoid fraying while the coils are moving. Moreover, the linear wire portions can be made of a shape perfectly complementary to the stator slot into which they must be inserted.

Preferably, step B lasts between 15 seconds and 2 minutes.

Preferably, during the pressing and/or carburizing step B, the linear portions of the coil are pressed with one or more presser elements and are heated by means of one or more heating devices included in, or coupled to, the presser elements, while the coil is wound on a winding tool, i.e. before the coil is taken from the winding tool.

In a possible method, in the pressing and/or carburizing step B, the thermal carburizing treatment is performed by inserting one or more heating elements between the linear portions of the coils, so that to heat them up to a predetermined carburizing temperature, generally in the range of 170° C.-210° C.

In a possible method, in the carburizing and pressing step B, the linear portions are pressed by means of a pressing device which is inserted between said linear portions of the coil after having removed the heating elements, by keeping the coil accommodated on the winding tool.

In a possible method, during the coil making step A, complementary and thinner conducting wires having a smaller section than the section of the main conducting wires, are added to the conducting wires, named main wires; the complementary conducting wires occupy the free spaces between the main side-by-side conducting wires.

Preferably, the method further comprises a step of insulating the conducting wires. An electrically insulating layer:
is applied at least on the linear portions of the coil, after the pressing and/or carburizing step B, whenever provided,
or
is applied between the teeth of the stator components, before the coil inserting step D.

Preferably, the coil making step A is implemented by making a series of multiple coils on the same winding tool, by making sure to keep one linear portion of a coil spaced from the linear portion of the successive coil, according to a predetermined pitch distance corresponding to the pitch between the stator slots of the star.

Preferably, before step E and during the coil inserting step D, first linear portions of the series of coils are contemporaneously inserted into corresponding stator slots of the star. At a later time, subordinate to step E, second linear portions of the same series of coils are contemporaneously inserted into corresponding stator slots of the star, so that the corresponding winding is distributed among multiple stator slots. The non-linear portions of the coil undergo deformation caused by the rotation of the star; the deformation leads the coil to assume the shape needed to achieve the proper insertion of the linear portions into the respective stator slots, according to the pitch defined by the electric phase.

The method can be implemented in two modes.

In a first mode intended for manufacturing a stator with a yoke made in one piece, between step D and step E and between steps F and G, it is provided to:

D′), F′) temporarily close the stator slot with the respective linear portion of the coil therein, by means of a closing device of the stator slots which is movable between a retracted position, at which the stator slot is open in radial direction and is accessible to the manipulator, thus allowing the insertion of the linear portion of the coil, and a forward position, at which the stator slot is closed in radial direction and the linear portion of the coil is prevented from coming out. This detail is intended to prevent the coil from being able to accidentally disengage the star while it is rotating.

Initially, whenever the manipulator of the coils approaches the star, after having taken a coil from the winding tool, and during the step D of inserting first linear portions of the coil into the respective stator slots of the star, the first linear portions are kept coplanar to the second linear portions of the coil. In other words, the coil is initially moved while keeping the shape with which it was taken from the winding tool, i.e. the coil is kept undeformed. Contrarily, the coil suffers a deformation during step E, whenever the first linear portions of the coil have been inserted into the corresponding stator slots, the second linear portions stay restrained by the manipulator and the star is rotated: in this circumstance, the coil is deformed at the portions connecting the first linear portions to the second linear portions.

Preferably, steps C to G are carried out by supporting the star on a spindle, for example a drum, and within an inner cylindrical surface of a winding apparatus. In practice, the star is coaxially fit on the spindle, with the stator teeth arranged radially and jutting out towards the inner cylindrical surface of the winding apparatus. With this detail, the stator slots are in closed in radial direction precisely by the inner cylindrical surface of the winding apparatus. Such inner cylindrical surface has a longitudinal through opening which provides to the manipulator of the coils an access in radial direction to the first stator slots of the star. Thus, only the stator slots into which the linear portions of a coil must be inserted from time to time are brought to the longitudinal opening and stay accessible from the outside, whereas the remaining stator slots and the rest of the star stay confined between the spindle and the inner cylindrical surface of the winding apparatus.

In this first implementation form of the method, steps D and F are carried out by bringing the stator slots intended to accommodate the linear portions of the coil at the longitudinal opening, by a rotation of the star, and instead by keeping the star stationary during the insertion of the linear portions.

Consequently, the rotations of the star are alternated with the insertion movements of the manipulator of the coils. By repeating the alternating movements of rotating the star and inserting the linear portions of the coils by the manipulator, the windings on the star are completed.

In this first implementation form of the method, the yoke is made substantially cylindrical and in one piece and step H is carried out by pulling out the star of the spindle and by inserting it, with all the windings, into the yoke.

In a second implementation form of the method, the yoke is made as a set of sectors and step H is achieved by taking a sector of yoke from the star, by means of a specific manipulation system for manipulating the sectors of the yoke in sequence between steps E and F and between steps F and G, and by constraining the sector at the stator slots into which a linear portion of coil was inserted, thus achieving the closing of the stator slots from the outside.

Thus, in the first implementation form of the method, the stator slots are closed by the closing device and, in the second implementation form of the method, the stator slots are closed by a sector of the yoke which is applied on the star.

Preferably, step H is carried out by temporarily constraining the sectors of the yoke both to the star and a spindle onto which the star is supported, by means of removable fastening elements, and the completed yoke, i.e. once completed, is kept together by a jaw system.

A further aspect of the invention concerns a two-component or star yoke stator according to claim 18, directly achieved with the method described herein. The stator directly achieved with the method described is recognizable from a stator manufactured with known techniques, all conditions being equal, for the following reasons:
considering the case of conducting wires with a circular section, the filling factor is at least 20% greater;
the conducting wires defining the linear portion of the coil comprised in the slots of the stator sector are arranged according to an orderly, repeatable, matrix layout and not according to a close-range but random layout, as in the known art;
the cross section of the stator slot is substantially rectangular, unlike the trapezoidal slots of the known solutions and the linear portions of the coil which have a section of a shape complementary to the section of the stator slot.

The present invention further concerns an electric motor which integrates the stator just described, in the version with the yoke made in one piece or in the version with the yoke achieved by assembling sectors of yoke.

A further aspect of the present invention concerns an apparatus according to claim 20 for manufacturing a star yoke stator of the type described above. The apparatus comprises:
at least one winding tool configured to carry out step A, wherein one or more conducting wires are wound on the winding tool so that to form coils comprising at least one linear portion which in turn comprises a plurality of individual linear portions of conducting wire and which is adapted to be inserted into one of said stator slots;
a spindle rotatable about a rotation axis and lockable in a plurality of angular positions, configured to:
support the star during steps C-G, with at least one first stator slot of the star accessible to a manipulator of the coils, and to
rotate the star by an angle corresponding to making at least one second stator slot accessible to the manipulator of the coils, possibly deforming the coil at the portions comprised between the linear portions during step E,
a manipulator of the coils, which is configured to carry out step D, by inserting a first linear portion of the coil into the corresponding stator slot and restraining a second linear portion of the same coil, and to carry out step F by inserting a second linear portion of the coil into the corresponding stator slot.

The spindle supports the star coaxially on the rotation axis. The rotations of the star are alternated with the insertion movements of the manipulator of the coils, so that, after a linear portion of a coil was inserted into the corresponding stator slot, the star is rotated to bring a further stator slot into the trajectory of the manipulator and allow the insertion of a further linear portion of a coil or the same coil.

Preferably, the winding tool comprises a supporting frame which supports a series of angular elements, wherein each of said series is arranged substantially along an edge of an ideal parallelepiped, and wherein the angular elements of each series are spaced from one another such as to define a corresponding series of winding chambers to accommodate the conducting wire, or the bundle of conducting wires, forming the coil. The winding chambers are spaced by a pitch corresponding to the desired pitch to be formed between the linear portions of the coils.

Preferably, the apparatus further comprises a wire directing device which in turn comprises an axial guide along which a plurality of wire guiding tubes slide in a controlled way an independently of one another. Each wire guiding tube is crossed by, and directs, a layer of one or more wires intended to form a layer of a loop. The wires can be main wires having a nominal section and thinner complementary wires, i.e. having a smaller section than the nominal one.

Preferably, the apparatus comprises a pressing device for performing step B, i.e. for pressing the linear portions of a coil. The pressing device comprises a plate to which a series of inclined planes adapted to come into contact with the linear portions to be pressed, are coupled.

Preferably, the apparatus comprises a heating device for carrying out step B, i.e. for performing the thermal carburizing treatment of linear portions of a coil. The heating device comprises one or more heating elements, preferably by induction, shaped and arranged so that to be inserted between the linear portions of a coil.

In the preferred embodiment, the manipulator of the coils comprises a first gripper, or upper gripper, and a second gripper, or lower gripper. The lower gripper is configured to take the first linear portions of a coil from the winding tool, to hold them for the necessary time and eject them into the first stator slots; the upper gripper is configured to take the second linear portions of a coil from the winding tool, restrain them for the necessary time and eject them into the second stator slots.

The upper gripper and the lower gripper are movable with respect to one another between:
an initial coplanar position, at which the coil is not deformed with respect to the initial configuration on the winding tool, and
a plurality of staggered positions, in which the grippers are on different planes and/or at different heights, to allow a linear portion of the coil at a time to be inserted into the stator slots at different angular positions of the star of the stator being assembled.

In other words, the grippers move one with respect to the other and with respect to the spindle and the star, to allow both the insertion of the linear portions of the coils and the deformation of the coils in the non-linear portions.

Preferably, the grippers are provided with ejector elements operable to eject the linear portions of the coils from the grippers themselves, for inserting them into the stator slots. In other words, the grippers are provided with jaws for restraining the linear portions of the coils for the time necessary for moving from the winding tool up to the spindle and the star, and they are also provided with ejector elements operable for pushing the linear portions of the coils outside of the jaws of the grippers and inside the stator slot.

In a first embodiment adapted for manufacturing stators with a yoke made in one piece, the apparatus comprises a supporting structure to which the spindle is constrained, and a carriage. The carriage is movable with respect to the spindle and/or with respect to the supporting structure, for example on tracks, between:
a first position at which the carriage does not intercept the spindle, and the star supported on the spindle is not confined in the carriage, i.e. the carriage does not surround the star, and
a second position at which the carriage extends around the spindle and encloses the star supported on the spindle.

The carriage has an inner cylindrical surface complementary to the star supported on the spindle, in the sense that the clearance available between the stator teeth and the inner cylindrical surface is minimum and sufficient to allow the star to rotate, but not the coming out of the coils from the stator slots. The inner cylindrical surface is open outwardly at a longitudinal through opening through which the manipulator of the coils is inserted to house the linear portions of the coils in the respective stator slots of the star. In practice, the carriage encloses the star supported on the spindle and the longitudinal opening allows the insertion of the linear portions of the coils, in radial direction from the outside.

A closing device configured to close the longitudinal opening temporarily and on command is present in this embodiment. In practice, the closing device intervenes to temporarily close the longitudinal opening and prevent the accidental coming out of the coils from the stator slots, before the star is rotated and the linear portions are displaced by the carriage to the confined zone.

Preferably, the closing device is a slide-like, or drawer-like, or shutter-like device mounted aboard the carriage and provided with a panel movable between two positions:
a retracted position, at which the panel does not intercept the longitudinal opening, thus allowing the manipulator to be inserted through the longitudinal opening and into the stator slots of the star supported on the spindle, and
a forward position, at which the panel intercepts the longitudinal opening, thus preventing a linear portion of a coil from coming out of the stator slots.

In a second embodiment adapted for manufacturing stators with a yoke formed by assembling sectors, the apparatus comprises a system for manipulating sectors of the yoke. The manipulation system is provided with at least one gripper with jaws movable to grip/release a sector of the yoke; the gripper is movable to a position for releasing the sector, at which the sector is anchored to the star and closes one or more stator slots already equipped with a linear portion of a coil.

In this second embodiment, the apparatus comprises one or more fastening elements transportable by the manipulation system together with each sector of yoke. The fastening elements are configured to keep the yoke sector constrained to the spindle while assembling the stator and are removable after assembling is completed.

Preferably, the fastening elements are fork-shaped, engage the two longitudinal ends of the sector of the yoke and are insertable into corresponding seats present on the spindle. The fork shape allows these fastening elements to straddle the linear portions of the coils inserted into the stator slots of the star.

More in detail, the fork-shaped elements engage the respective sector of yoke and have at least one tooth insertable into a seat of the spindle. The spindle in turn comprises at least one lever and the tooth of the fork-shaped element snap-engages the corresponding lever. The lever is movable to release the tooth of the fork-shaped element and allow the release of the fork-shaped element when it is no longer useful, i.e. when the yoke has been assembled.

Preferably, the seats for inserting the fork-shaped elements are arranged circumferentially on the spindle, according to a pitch proportional or corresponding to the pitch between the sectors of the yoke. The spindle comprises at least one lever for each seat, each lever swinging on a pin and counteracted by a spring. The lever is also provided with a tooth intended to engage the tooth of the respective fork-shaped element. All the fork-shaped elements are unhooked and disengaged from the spindle by controlling the swinging of all levers.

Preferably, the spindle is cylindrical and the levers are arranged radially on the spindle; the pins are arranged tangentially, i.e. orthogonally to the respective lever.

In its two versions, the apparatus described allows to assemble the stator according to the present invention and to thus achieve the advantages described, with quick, precise and fully automated assemblies.

### BRIEF LIST OF THE FIGURES

Further characteristics and advantages will become clearer from the description of some preferred, but not exclusive, embodiments of a method for making a stator, which are depicted by way of example and without limitations with the aid of the accompanying drawings, in which:

FIG. 1 is a flow diagram which depicts the method for manufacturing star yoke stators according to the present invention;

FIG. 2 is a front and elevation view of a winding machine used for making coils usable in the method and in the stator according to the present invention;

FIG. 3 is a detail of the machine of FIG. 2;

FIGS. 4, 5 and 6 are sectional details of the machine of FIG. 2;

FIGS. 7 and 8 are exploded views of a winding tool combined with the machine of FIG. 2;

FIGS. 9 and 10 are perspective views of the winding tool of FIG. 7, in successive steps;

FIG. 11 is a side and elevation view of the winding tool shown in FIG. 7;

FIGS. 12, 13 and 14 are sectional views, along different planes, of the winding tool of FIG. 7;

FIG. 15 is a perspective view of an individual coil made in the machine of FIG. 2 and on the winding tool of FIG. 7;

FIG. 16 is a perspective view of a plurality of coils made in the machine of FIG. 2 and on the winding tool of FIG. 7;

FIG. 17 is a perspective view of an apparatus for pressing and carburizing coils;

FIGS. 18 and 19 are sectional views of the apparatus of FIG. 17 at successive coil pressing and carburizing times;

FIGS. 20 and 21 are perspective views of an alternative embodiment of the winding tool;

FIGS. 22a, 22b and 22c are sectional views of the loops of different possible types of windings;

FIGS. 23a, 23b and 23c are sectional views of the loops of different types of windings according to an optional solution;

FIG. 24 is a perspective view of a detail of a further embodiment of the winding tool;

FIG. 25 is a front view of the winding tool of FIG. 24;

FIG. 26 is a side view of the winding tool of FIG. 24;

FIG. 27 is a top view of the winding tool of FIG. 24;

FIGS. 28A and 29 are perspective views which depict two successive steps of the thermal treatment process carried out on a coil housed on the winding tool of FIG. 24;

FIG. 30 is a sectional view of an electric motor provided with a star yoke stator, according to the known art;

FIG. 31 is a perspective view of a star according to the known art;

FIG. 32 is a perspective view of a stator star portion according to the present invention;

FIG. 33 is a cross sectional view of a first embodiment of a star yoke stator according to the invention, devoid of windings;

FIG. 34 is an isometric view of the star yoke stator shown in FIG. 33 but with the windings completed;

FIG. 35 is a cross sectional view of a second embodiment of a star yoke stator according to the present invention, devoid of windings;

FIG. 36 is an isometric view of the star yoke stator shown in FIG. 35 but with the windings completed;

FIG. 37 is a perspective view of a gripper system used in an apparatus according to the present invention for manipulating coils for manufacturing star yoke stators, in both embodiments respectively shown in FIGS. 33-34 and 35-36;

FIG. 38 is a cross sectional view of the gripper system shown in FIG. 37;

FIGS. 39-61 are perspective views of a first apparatus according to the present invention for manufacturing star yoke stators according to the first embodiment shown in FIGS. 33 and 34, at different steps during the insertion of the coils into the stator slots;

FIGS. 62-63 and 66-91 are perspective views of a second apparatus according to the present invention for manufacturing star yoke stators according to the second embodiment shown in FIGS. 35 and 36, at different steps during the insertion of the coils into the stator slots;

FIG. 64 is a perspective view of a component of the second embodiment of the apparatus according to the present invention;

FIG. 65 is a sectional (vertical) view of the component shown in FIG. 65;

FIG. 92 is a schematic view of a layout for winding a star yoke stator according to the known art, in a cross sectional view, and a table of the respective technical requirements of the winding;

FIG. 93 is a schematic view of five possible layouts for winding a star yoke stator according to the present invention, in a cross sectional view, and a table of the respective technical requirements of the windings;

FIG. 94 is a cross sectional view of a portion of a hypothetic star yoke stator, with a stator slot filled in the conventional way compared to an identical stator slot filled with the method according to the present invention;

FIG. 95 is a diagram of the losses in relation to the number of revolutions of a motor made with a star yoke stator according to the known art and of a motor made with a star yoke stator according to the present invention, all conditions being equal;

FIG. 96 is a diagram of the efficiency in relation to the number of revolutions of a motor made with a star yoke stator according to the known art and of a motor made with a star yoke stator according to the present invention, all conditions being equal;

FIG. 97 is a diagram of the output power in relation to the number of revolutions of a motor made with a star yoke stator according to the known art and of a motor made with a star yoke stator according to the present invention, all conditions being equal.

### DETAILED DESCRIPTION OF THE INVENTION

In order to achieve a high filling factor, in the star yoke stator according to the present invention, the windings are formed by making, in an appropriate tool outside of the stator, coils characterized by an extremely orderly distribution of the conducting wire and by then inserting the coils into the stator slots.

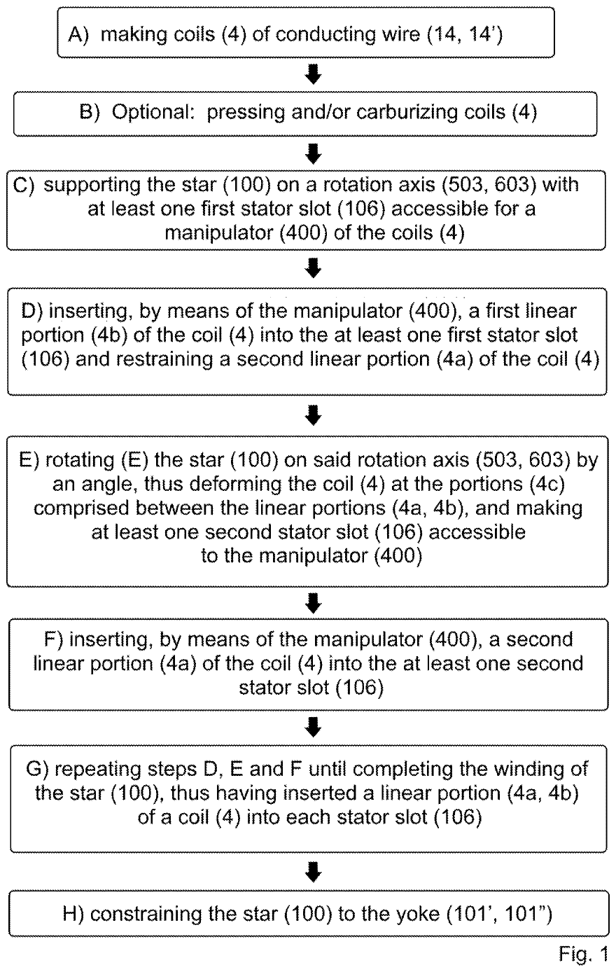

FIG. 1 is a flow diagram which summarizes the main steps of the method according to the present invention for manufacturing star yoke stators with distributed windings.

Step A consists in making the coils 4. The method optionally and preferably comprises the step B of pressing and/or carburizing the coils, wherein step B provides for carrying out only the pressing, or only the carburizing, or both the pressing and the carburizing in the desired order or contemporaneously.

Step C provides for coaxially fitting the star 100 of the stator S1, S2 on a spindle 501, 601, with the stator teeth 104 jutting out radially outwardly from the spindle 501, 601 and with a first stator slot 106 accessible from the outside.

Step D provides for manipulating a coil 4 previously made with step A and possibly also with step B, to insert a first linear portion 4b of the coil 4 into the first stator slot 106 and to restrain or lock a second linear portion 4a of the same coil 4.

Step E provides for rotating the spindle 501, 601, and thus the star 100, by an angle useful for making a second stator slot 106 accessible from the outside, thus causing the concurrent deformation of the coil 4.

Step F provides for inserting a second linear portion 4a of the coil 4 into the second stator slot 106.

Step G provides for repeating steps D, E and F until completing the windings, i.e. until a linear portion 4a, 4b of a coil 4 is inserted into each stator slot 106.

The yoke 101′, 101″ is assembled on the star 100 in a step H, which can be implemented during the previous steps.

In a first embodiment, the spindle 501, onto which the star 100 of the stator S1 is fit, rotates inside a cylindrical surface 508, and the rectilinear portions 4a, 4b of the coils 4 are restrained in the respective stator slots 106 by the cylindrical surface 508. In a second embodiment, the yoke 101″ of the stator S2 is made of sectors 110 and the rectilinear portions 4a, 4b of the coil 4 are restrained in the respective stator slots 106 by at least one sector 110 of the yoke 101″ which is coupled to the star 100.

In the first embodiment, step H′ provides for completing the stator S1 by removing the star, together with the windings, from the spindle 501 and by inserting it into the respective yoke 101′. In the second embodiment, step H″ provides for completing the stator S2 by locking all sectors 110 of the yoke 101″, for example with a jaw system 700.

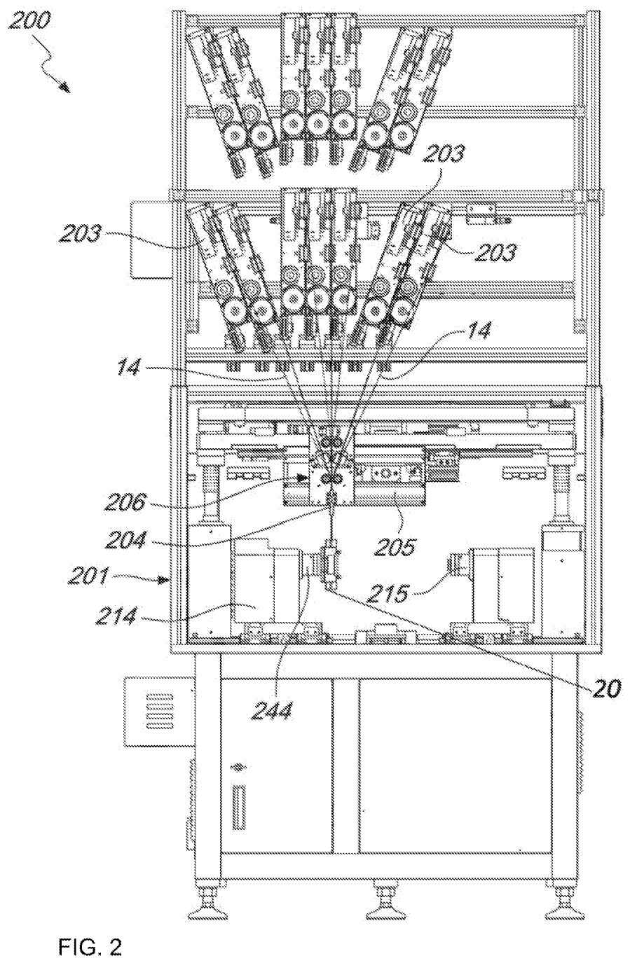

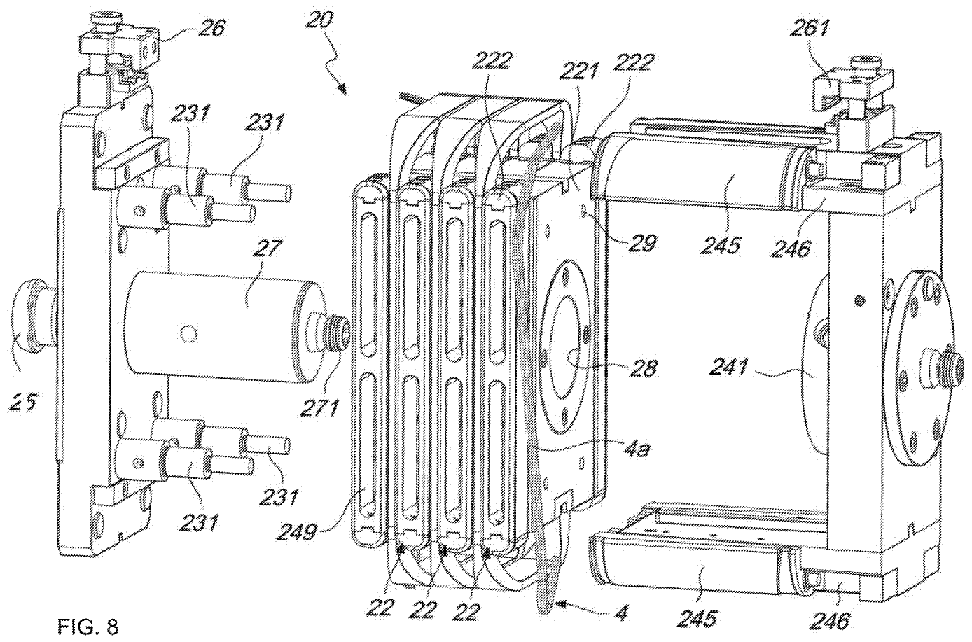

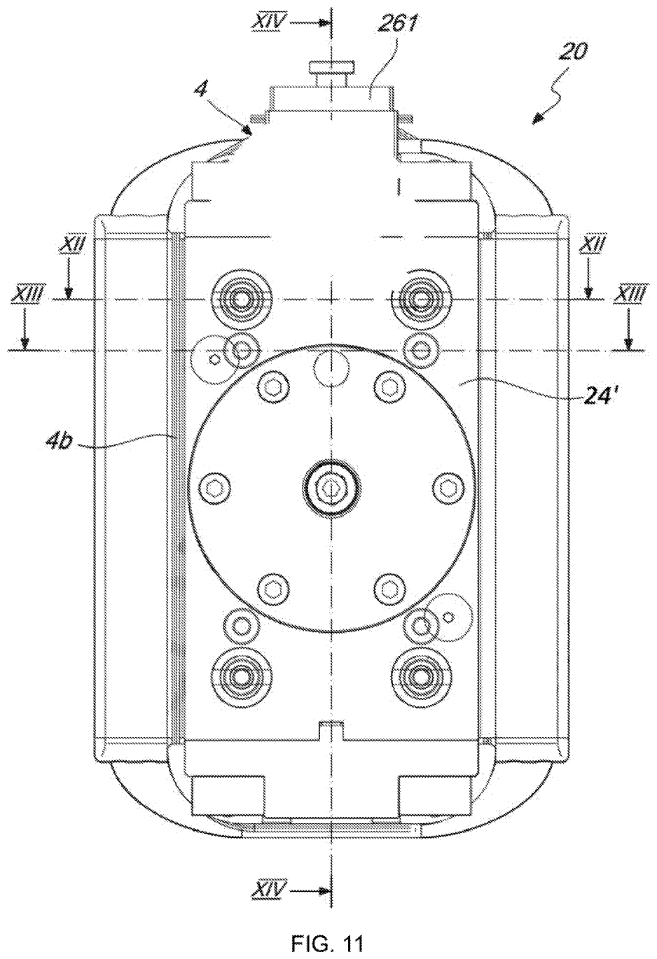

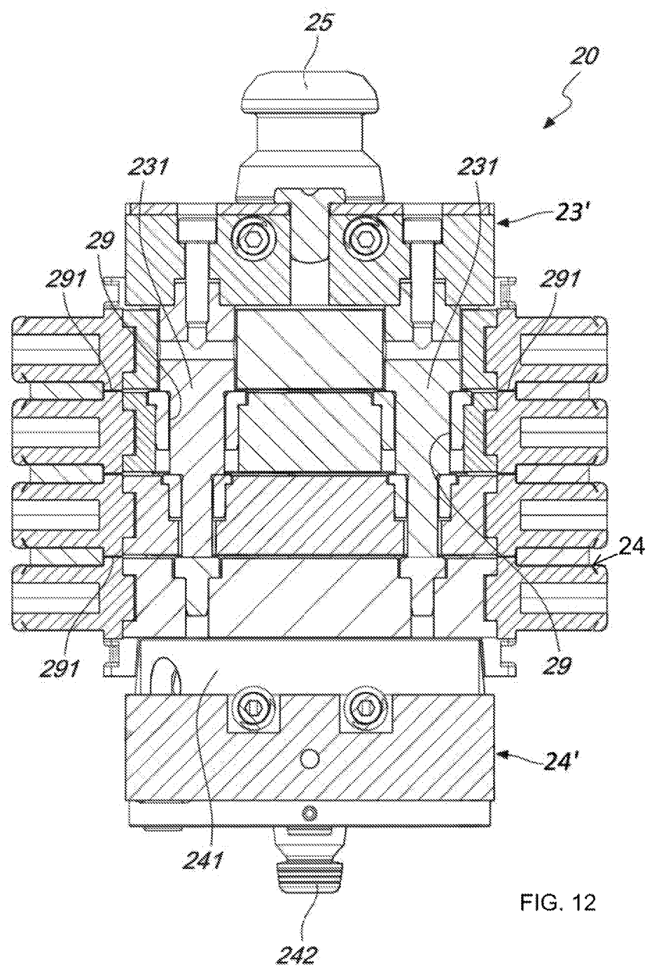

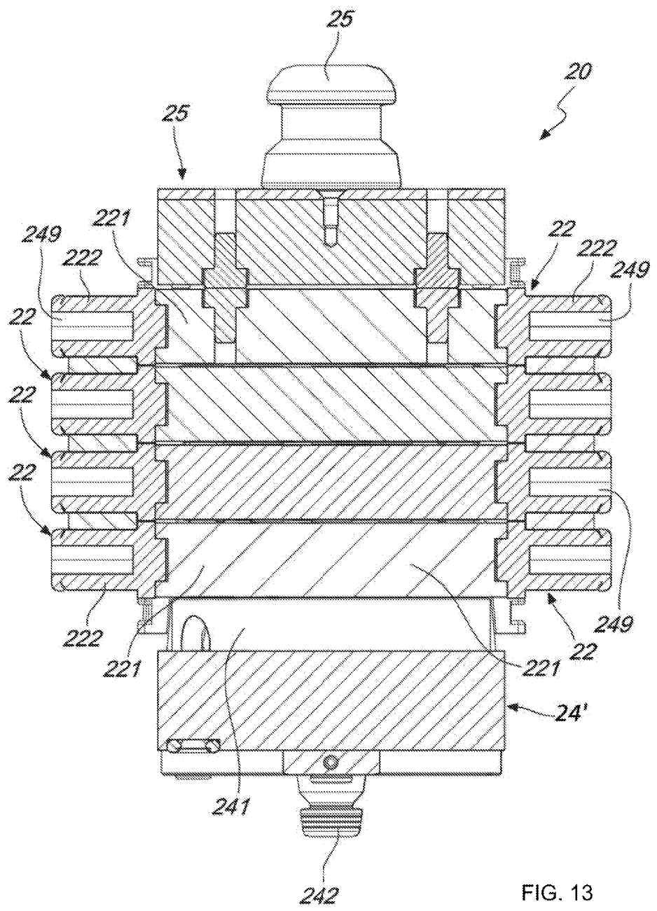

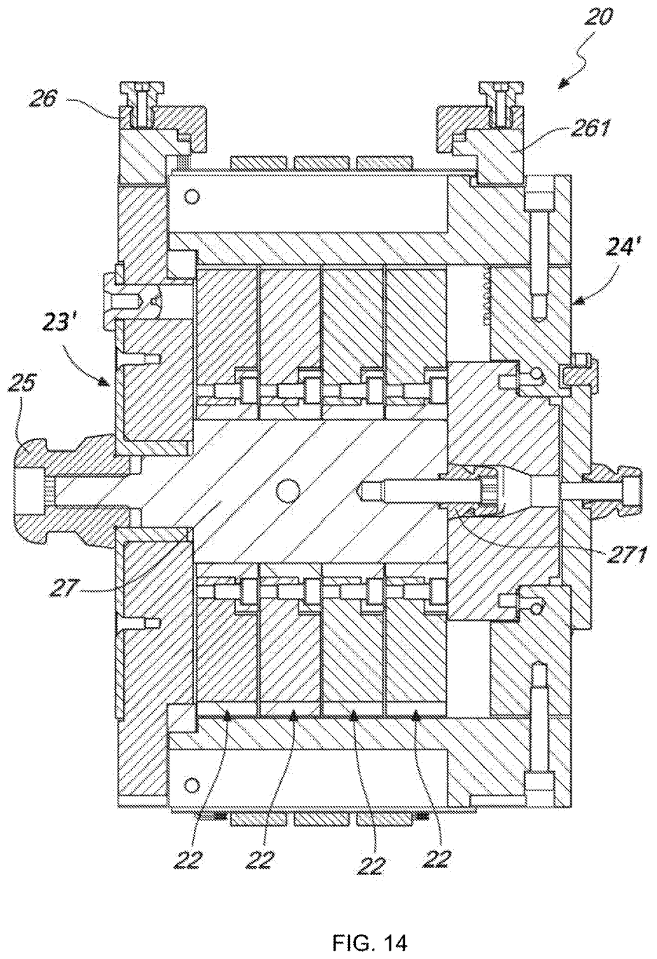

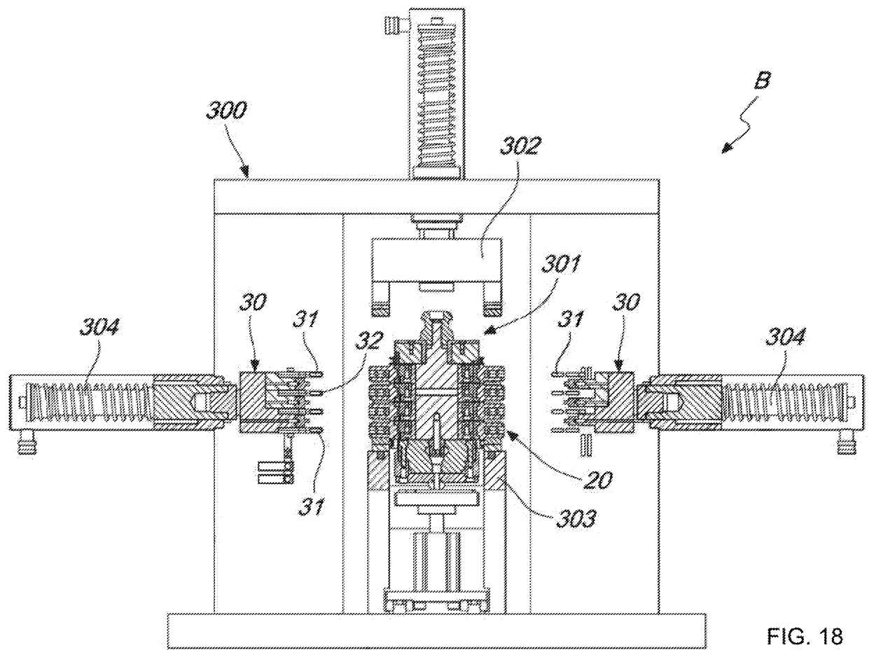

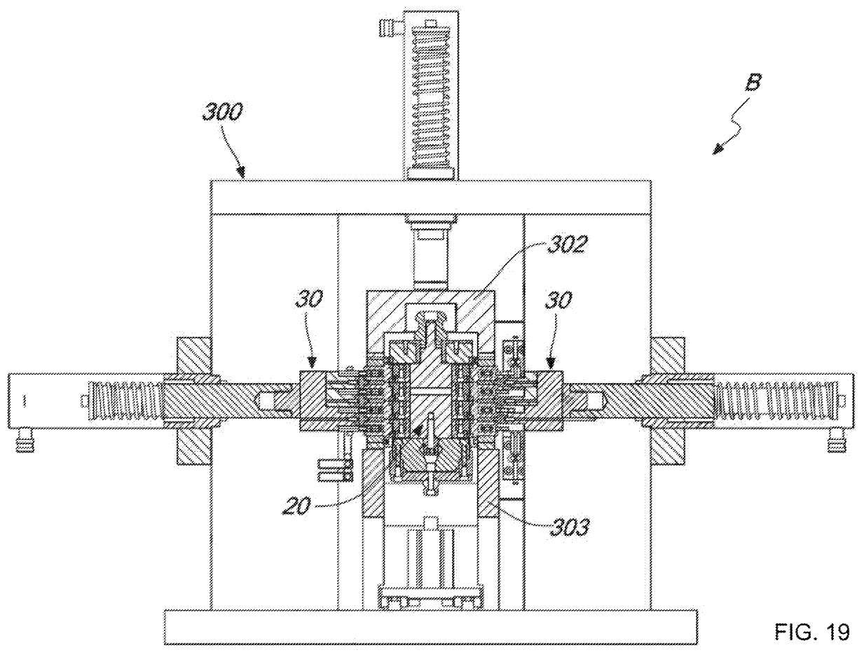

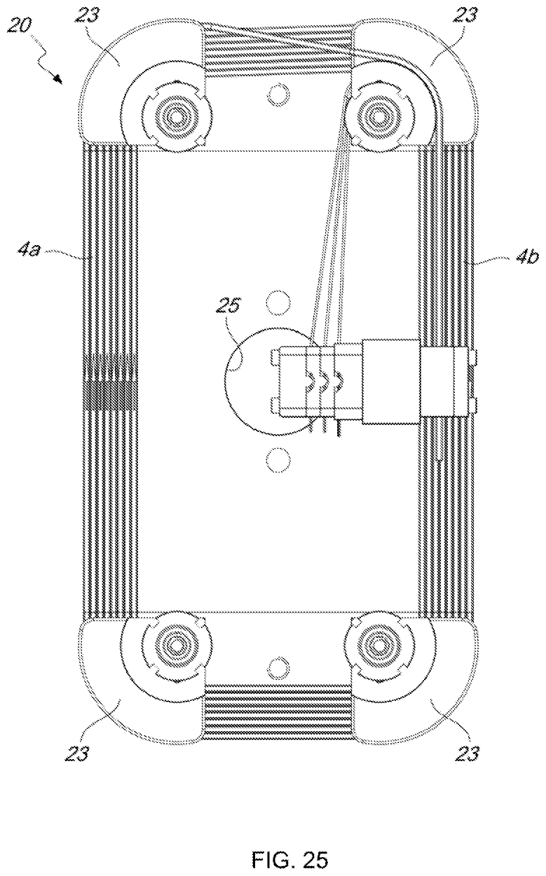

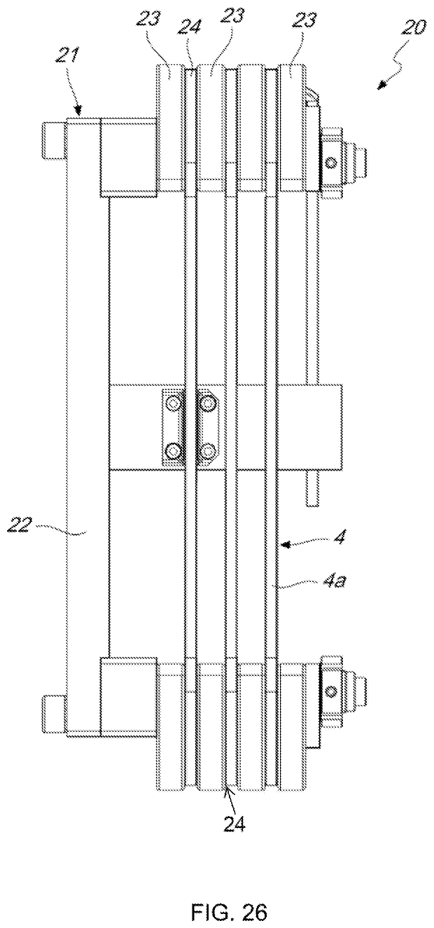

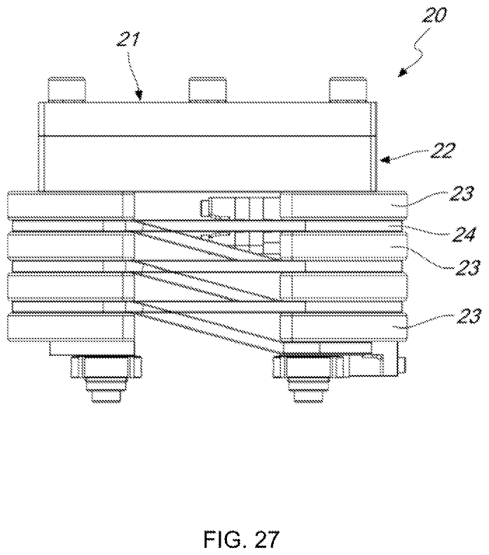

With reference to FIGS. 2-29, and as mentioned, the method initially comprises a step A of making the coils 4, wherein one or more conducting wires 14 are wound on a winding tool 20, so that to form at least one coil 4 comprising at least one and preferably two linear portions 4a, 4b, each of which in turn comprising a plurality of individual linear wire portions 14. Each linear portion 4a, 4b of a coil 4 is intended to be inserted into a stator slot defined in the star of the stator. The coil 4 thus made is in practice formed by a plurality of loops of wire 14.

In this step, the coil 4 is preferably made with at least one first 4a and at least one second 4b linear portion parallel to one another and connected by non-linear portions, which first 4a and second 4b linear portions will then each be inserted into a different stator slot 106.

As shown in the figures, the coils 4 are preferably made in series on the winding tool 20, so that the series comprises a plurality of first linear portions 4a and corresponding second linear portions 4b, for example three, appropriately spaced according to a pitch distance corresponding to the pitch between the stator slots 106 of the star 100.

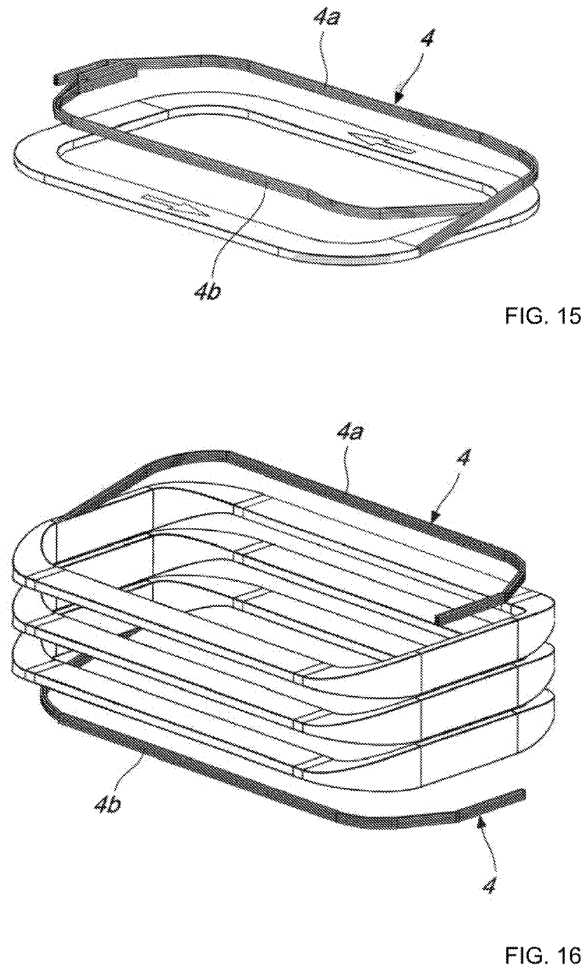

As in FIG. 15, only one coil 4 or, as in FIG. 16, a plurality of coils 4 in series, can be wound on the winding tool 20 depending on the design decisions.

The winding is made with one, or two or more parallel wires, so that to achieve coils 4 consisting for example: of one hundred loops constituted by only one wire 14, or fifty loops constituted by two parallel wires, or ten loops constituted by ten parallel wires 14, etc.

A possible embodiment of the winding machine 200 usable for making the coils 4 is depicted in FIG. 2.

The winding machine 200 comprises a supporting structure 201 which supports:
a plurality of wire tensioning devices 203 (of known type) for tensioning wires 14 to be wound,
a wire guiding device 206 provided with a wire guiding tube 204 and movable along a wire guiding guide 205 (preferably consisting of a bar),
a winding spindle 244 rotated by a motor 214 and adapted to rotate the winding tool 20 which will be described below, in practice being coupled to the sleeve for hooking to the spindle 25.

Such winding machine 200 can thus be configured in an operative winding configuration, wherein the wires 14 to be wound are tense and come out of the wire tensioning devices 203 towards the wire guiding device 206, which in turn guides the wires 14 towards the winding tool 20 kept rotating.

Optionally, the winding machine 200 further comprises a tailstock 215 positioned coaxially to the spindle 244 and adapted to be coupled to the removable wall 24′ of the winding tool 20.

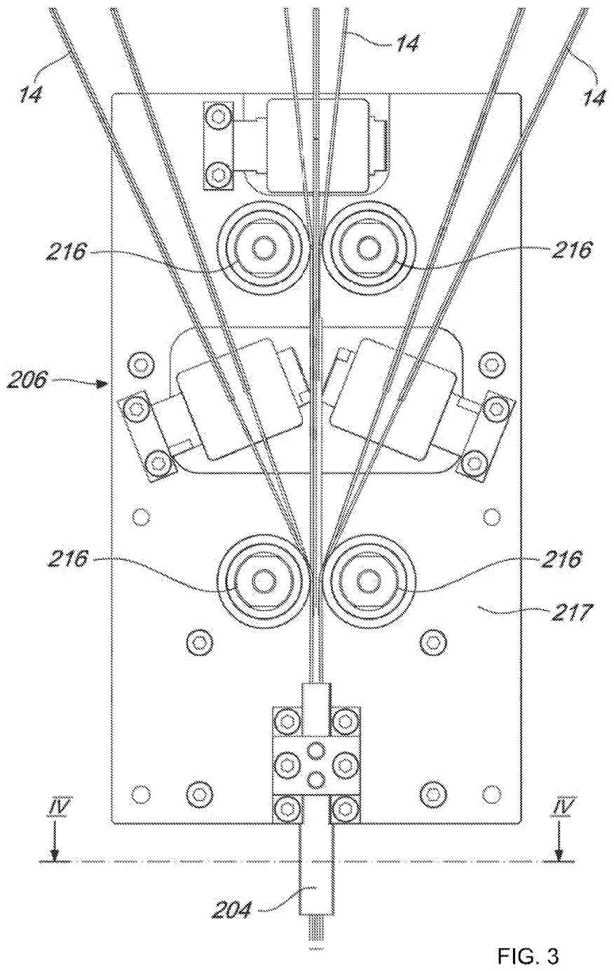

FIG. 3 shows, in detail, the wire guiding device 206 which comprises a base 217 on which wire directing elements 216 (preferably pairs of wheels) are fixed and direct the wires 14 into the wire guiding tube 204 which is placed at the end of the base 217 facing the winding tool 20.

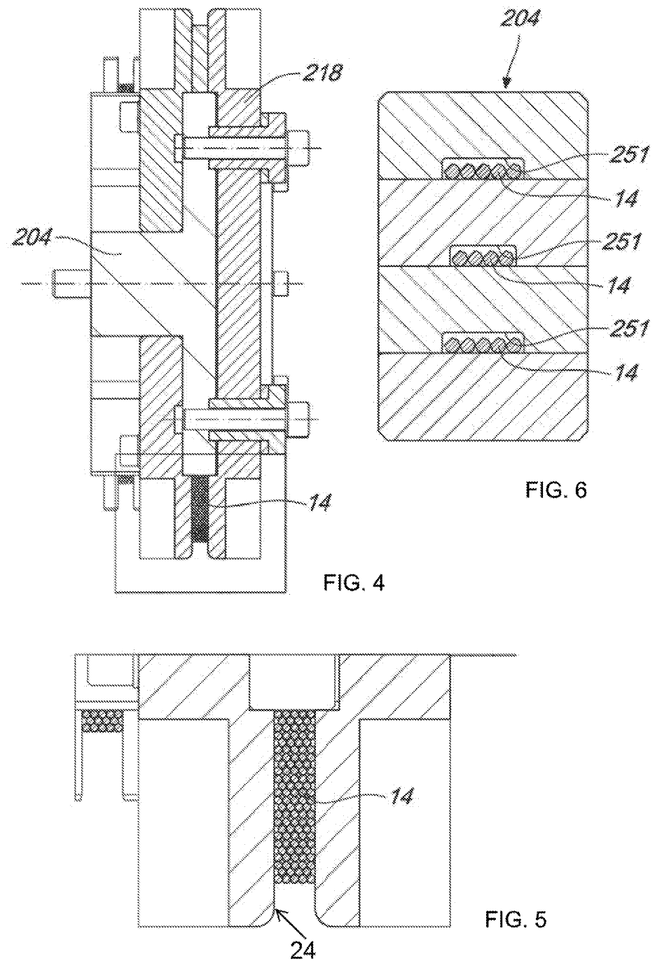

The details of a reeling member 218, which is preferably present in the winding machine 200 and positioned coaxially to the spindle 244, in which the wires 14 coming out of the wire guiding tube 204 are aligned in loops before being wound on the winding tool 20, are illustrated in FIGS. 4 and 5.

FIG. 6 shows a section of the wire guiding tube 204 consisting of a plurality of sectors which define a plurality of separate ducts 251 for the wires 14, so that the wires 14 intended to form a level of a loop are kept in position in each duct 251. There are three ducts 251 in the example depicted and the wires are arranged on three levels with a 5-4-5 sequence (five wires on the first level, four on the second level and five on the third level) for a total of fourteen parallel wires in parallel for each loop, each of which wire 14 comes from and is managed by one of the fourteen wire tensioning devices 203 visible in FIG. 2.

Obviously, the number of wires 14 wound in parallel for each loop (and thus of wire tensioning devices 203), the number of levels (and thus of ducts 251 in the wire guiding tube 204) and the number of wires 14 per level can be varied and selected depending on the project requirements.

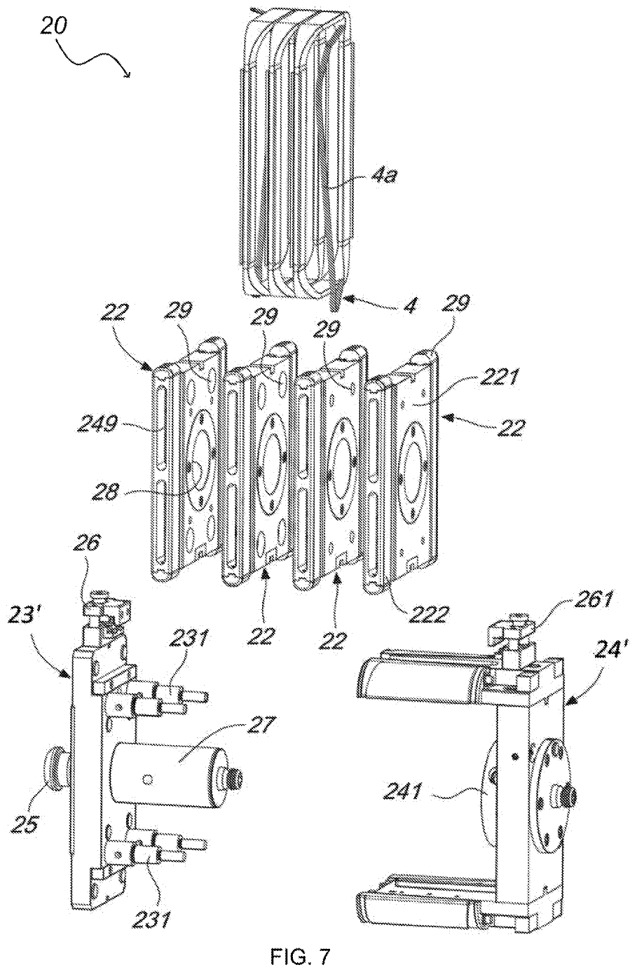

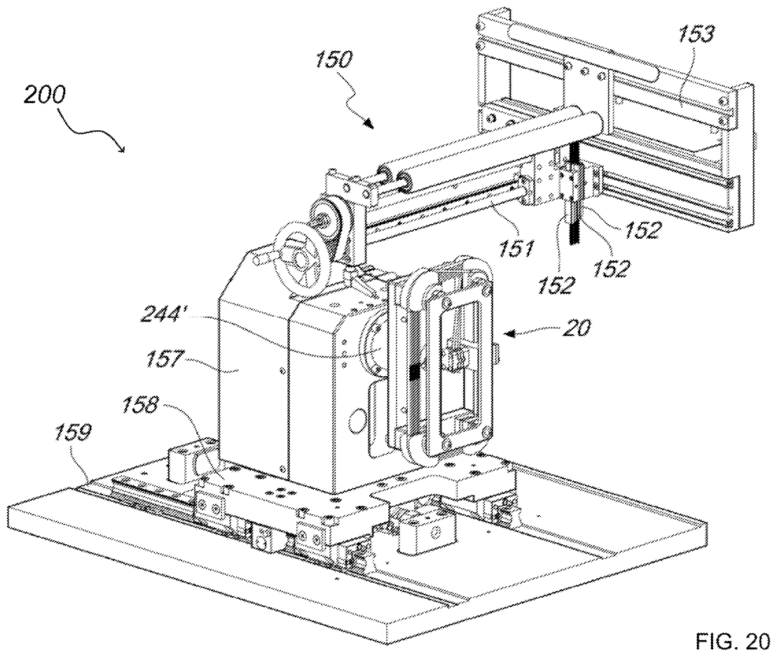

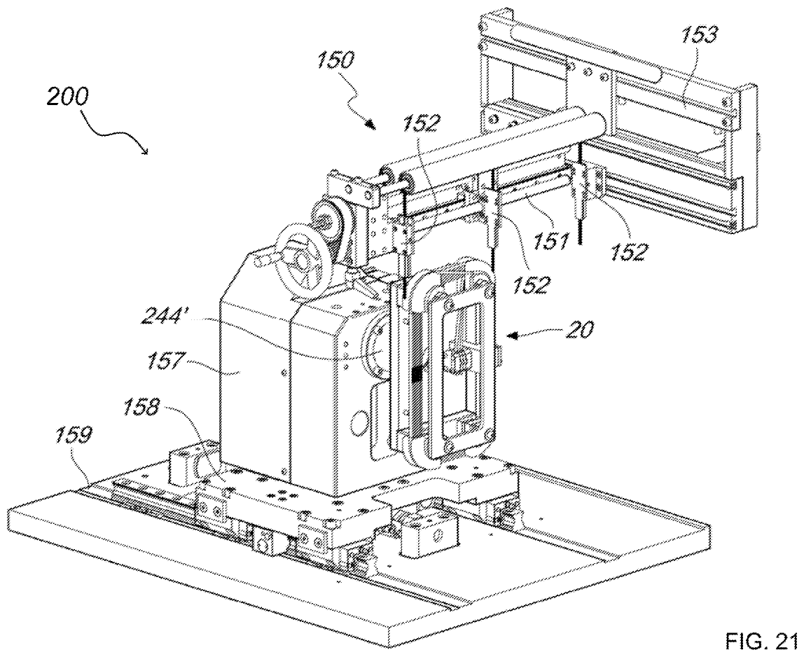

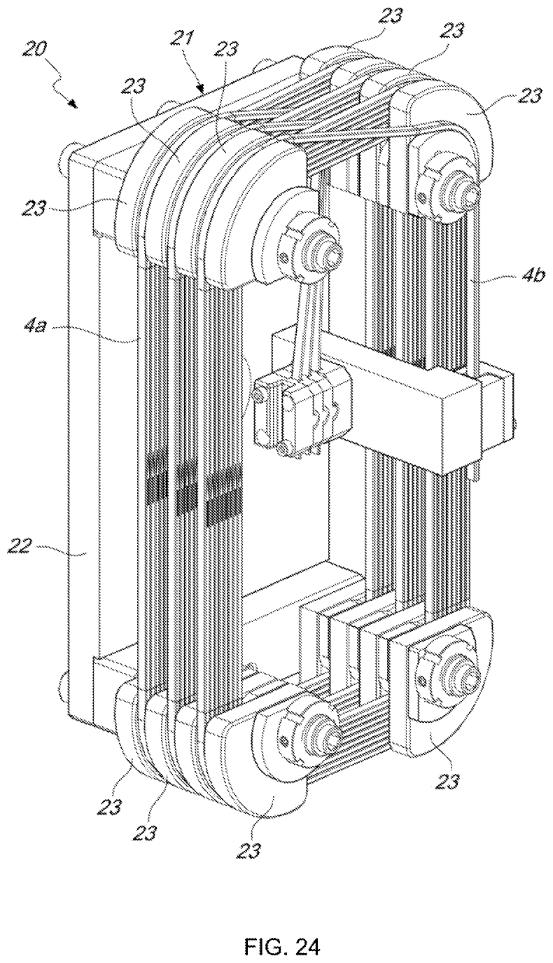

A first embodiment of the winding tool 20 is shown in FIGS. 7-14; a second embodiment is shown in FIGS. 20-21 and in FIGS. 24-29.

With reference to FIGS. 7-14, the winding tool 20 preferably comprises a plurality of movable walls 22 comprised between an anchor wall 23′ and a removable disassembly wall 24′.

The anchor wall 23′ is configured to be operatively coupled to a winding spindle 244 so that to drive the rotation of the movable walls 22 and optionally comprises, for this purpose, a hooking sleeve to the spindle 25.

The removable disassembly wall 24′ can be decoupled from the anchor wall 23′ to release the movable walls 22 and allow the displacement of the coils 4 already wound.

The movable walls 22 form one or more winding chambers 24 inside which the conducting wires 14 are wound to form the coils 4.

More in detail, the anchor wall 23 further comprises a wire clamp element 26 configured for clamping the wires 14 (already arranged in the proper configuration) coming into the winding.

Conveniently, the anchoring wall 23′ is further provided with a centering pin 27 to center the movable walls 22, which centering pin juts out towards the removable wall 24′ and engages a tunnel formed by central holes 28 which are obtained at the center of each movable wall 22.

A hooking end 271, for hooking the anchor wall 23′ to the removable wall 24′, is present at the end of the centering pin 27.

The anchor wall 23′ is further provided with a plurality (four in the example depicted) of axial positioning pins 231 which are also jutting out towards the removable wall 24′ and which have the task of keeping the proper axial position of the movable walls 22 while winding, by occupying respective positioning holes 29 obtained in the movable walls 22, so that to ensure the proper size of the winding chambers 24.

As can be noted in the figures, the axial positioning pins 231 are formed by a plurality of longitudinal portions of different diameters and decreasing towards the removable wall 24′, and the positioning holes 29 are of a different diameter in each movable wall 22, decreasing towards the removable wall 24′, so that each movable wall 22 is locked on a respective longitudinal portion of the axial positioning pins 231.

The movable walls 22 thus ensure the axial dimension (determined by the thickness of the walls 22 and by the distance between the walls 22 themselves) during the step of winding the conducting wire 14 (of making the coils 4), but can move closer to each other under the thrust of a press during the pressing step, which will be described hereunder. Such axial dimension is conveniently ensured by mechanical reference elements 291 which ensure the repeatability of the process and the consistency of the final dimensions of the pressed coil 4. In practice, the winding tool 20 is configured so that the movable walls 22 can move closer to each other, under the action of a pressure, up to a distance defined by the mechanical reference elements 291 which act as a limit abutment.

The number of movable walls 22 in the winding tool 20 is determined by the number of coils 4 to be made in series (equal to the number of coils per electric pole and thus per sector 3)+1; thus by the formula Np=nm+1, wherein Np is the number of movable walls 22 and nm is the number of coils. In practice, the nm coils are the coils 4 which will be part of an individual electric pole.

The movable walls 22 are substantially rectangular in plan, both in vertical section and in horizontal section. Preferably, the movable walls 22 are provided, on the sides jutting out outside of the winding tool 20, with manipulation seats 249.

In the preferred embodiment, each movable wall 22 is formed by a central support 221, two winding cheeks 222 fixed to the two sides of the central support 221, in this case the manipulation seats 249 are obtained in the winding cheeks 222. In practice, in these embodiments, the winding chambers are defined between the winding cheeks 222.

Preferably, a thermal insulator is interposed between the central support 221 and the winding cheeks 222 to limit thermal loss during the thermal carburizing treatment which will be described hereunder.

The removable disassembly wall 24′ is removable in the sense that it can be decoupled from the fixed wall to allow to pull out the movable walls 22.

In the preferred embodiments, the removable wall 24 is also provided with a respective wire clamp element 261 configured for clamping the wires 14 coming out of the winding, thus keeping them arranged in the proper configuration.

The removable wall 24′ then comprises a coupling device 241 for the direct or indirect coupling to the anchor wall 23′ in which, for example, the hooking end 271 of the centering pin 27 of the anchor wall 23′ is hooked.

Preferably, the removable wall 24′ further comprises a gripping element 242 adapted to be grasped or hooked to allow its movement.

In the preferred embodiments, the winding tool 20 comprises a plurality of corner elements 245 coupled to the removable wall 24′, which slide on respective appropriately inclined guides 246. Such guides 246 extend from the removable wall towards, and preferably up to, the anchor wall 23′. The corner elements act as an abutment for the wires 14 while winding and, in particular, provide support to the wire portion 14 which will not be part of the rectilinear portions 4a, 4b, i.e. the wire portion 14 forming the header of the coil 4.

In the example shown, the corner elements 245 are at least four, one for each angle.

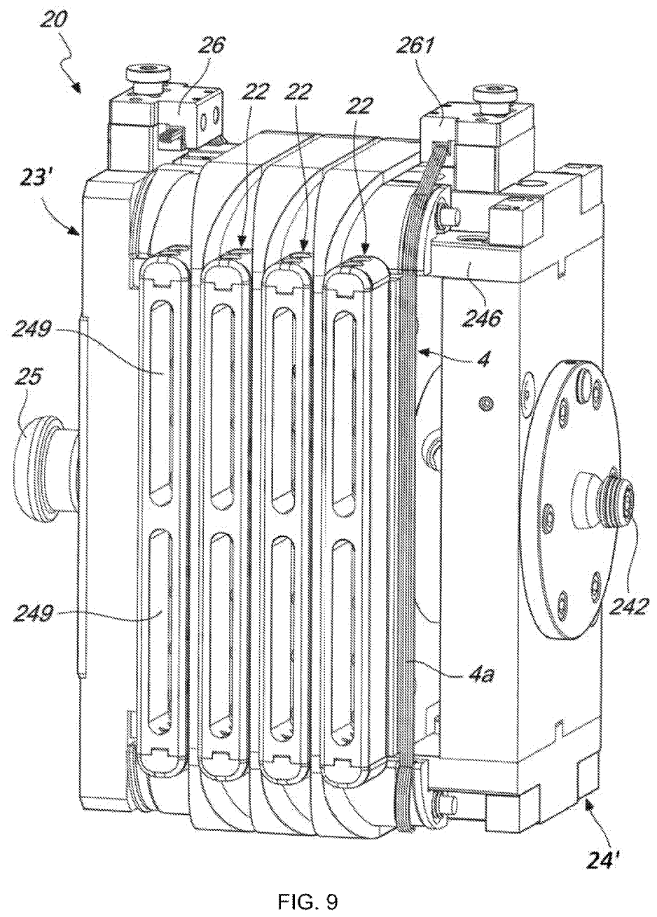

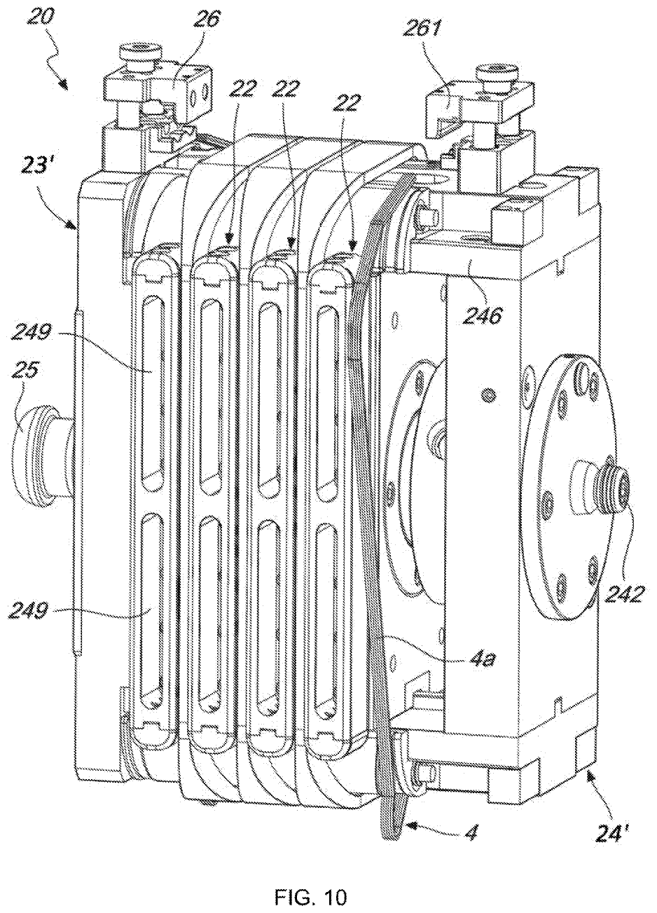

Thanks to the sliding along the guides 246, the corner elements 245 slide towards the center of the winding tool 20 (as shown in FIGS. 9 and 10) during the detachment of the removable wall 24′ from the hooking wall, so that to cancel stress from the wires 14 forming the coils 4 and thus to allow the removal of the coils 4 without scrapes, so that to prevent the wire 14 from being damaged.

Following the coil forming step A, the method provides an optional, although preferential, pressing and/or carburizing step B, wherein the at least one linear portion 4a, 4b of the at least one coil 4 is pressed and subjected to a thermal carburizing treatment so that to compact the individual linear wire portions 1 together.

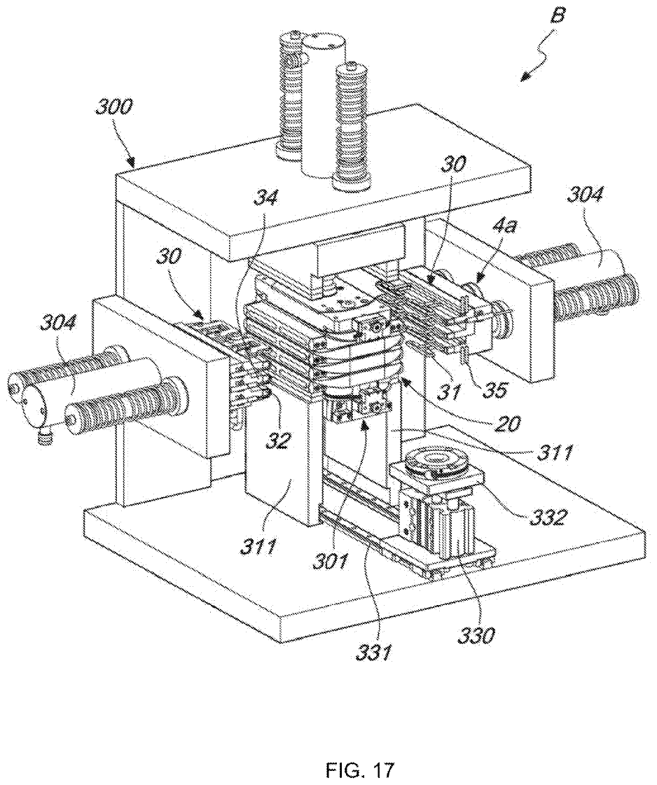

In practice, the coil 4 already formed on the winding tool 20 is displaced and positioned, together with the winding tool 20, in a pressing and/or carburizing apparatus 300, like the apparatus shown for example in FIG. 17.

In the preferred embodiments, the apparatus 300 carries out both the pressing and carburizing 300 and comprises a housing seat 301 configured for housing the winding tool 20 and one or more presser elements 30 configured for exerting a pressure on the at least one linear portion 4a, 4b of the coil 4 wound on the winding tool 20.

Preferably, there are two presser elements 30 positioned coaxially on opposite sides of the housing seat and exerting a pressure one in direction of the other, preferably in horizontal direction, so that to press each one of the two opposite linear portions 4a, 4b of each coil 4.

The presser elements 30 are provided with at least one heating device 31 (preferably comprising one or more inductors) configured for heating the linear portion 4a, 4b before, after or during said pressure, so that to perform the thermal carburizing treatment while the coil 4 is wound on the winding tool 20 and, thus, while the arrangement of the conducting wire 14 is perfectly orderly.

The presser elements are activated by means of a pressure kinematic system 304 which, in the embodiment illustrated, comprises a piston and a spring coaxial thereto.

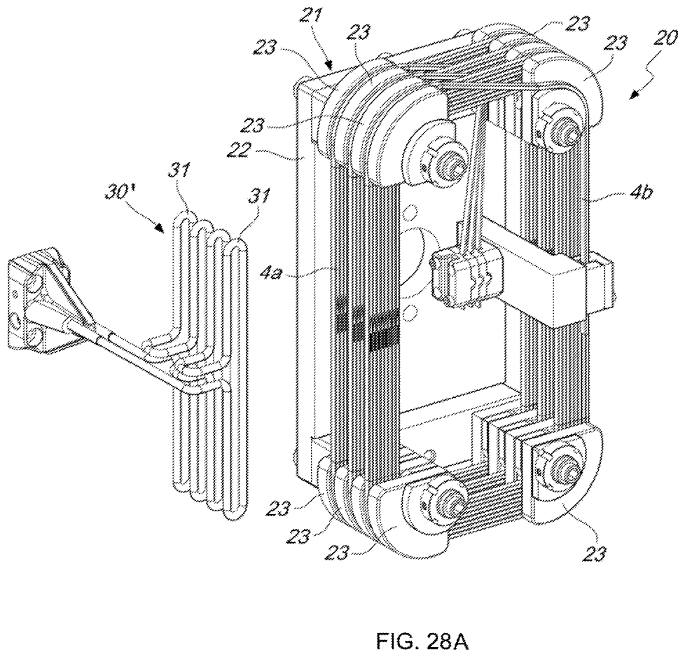

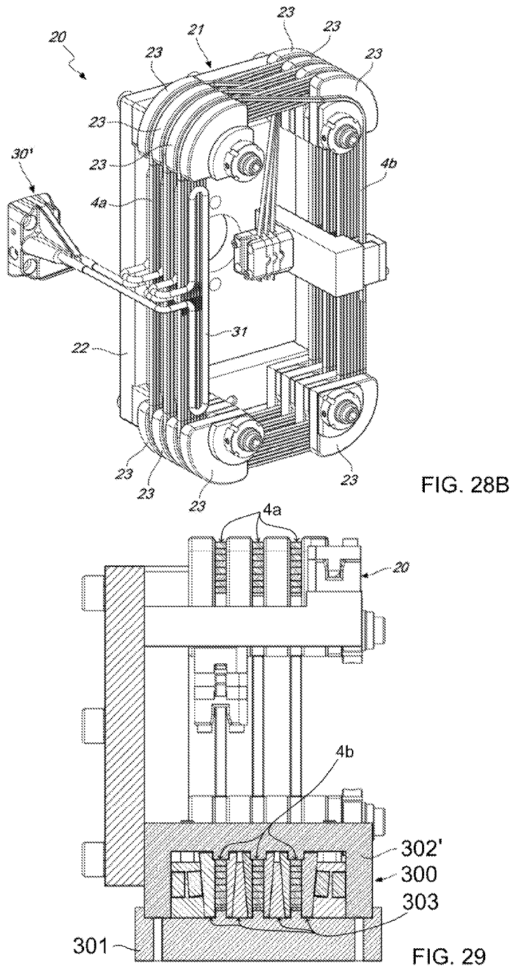

In some embodiments, the heating devices 31 (well visible in FIG. 28) are comprised in, or coupled to, the presser elements 30 and more precisely in their heads 32, which heads constitute the end of the presser elements 30 themselves that come into contact with the linear portions 4a, 4b during the pressing.

Conveniently, there is a number of heating devices 31 equal to the number of movable walls 22.

Optionally, the pressing and/or carburizing apparatus 300 comprises thermal probes 34 and/or pyrometers 35, preferably coupled to the presser elements 30, for allowing the feedback control of the carburizing treatment by a control system which controls the heating elements 31.

More in detail, the pressing and/or carburizing apparatus 300 comprises, at the housing seat 301, fixed abutments 311 on which the winding tool 20 rests. Such fixed abutments 311 have bearing planes made of a thermally insulating material, on which the winding tool 20 is rested to limit heat dispersion.

Preferably, the pressing and/or carburizing apparatus 300 further comprises a press head 302 which moves orthogonally with respect to the presser elements 30, vertically in the example depicted, so that to compress the winding tool (and thus the coil 4) in orthogonal direction with respect to the presser elements 30, thus causing the movable walls 22 to move closer, so that to further compact the linear portions 4a, 4b of the coil 4 and to determine its thickness, using the mechanical reference elements 291 acting as limit abutments as a reference. In practice, the press head 302 compresses the winding tool 20 (and thus the coil 4) against the fixed abutments 311.

Thus, the linear portions 4a, 4b of each coil 4 are preferably subjected to two pressures in orthogonal directions to each other, as shown in FIGS. 17-19.

Conveniently, only the linear portions 4a, 4b of the coil 4 are pressed and subjected to the thermal treatment, while the non-linear portions (i.e. the parts of the coil 4 connecting the linear portions 4a, 4b, which are mainly curved and which form the header of the coil 4) are left untreated, so that to be able to easily shape them in the successive steps.

Once the predetermined carburizing temperature has been reached, which depends on the characteristics of the wire 14 used, the presser elements 30, and possibly the vertical press 302, keep the pressure for the time needed to cool, which is assisted by cooling devices (for example with air, not depicted), so that to stabilize the linear portions 4a, 4b to their final dimensions.

In the example shown in the figures, the pressure exerted is within the range of 140-300 bars and the temperature reached by the heating elements 31 is within the range of 170°−210° C. The duration of step B is between 15 seconds and 2 minutes.

Optionally, the pressing and/or carburizing apparatus 300 comprises a loading slide 330 configured for bringing the winding tool 20 with the coil 4 into the housing seat 301 and for depositing it on the fixed abutments 311. As visible in FIG. 17, the loading slide can slide along horizontal tracks 331 and is provided with a platform movable vertically and adapted for raising the winding tool 20.

Advantageously, the pressing and/or carburizing step B conforms and makes the size of the linear portions 4a, 4b of the coils 4 repeatable and compacts them by maximizing the filling factor. Moreover, the linear portions 4a, 4b thus treated are solidified together so that the arrangement of the wires 14 stays unchanged during the entire process; the wires 14 are arranged and kept in an orderly, repeatable matrix configuration and are not grouped in random order, but they keep the orderly arrangement given during the initial winding.

In the example described, the linear portions 4a, 4b of the coil 4 are first subjected to pressing and then to carburizing, but in general the method can be implemented by performing either the pressing or the carburizing, or both in the order described and also backwards, or even by performing the pressing and carburizing contemporaneously.

After the pressing and/or carburizing step B, when the coil 4 has cooled and thus solidified in the linear portions 4a, 4b, the coil itself is disassembled from the winding tool 20. By supporting the winding tool 20 by means of the sleeve for hooking to the spindle 25 and/or the gripping element 242, the coupling device 241 is locked (pneumatically).

The wire clamp elements 26, 261 are thus opened, for example by means of two external controls, to release the wires 14 coming in and out of the winding. At this point, a manipulator (not depicted), which guides the removable wall 24′ of the winding tool, starts to move away axially from the anchor wall 23′. During the first step of this movement, the corner elements 245, sliding on the respective guides 246, start to move towards the center of the winding tool 20, so that to cancel stress of the wire and allow to pull out the coils 4.

The manipulator guiding the removable wall 24′ thus continues to move away axially from the anchor wall 23′ and a second manipulator takes the movable walls 22 by means of the manipulation seats 249 and moves them until pulling them out from the anchor wall 23′ (pulling them out from the pins 27, 231).

At this point, the coil 4, or coils 4, is/are removed from the winding tool 20.

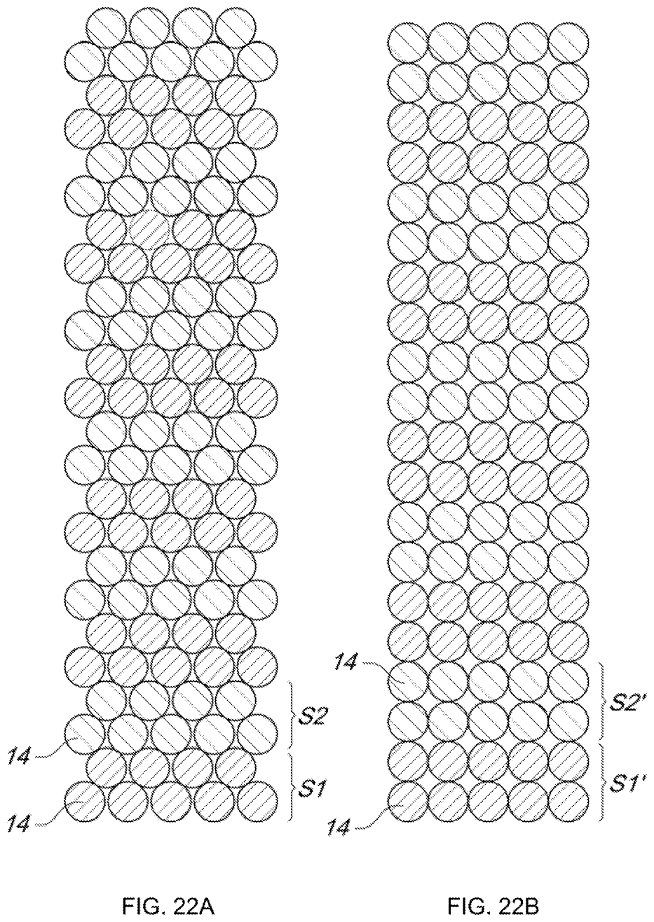

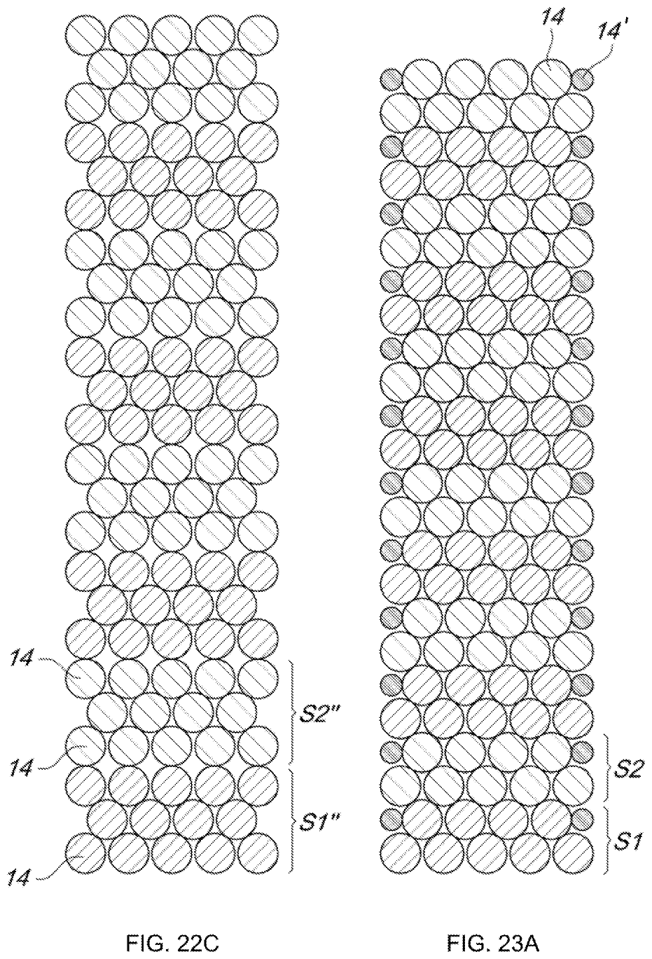

FIGS. 22a, 22b, 22c show three different examples of loops achievable with the winding tool 20 described, wherein:
in FIG. 22a, each loop S1, S2 is formed by two layers: a first layer of five wires and a second layer of four wires;
in FIG. 22b, each loop S1′, S2′ is formed by two layers, both of five wires;
in FIG. 22c, each loop S1″, S2″ is formed by three layers: a first layer of five wires, a second layer of four wires and a third layer of five wires.

These examples help understand how it is possible to recognize a star yoke stator manufactured according to the present invention from a star yoke stator manufactured according to the known art, by visually analyzing the arrangement and density of the wires in the sectors, or slots.

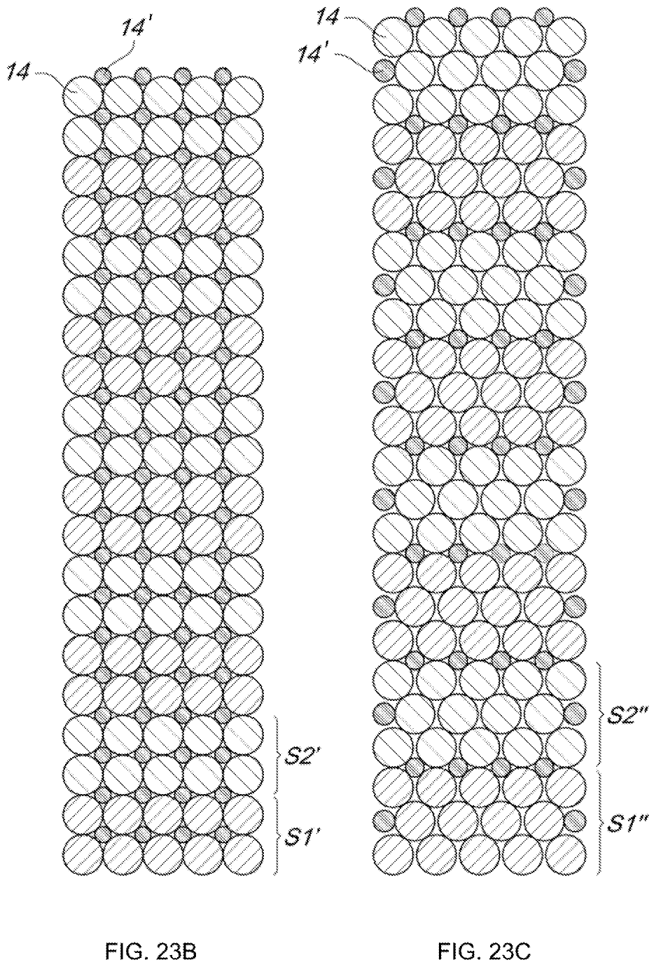

As can be noted, the round wires tend to leave free spaces; to overcome this problem, it is possible to resort to an optional solution depicted in FIGS. 23a, 23b, 23c.

According to this optional and advantageous solution for the filling factor, during the coil making step and, more precisely, while winding, complementary conducting wires of a smaller section 14′, which occupy the space left free from the tangency of the wires 14 of a greater section (i.e. the free spaces between the aforesaid wires 14 of greater section), are added to each loop S1, S2. This way, in the winding step, each loop S1, S2 will be formed by layers of wires of a different section, alternated with each other and which, once wound, allow to achieve an even greater filling factor.

FIGS. 20 and 21 show a variant of the winding machine 200 and a second embodiment of the winding tool 20, usable as an alternative to the first. A wire directing device 150, which automatically allows to manage the distance between the various levels of wires 14 coming in by means of a controlled axis, is used instead of the wire guiding device 206 with an individual wire guiding tube 204 of FIG. 206.

This wire directing device 150 comprises an axial guide 151 along which a plurality of wire guiding tubes 152 slide in a controlled way and independently of one another.

The axial guide 151 in turn slides along a perpendicular guide 153, so that the wire guiding tubes 152 are movable along at least two axes.

Each wire guiding tube 152 is crossed by, and in practice directs, a layer of wires 14.

During the various winding steps, the wire guiding tubes 152 can move closer to each other up to bringing the various levels of wire into contact, or can move away from one another so that each layer enters the winding independently and at a different time than the others.

This makes it possible to deposit each layer on the winding tool 20 independently of the others so that to prevent them from getting in each other's way.

Whenever required, the wire guiding tubes 152 move close to each other again to facilitate the operations which require the wires 14 to all be close together.

Optionally, in this embodiment, the winding tool 20 is rotated by a winding spindle 244′ which is integral to a motor assembly 157 fixed to a carriage 158 movable along a track 159 (guide or track or the like).

Considering the winding machine 200 shown in FIGS. 20-21 and the respective winding tool 20, following the coil forming step A, the method provides a pressing and/or carburizing step B, as previously described and as will now be depicted with reference to FIGS. 24 to 29B.

The heating device 30′ shown in FIGS. 28A and 28B comprises one or more heating elements 31, preferably by induction. These heating elements 31 are shaped and arranged so that to be inserted between the linear portions 4a, 4b of the coils, in contact therewith or adjacent thereto. It is possible to perform this operation while the coil 4 is still accommodated on the winding tool 20, thanks to the fact that the linear portions 4a, 4b are left free.

Thus, these heating elements 31 have a longitudinal extent substantially equivalent to that of the linear portions 4a, 4b to be heated.

It should be noted that in the embodiment depicted, the heating elements 31 substantially form a comb of elements parallel to one another.

In practice, the heating elements 31 are inserted between the linear portions 4a, 4b of the coils so that to heat them up to the carburizing temperature, as depicted in FIG. 28B.

There is thus time to remove the heating elements 31 and to insert, in their place, the pressing device 300 which presses the winding, by exploiting the thermal inertia of the material.

In the embodiment depicted in FIGS. 29, concerning the winding tool 20 mounted on the winding machine 200 shown in FIGS. 20-21, the pressing device 300 comprises a plate 301 to which a series of inclined planes 303 adapted for coming into contact with the linear portions 4a, 4b to be pressed, is combined. The plate 301 is inserted into, or is anyhow mechanically coupled to, a complementary counterplate 302′ positioned on the opposite side of the linear portions 4a, 4b, which complementary counterplate 302′ in practice acts as an abutment element.

The plate 301 is pushed by means of a thrust device (not depicted) against the counterplate 302′. The inclined planes 303 are configured so that the moving of the plate 301 towards the counterplate 302′ causes, by direct mechanical interaction, the compacting of the linear portions of the coil 4a, 4b.

Thus, the linear portions 4a, 4b of the winding are compacted to the desired dimensions by exploiting the force of the thrust device and the appropriately made inclined planes 303.

These carburizing and pressing operations can be implemented alternately or contemporaneously on the two sides of the winding tool 20, depending on the cycle time required by the plant during production.

Conveniently, only the linear portions 4a, 4b of the coil 4 are pressed and/or subjected to thermal treatment, while the non-linear portions (i.e. the parts of the coil 4 connecting the linear portions 4a, 4b, which are mainly curved and form the header of the coil 4) are left untreated so that to be able to easily shape them in the successive steps.

After the pressing and/or carburizing step B, when the coil 4 has cooled and thus solidified in the linear portions 4a, 4b, the coil 4, or coils 4, can be removed from the winding tool 20 (any one of those described herein).

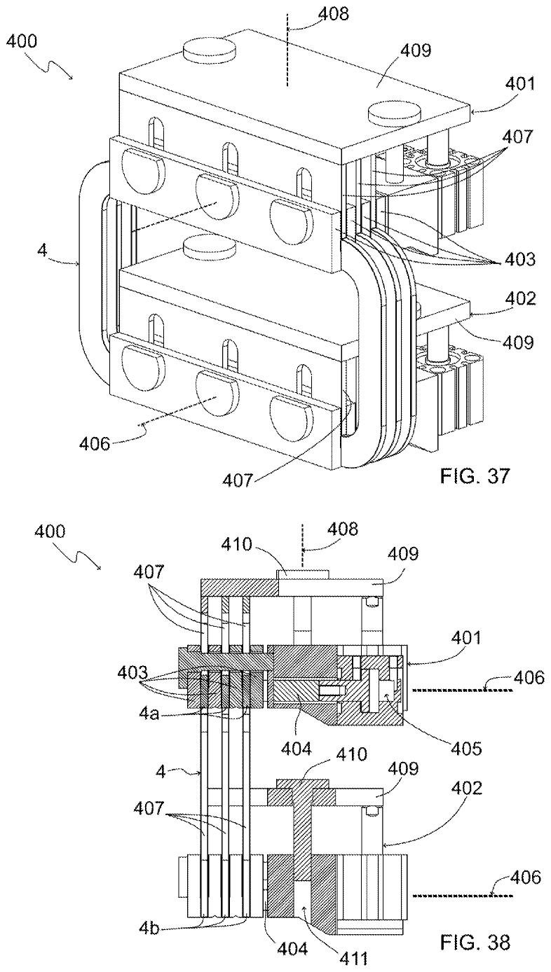

Optionally, whenever, in the coil making step A, a series of more coils 4 is made on the same winding tool 20 so that a linear portion 4a, 4b of a coil 4 is spaced from the linear portion of the successive coil 4 by a predetermined pitch distance, a step of correcting the pitch between the coils 4 is performed before housing the coils 4 in the stator slots. The pitch correction is achieved by:
taking the series of coils 4 from the winding tool 20 and bringing them on a pitch-correcting device (not shown) configured for correcting the pitch distance between the linear portions 4a, 4b of the different coils 4,
taking the coils 4 from the pitch-correcting device by means of the grippers shown for example in FIGS. 37 and 38 and configured for keeping the pitch distance unvaried between the linear portions 4a, 4b of the coils 4, after having achieved the pitch correction. These grippers will insert the coils 4 between the stator teeth of the star.

Optionally, during the pitch-correcting process, it is possible to introduce insulating papers, which protect the coils 4 themselves from being damaged inside the stator slots, inside the coils 4 (preferably around the linear portions 4a, 4b).

Thanks to the step A of forming the coils 4 described above, coils 4 with rectilinear portions 4a, 4b, and whose cross section has a shape complementary to that of the stator slot 106 into which they must be inserted, are made. Thus, it is possible to exploit the entire area of the stator slot 106 while contemporaneously keeping the conducting wires 14, 14′ orderly and maximizing the filling factor.

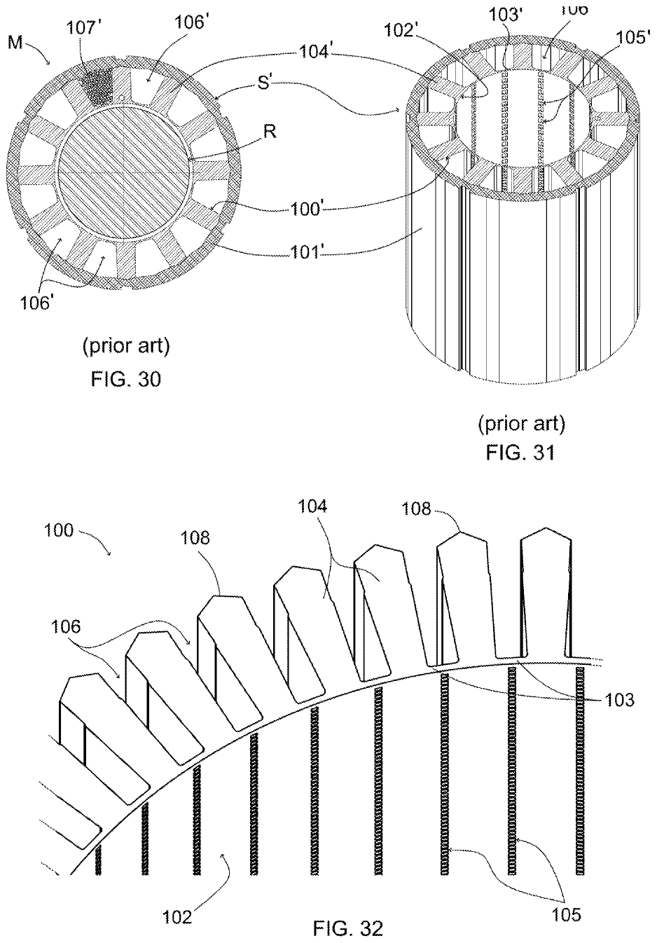

FIG. 30 is a schematic cross sectional and plan view of an electric motor M according to the known art, comprising a star yoke stator S′ and a rotor R arranged rotatably and coaxially on its rotation axis inside the stator S′. The stator S′ is of the two-component type, i.e. consists of an outer cylindrical body 101′, the yoke, and an inner body 100′ named star, constituted by a pack of stacked metal laminations.

FIG. 31 shows the star 100′ in perspective, extending from an inner cylindrical surface 102′ defined by the pole shoes 103′ of all stator teeth 104′ and by the stator teeth 104′ themselves, which stator teeth extend radially outwardly from the inner cylindrical surface 102′. The inner cylindrical surface 102′ of the star 100′ is substantially continuous, except for small windows or openings 105′ made to lighten the stator and minimize electromagnetic short-circuit phenomena. The stator slots 106′, intended for housing the coils of conducting wire, are defined between the stator teeth 104′, the inner cylindrical surface 102′ and the yoke 101′.

For simplicity in FIG. 30 only one stator slot is drawn with a winding 107′ of conducting wire present. A conventional motor M, such as the one shown in FIG. 30, is recognizable for the fact that the distribution of the conducting wire in the windings 107′ is not orderly or can anyhow be perfected.

The object of the present invention is precisely to maximize the filling factor by providing a method and an apparatus which allow to automatically assemble a stator with perfectly orderly coils 4 obtained as described above with reference to FIGS. 2-29 and made to better occupy the stator slots with a complementary shape and an orderly arrangement.

FIG. 32 is a perspective view of a star 100 of a stator S1, S2 according to the present invention, which is different from the star 100′ of the stator S′ of the known art for in that the stator teeth 104 are pointed at the end 108 opposite the pole shoe 103. In practice, the end 108 of the stator teeth 104 is pointed for stabilizing the coupling to the yoke, as will be described below.

A further difference between the star 100 and the star 100′ lies in the shape of the stator slots. A simple visual comparison highlights that the stator slots 106′ of the stator S′ according to the known art are slice-shaped, i.e. they widen in an outer radial direction, whereas the stator slots 106 of the stator S according to the present invention are substantially rectangular in shape and thus provide greater compatibility with the coils 4 in terms of shape.

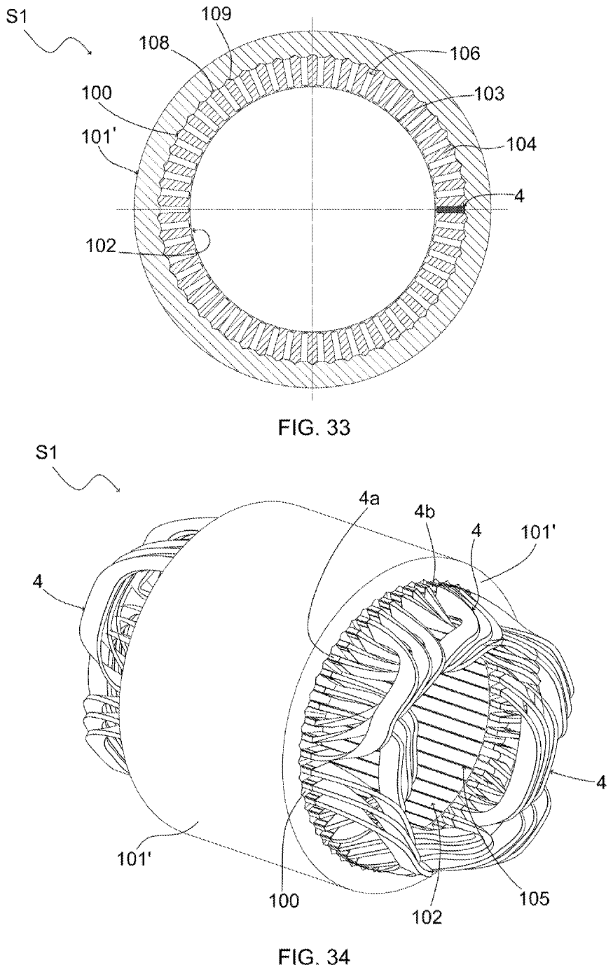

FIG. 33 is a cross sectional view of a stator S1 according to a first embodiment of the present invention: an individual winding constituted by a linear portion 4a or 4b of a coil 4 is shown for simplicity. The star 100 is forcibly inserted into the yoke 101′, in the sense that the coupling among these elements is carried out by interference. As will be explained below, the yoke 101′ is fit by interference on the star 100 after the coils 4 were all properly positioned, so that the pointed end 108 of the stator teeth 104 is inserted into a corresponding longitudinal groove 109 formed in the inner surface of the yoke 101′. The pointed shape of the stator teeth 104, together with the shape coupling to the corresponding grooves 109, ensures the mechanical seal of the stator S made in the two components 100, 101′.

FIG. 34 is a perspective view of the stator S1 complete of all windings, i.e. with the stator slots 106 all engaged by a linear portion 4a or 4b of a coil 4. As can be observed, the inner surface 102 of the star 100 is continuous, except for the windows or openings 105. In this configuration, the stator S1 is ready to accommodate a rotor R for completing the electric motor.

As can be noted, the first embodiment of the stator S1 is provided with a yoke 101′ made in one piece from a mechanical cylinder.

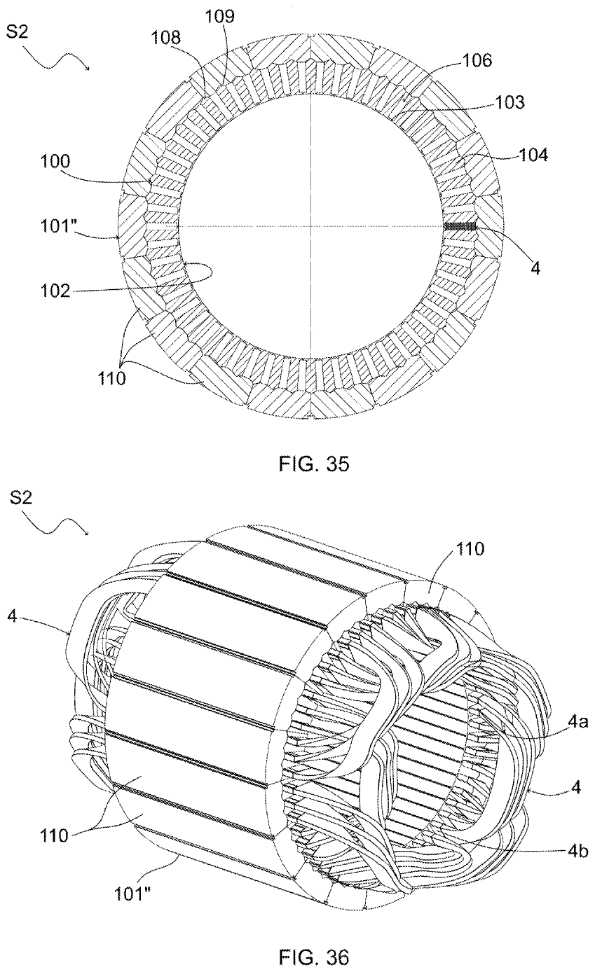

FIG. 35 is a cross sectional view of a stator S2 according to a second embodiment of the present invention: an individual winding constituted by a linear portion 4a or 4b of a coil 4 is shown for simplicity. The star 100 is forcibly inserted into the yoke 101″, in the sense that the coupling among these elements is carried out by interference. As will be explained below, the yoke 101′ is constructed around the star 100 by fastening sectors 110 of the yoke 101″ as the coils 4 are properly inserted into the stator slots 106, so that the pointed end 108 of the stator teeth 104 is inserted into a corresponding longitudinal groove 109 formed in the inner surface of each sector 110 of the yoke 101′. The pointed shape of the stator teeth 104, together with the shape coupling to the corresponding grooves 109, ensures the mechanical seal of the stator S made in the two components 100, 101″.

FIG. 36 is a perspective view of the stator S2 complete of all windings, i.e. with the stator slots 106 all engaged by a linear portion 4a or 4b of a coil 4. As can be observed, the inner surface 102 of the star 100 is continuous, except for the windows or openings 105. In this configuration, the stator S2 is ready to accommodate a rotor R for completing the electric motor.

As can be noted, the second embodiment of the stator S2 is different from the first S1 in that the yoke 101″ is not made in one piece but is formed by assembling sectors 110 on the outside of the star 100.

The method and apparatus for making both the stators S1 and S2 will now be described.

First, with reference to FIGS. 37 and 38, the gripper system used for taking the coils 4 of conducting wire 14 from the winding machine 200 or from the pressing and/or carburizing apparatus 300 and for positioning them into the stator slots 106 of the star 100 will be described.

FIG. 37 shows a perspective view of a gripper system 400 comprising two grippers, the upper gripper 401 and the lower gripper 402, both used for handling a coil 4. FIG. 38 shows the system 400 in cross section (on different planes) and in elevation view. The coil 4 is shown arranged on a vertical plane: the linear portions 4a are restrained by the upper gripper 401 and the linear portions 4b are restrained by the lower gripper 402.

The grippers 401 and 402 are provided with jaws 403, the intermediate ones mounted floating on pins 404 and the first and last one fixed to the pins 404, for restraining the linear portions 4a and 4b; the pins 404 are connected to a pneumatic linear actuator 405 for example operating with compressed air, so that the pins 404 are translatable in the two directions along a horizontal direction 406 transversal to the linear portions 4a and 4b of the coils 4 for respectively opening and closing the jaws 403 on the linear portions 4a and 4b of the coil 4.

Thanks to this configuration, the grippers 401, 402 keep the pitch distance between the first linear portions 4a and between the second linear portions 4b of the coils 4 taken from the winding tool.

The grippers 401 and 402 are further provided with ejector elements 407 movable in the two directions along a vertical direction 408 orthogonal to the horizontal direction 406 for ejecting the linear portions 4a and 4b of the coils from the grippers 401 and 402 themselves. For this purpose, the ejector elements 407 are fixed to a plate 409 movable vertically in response to thrusts imparted by an external actuator. The movement of the plate 409 is guided by the pin 410 visible in FIG. 38, which pin moves in the hole 411.

The operation of the gripper system 400 is as follows:
whenever a coil 4 must be taken, both the grippers 401 and 402 are caused to engage the linear portions 4a and 4b of the coil 4 with the linear portions 4a and 4b inserted between the jaws 403;
the pneumatic actuator 405 is operated to grip the linear portions 4a and 4b;
at this point, the gripper system 400 can be moved together with the coil 4, which stays integral with the grippers 401 and 402 with no possibility of relative movements;
whenever the linear portions 4a or the linear portions 4b of the coil 4 must be ejected, the jaws 403 of the upper gripper 401 or the lower gripper 402 are respectively opened and the plate 409 is pushed downward to cause the ejector elements 407 to be inserted between the jaws 403 and thereby the linear portions 4a or 4b to be ejected.

The ejection of the linear portions 4a and 4b can occur, and is expected to occur, at different times: the upper gripper 401 and the lower gripper 402 are selectively operable.

The gripper system 400 just described is usable for making both the embodiments S1 and S2 of the stator according to the present invention.

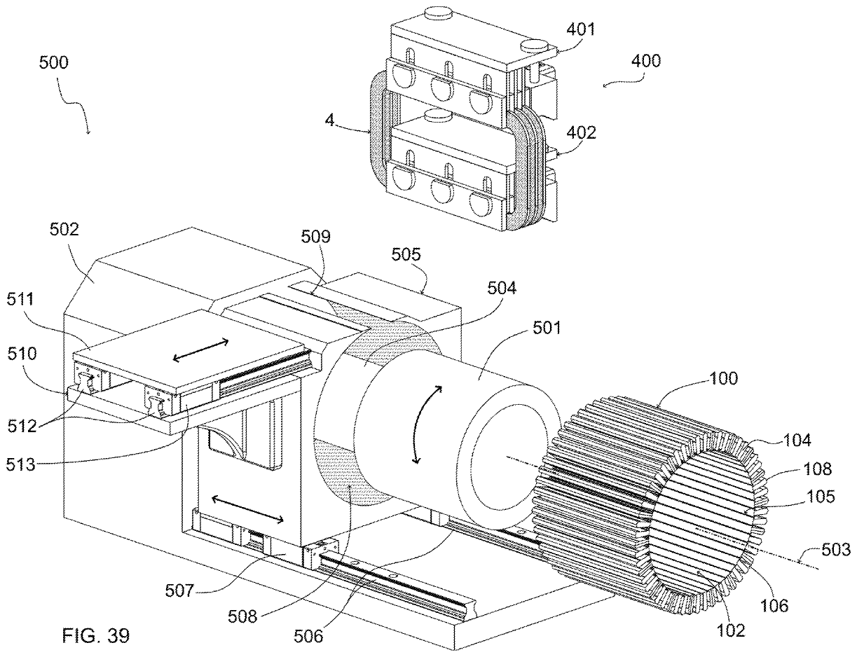

FIG. 39 is a perspective view of a first apparatus 500 for manufacturing the stator S1 according to the first embodiment. The apparatus 500 comprises a spindle 501 mounted on a shaft 504 extending cantileverly from the supporting structure 502, so that to be rotatable with respect to the supporting structure 502 itself about a horizontal rotation axis 503 and with respect to which the directions are defined longitudinal, transversal or radial. The spindle 501 is rotatable, being rotated by a motor housed in the supporting structure 502 not visible in the drawings.

The apparatus 500 further comprises a carriage 505 provided with sliding blocks 507 and mounted on coplanar tracks 506 parallel to the rotation axis 503 of the spindle 501. Thanks to this configuration, the carriage 505 is translatably movable on the tracks 506, on the sliding blocks 507, between a first position and a second position:
in the first position, proximal to the supporting structure 502, the carriage 505 extends around the shaft 504 but does not intercept the spindle 501, as shown in FIG. 39, and
in the second position, shown in the other figures, the carriage 505 extends around the spindle 501 but does not intercept the shaft 504 and only partially intercepts it.

The longitudinal displacement of the carriage 505 on the tracks 506 is achieved by means of a special actuator, for example of the linear or rack type, mounted on the supporting structure 502 or directly aboard the carriage 505.

The carriage 505 has a longitudinal extent, considered along the rotation axis 503, at least equal to the longitudinal extent of the spindle 501. The carriage 505 is hollow inside: has an inner cylindrical surface 508 coaxial to the rotation axis 503 and thus coaxial to the shaft 504 and the spindle 501.

The inner cylindrical surface 508 of the carriage 505 is broken at a longitudinal opening 509, i.e. an opening parallel to a generatrix of the inner cylindrical surface 508. The longitudinal opening 509 gives to the carriage 505 an almost horseshoe-like shape and allows the gripper system 400 to access the inside of the carriage 505 from the outside, in particular, the longitudinal opening 509 provides to the gripper system 400 the possibility of interacting with the star 100 whenever the latter is fit on the spindle 501 and the carriage 505 is in the second position, as will be explained below.

The longitudinal opening 509 has a width, measured in circumferential direction with respect to the inner cylindrical surface 508 of the carriage 505, sufficient for allowing a coil 4 to be inserted, in particular the insertion of the linear portions 4a and 4b of a coil 4, from the outside of the carriage 505 into the volume intercepted by the inner cylindrical surface 508. In the example shown in the figures, since the coil 4 comprises three linear portions 4a and three linear portions 4b, the longitudinal opening 509 has a width equal to at least the circumferential extent of three stator slots 106 of the star 100. Whenever there would only be one linear portion, the width of the longitudinal opening 509 would clearly be smaller, equal to at least the circumferential extent of an individual stator slot 106 of the star 100.

The apparatus 500 further comprises a closing device 510 configured to close the longitudinal opening 509, temporarily and on command. In the example shown, the closing device 510 is mounted aboard the carriage 505 and moves therewith.

In the embodiment shown in the figures, the closing device 510 is a slide-like, or drawer-like, device provided with a panel 511 mounted on tracks 512, thanks to sliding blocks 513 acting as actuators. The tracks 512 are parallel to one another and are arranged askew to the rotation axis 503, so that the panel 511 is movable between a retracted position and a forward position, thus staying tangential to the inner cylindrical surface 508 of the carriage 505. In particular:
in the retracted position shown in FIG. 39, the panel 511 does not intercept the longitudinal opening 509, which stays usable for the insertion of a linear portion 4a, 4b of the coil 4 by the gripper system 400;
in the forward position shown in other figures, the panel 511 intercepts the longitudinal opening 509 and closes it, thus preventing a linear portion 4a, 4b from escaping from the inside of the carriage 505 through the longitudinal opening 509.

As will be noted with reference to other figures, the longitudinal extent (parallel to the axis 503) of the panel 511 corresponds to the longitudinal extent of the longitudinal opening 509, for not interfering with the headers (the non-linear portions) of the coil 4.

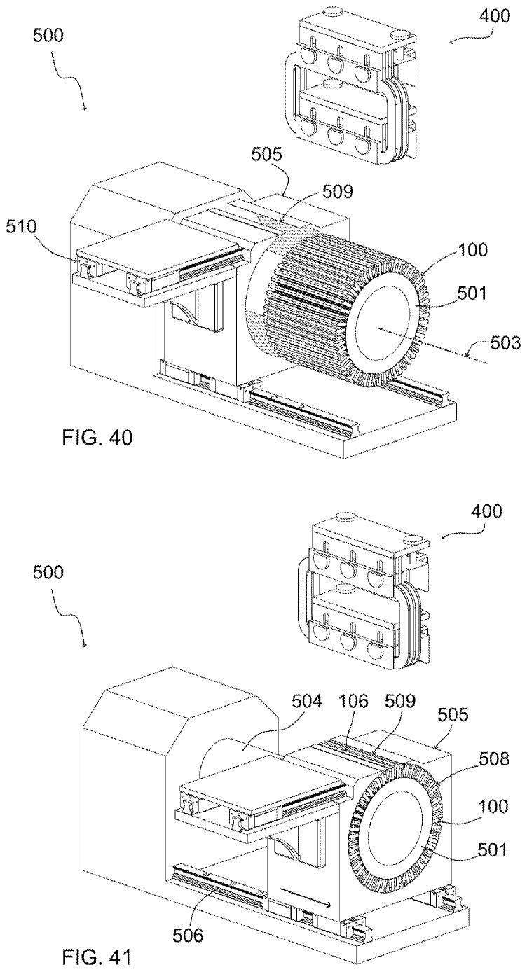

Initially, as shown in FIG. 40, the star 100 of the stator S1 is fit on the spindle 501, so that the stator teeth 104 are directed radially towards the outside and the stator slots 106 are also arranged radially with respect to the rotation axis 503. In the configuration shown in FIG. 40, the carriage 505 is in the first position and the closing device 510 keeps the panel 511 in the retracted position, thus leaving the longitudinal opening 509 open.

FIG. 41 shows a successive configuration over time with respect to the configuration shown in FIG. 40. The carriage 505 is pushed to the second position on the tracks 506. The carriage 505 encloses the spindle and the star 100; more in particular, the star 100 stays interposed with minimum clearance between the outer surface of the spindle 501 and the inner cylindrical surface 508 of the carriage 505. The clearance is minimal, sufficient for allowing the spindle 501 with the star 100 integral therewith to rotate without interfering with the inner cylindrical surface 508 of the carriage 505.

The spindle 501 is rotated by an angle sufficient for bringing a stator slot 106 of the star 100 at the longitudinal opening 509 and, in this position shown in FIG. 41, the spindle 501 is stopped: the stator slot 106 facing upward stays accessible to the gripper system 400, precisely through the longitudinal opening 509.

The rotation of the spindle 501 is intermittent and is used to rotate the star 100 by an angle corresponding to the angular distance between the two stator slots which must accommodate the linear portions 4a, 4b of coil. At the end of the rotation, the spindle 501 is stopped and kept stationary until a new rotation is needed. The rotations of the spindle 501 are thus alternated with the insertions of the linear portions 4a, 4b of a coil 4.

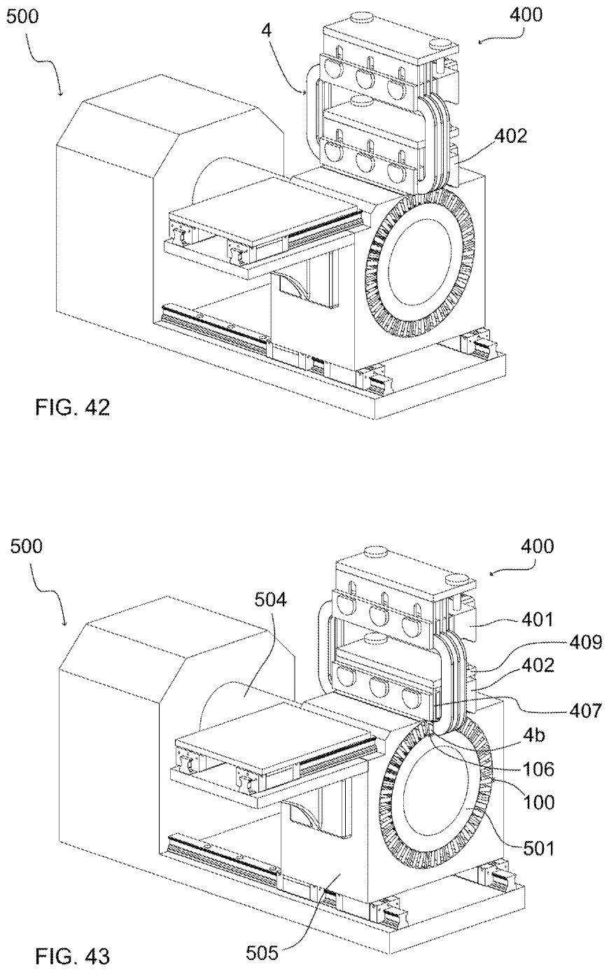

FIG. 42 shows a successive configuration over time with respect to the configuration shown in FIG. 41. The gripper system 400 was displaced at the longitudinal opening 509. In particular, the lower gripper 402 restraining linear portions 4b of the coil 4 is brought at the borders of the longitudinal opening 509, or in abutment thereon. The other components of the apparatus 500 stay stationary, just as the star 100 stays stationary. In the example shown, the coil 4 comprises three linear portions 4b (and three corresponding linear portions 4a), like in the configuration shown in FIGS. 37 and 38.

FIG. 43 shows a successive configuration over time with respect to the configuration shown in FIG. 42. The spindle 501 is kept stationary together with the star 100. The lower gripper 402 is kept stationary with respect to the position shown in FIG. 42. The ejector elements 407 of the lower gripper 402 were lowered vertically by the plate 409 (FIG. 38) for ejecting the three linear portions 4b of the coil 4 from the gripper 402 and inserting them into the corresponding three stator slots 106 through the longitudinal opening 509. The upper gripper 401 was lowered by a height corresponding to the travel made by the ejector elements 407 of the lower gripper 402, so that to facilitate the displacement of the coil 4 in radial direction.

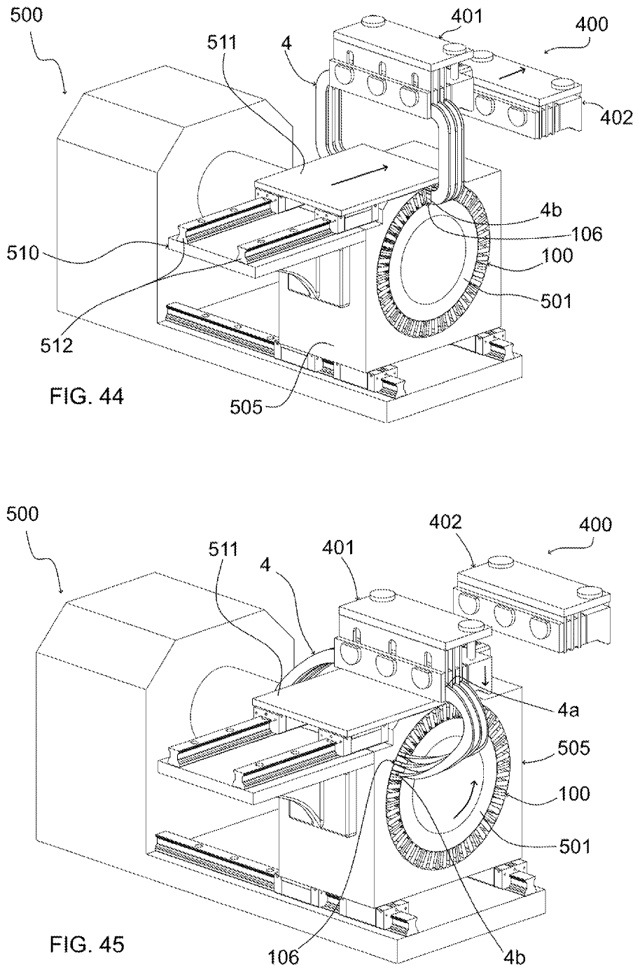

FIG. 44 shows a successive configuration over time with respect to the configuration shown in FIG. 43. The spindle 501 is kept stationary together with the star 100. The lower gripper 402 was moved away from the carriage 505 with a transversal movement relative to the containment plane of the coil 4. Simultaneously to, or right after, the moving away of the lower gripper 402, the closing device 510 is operated and the panel 511 is pushed and kept in the respective forward position, at which the longitudinal opening 509 stays closed by the panel 511 acting as an external, and temporary, closing element of the stator slots 106. Thanks to this arrangement, the linear portions 4b of the coil 4 cannot disengage the corresponding stator slots 106.

FIG. 45 shows a successive configuration over time with respect to the configuration shown in FIG. 44. Seeing the stator S1 being manufactured is of the distributed winding type, the spindle 501 was rotated (anticlockwise when observing the figure) by an angle corresponding to a phase of the stator S1, and the upper gripper 401 is simultaneously lowered and goes at, or abuts against, the panel 511. The simultaneous rotary movement of the spindle 501 about the rotation axis 503 and the vertical translatory movement of the first gripper 401 cause the deformation of the coil 4.

The linear portions 4b, initially restrained in the respective stator slots 106 between the star 100 and the panel 511, stay properly housed in the stator slots 106 thanks to the presence of the inner cylindrical surface 508 of the carriage 505, which surrounds the star 100 on the outside, and thus rotate integrally with the star 100.

The lowering of the upper gripper 401 brings the linear portions 4a, which are still restrained in the upper gripper 401, at the panel 511 and, thus, above the longitudinal opening 509 aligned therewith.

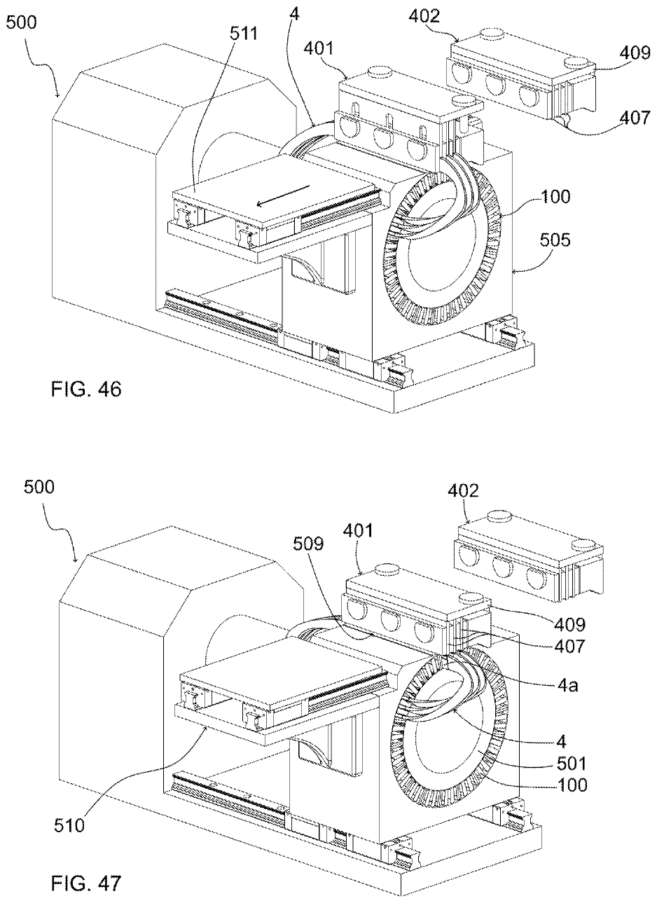

FIG. 46 shows a successive configuration over time with respect to the configuration shown in FIG. 45. The panel 511 was retracted, i.e. brought to its retracted position, to leave the longitudinal opening 509 accessible to the upper gripper 401 which is further lowered for abutting against the borders of the longitudinal opening 509. The linear portions 4a of the coil 4 are still restrained by the upper gripper 401.

FIG. 47 shows a successive configuration over time with respect to the configuration shown in FIG. 46. The ejector elements 407 of the upper gripper 401 were operated by lowering the plate 409, and the linear portions 4a of the coil 4 were pushed into the respective stator slots 106 made accessible thanks to the moving back of the panel 511 described in the previous paragraph.

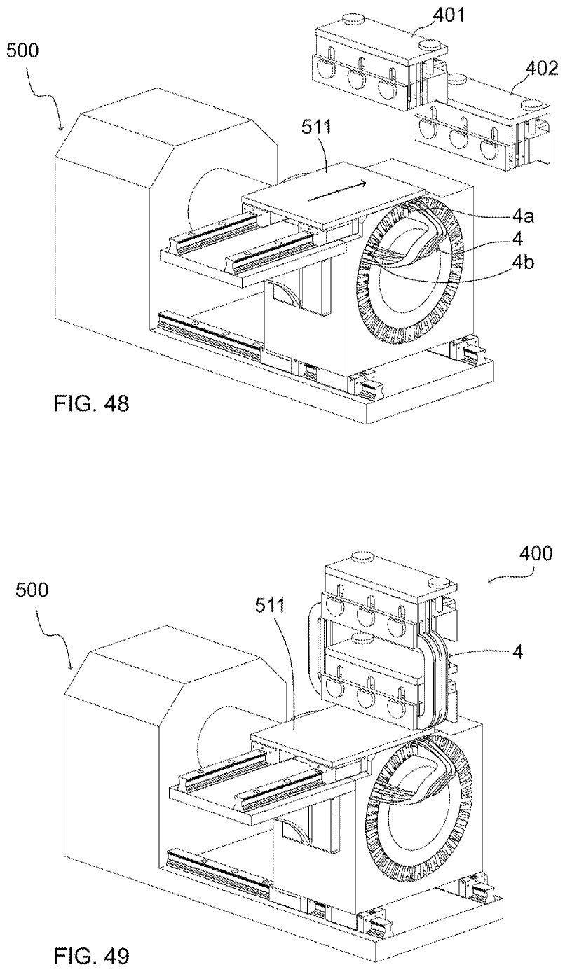

FIG. 48 shows a successive configuration over time with respect to the configuration shown in FIG. 47. The gripper system 400 is moved away from the apparatus 500 and the panel 511 is pushed to the forward position for once again closing the longitudinal opening 509 and preventing the linear portions 4a of the coil 4 from coming out from the stator slots 106. In this configuration, the coil 4 is completely inserted into the star 100: three linear portions 4b and three linear portions 4a angularly offset by an angle corresponding to an electric phase. The spindle 501 is stationary.

FIG. 49 shows a successive configuration over time with respect to the configuration shown in FIG. 48. The gripper system 400 is brought at the panel 511 with a new coil 4 locked in the grippers 401 and 402.

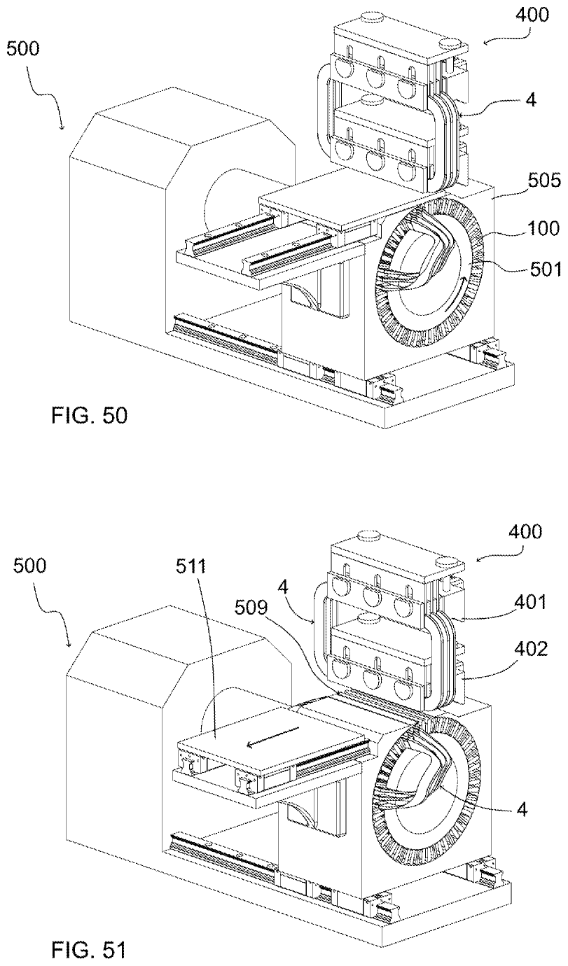

FIG. 50 shows a successive configuration over time with respect to the configuration shown in FIG. 49. The spindle 501 was rotated by an angle corresponding to bring the stator slots 106 of the star 100 corresponding to a new electric phase at the longitudinal opening 509. The panel 511 stays stationary in the forward position, just as the gripper system 400 stays stationary.

FIG. 51 shows a successive configuration over time with respect to the configuration shown in FIG. 50. The spindle 501 stayed stationary from the previous configuration of FIG. 50. The panel 511 was brought to the retracted position and the longitudinal opening 509 is open and accessible to the lower gripper 402, so that to leave the three stator slots 106 of the star 100, into which the linear portions 4b of the new coil 4 are inserted, accessible.

The steps described with reference to FIGS. 44-50 are repeated but for the new coil 4, so that to arrange two coils 4 on the star 100.

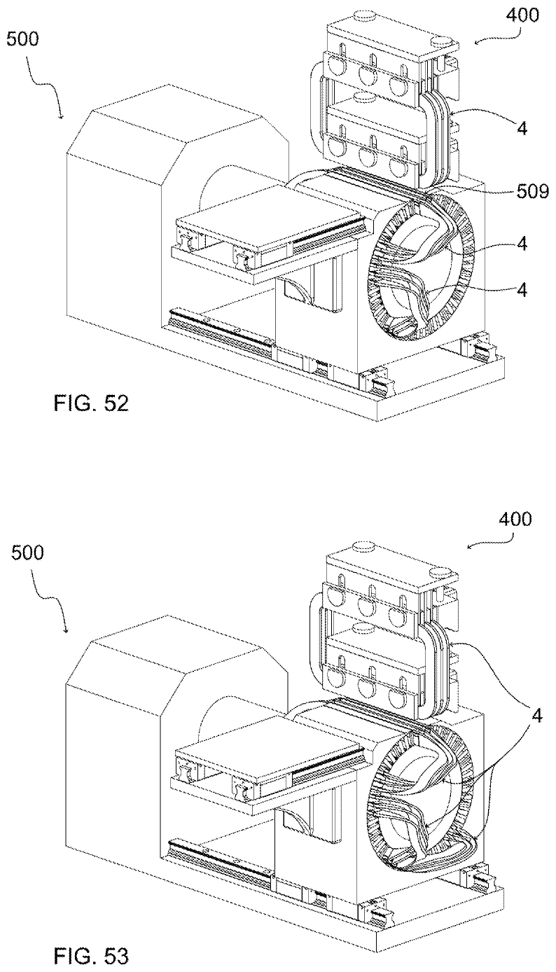

FIG. 52 shows a successive configuration over time with respect to the housing of the first and second coil 4, and a third coil 4 is ready for being manipulated.

FIG. 53 shows a successive configuration over time with respect to the configuration shown in FIG. 52. Three coils 4 were already housed on the star 100 and a fourth coil 4 is about to be moved.

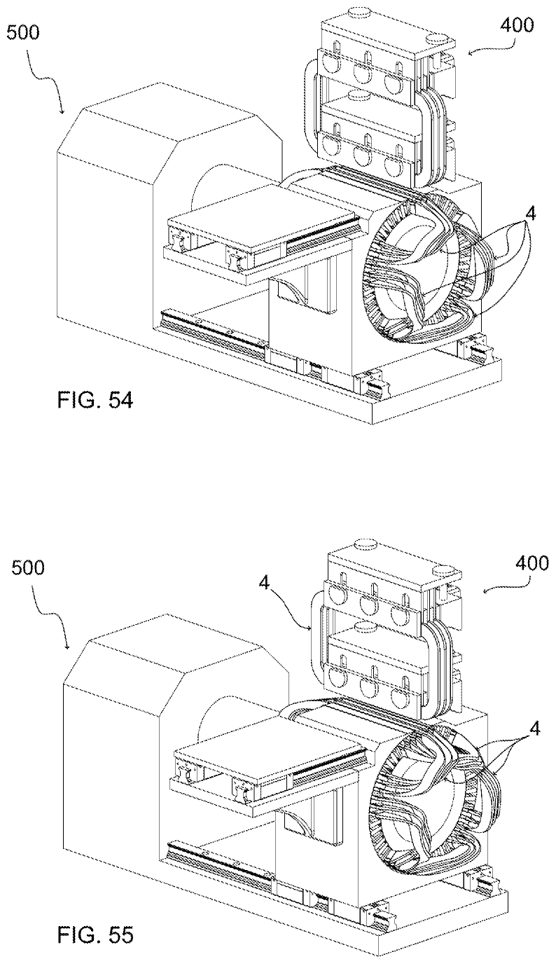

FIG. 54 shows a successive configuration over time with respect to the configuration shown in FIG. 53. Four coils 4 were already housed on the star 100 and a fifth coil 4 is about to be manipulated for the insertion of the linear portions 4a and 4b into the stator slots 106.

FIG. 55 shows a successive configuration over time with respect to the configuration shown in FIG. 54. Five coils 4 were already housed on the star 100 and a sixth coil 4 is about to be manipulated for the insertion of the linear portions 4a and 4b into the stator slots 106.

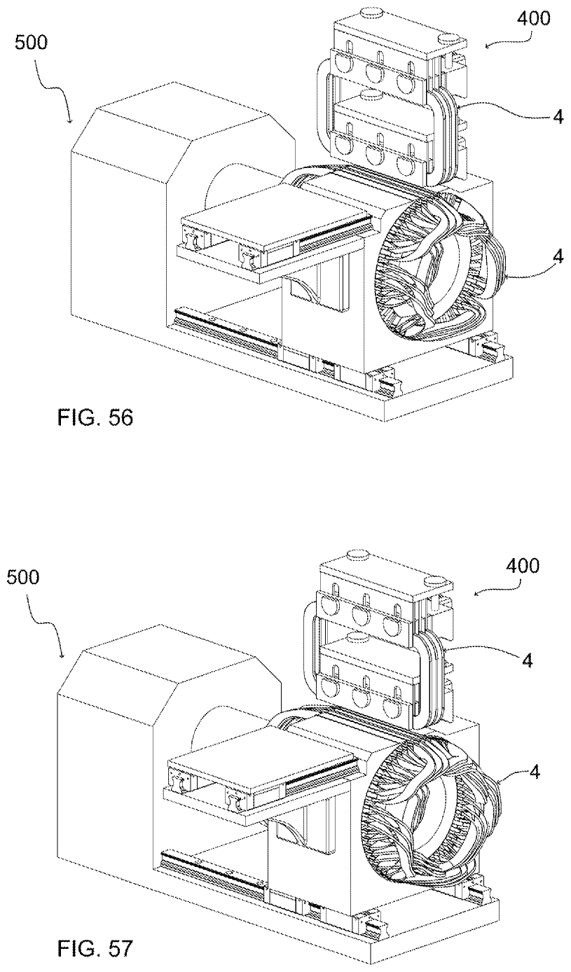

FIG. 56 shows a successive configuration over time with respect to the configuration shown in FIG. 55. Six coils 4 were already housed on the star 100 and a seventh coil 4 is about to be manipulated for the insertion of the linear portions 4a and 4b into the stator slots 106.

FIG. 57 shows a successive configuration over time with respect to the configuration shown in FIG. 56. Eight coils 4 were already housed on the star 100 and a ninth coil 4 is about to be manipulated for the insertion of the linear portions 4a and 4b into the stator slots 106.

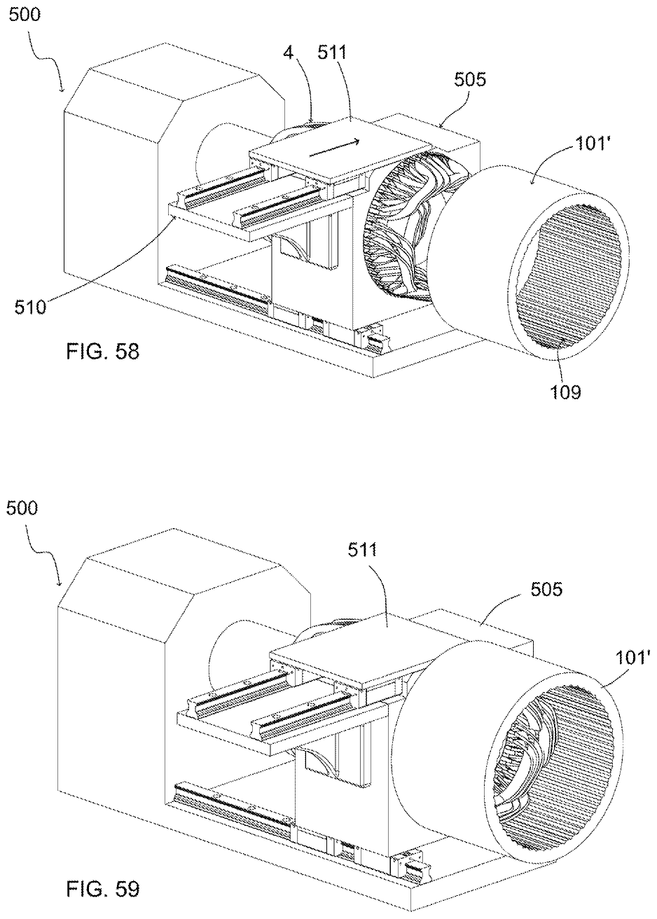

FIGS. 58-61 show the final steps of the method for manufacturing the stator S1.

In particular, FIG. 58 shows the apparatus 500 in a configuration in which the windings on the star 100 were completed. Nine coils 4 were constrained to the star 100. The panel 511 is brought to the forward position for closing the longitudinal opening 509.

A yoke 101′, made in one piece, is moved closer to the carriage 505. The yoke 101′ is cylindrical: longitudinal grooves 109, into which the pointed ends 108 of the stator teeth 104 of the star 100 will be inserted, are formed on its inner surface.

The yoke 101′ is shown in abutment against the carriage 505 in FIG. 59. The yoke 101′ is supported coaxial to the rotation axis 503 of the spindle 501 with appropriate means (not shown). In this step, the spindle 501 stays stationary, just as the panel 511 which stays stationary in the forward position. The yoke 101′ and the star 100 are angularly aligned, in the sense that the pointed ends 108 of the stator teeth 104 are aligned with the longitudinal grooves 109 of the yoke 101′.

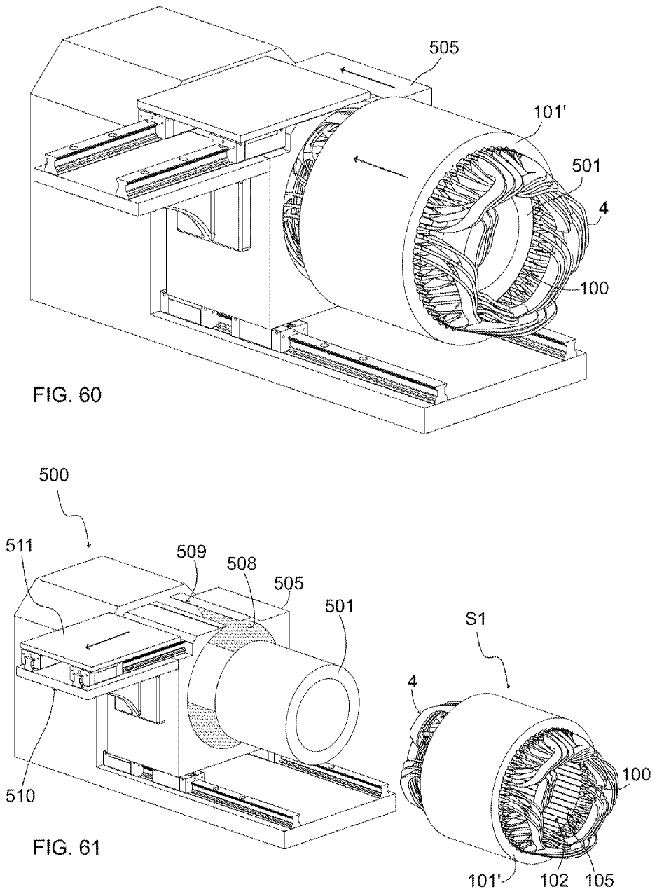

FIG. 60 shows a successive time, in which the carriage 505 is moving back, i.e. is displaced from the second position, where it stayed stationary up to now, to the first position, at which it does not intercept the semi-finished product constituted by the star 100 with the windings completed. Simultaneously to the displacement of the carriage 505 on the tracks 506, the yoke 101′ is moved forward and follows the carriage 505 by being fit on the semi-finished product, i.e. on the star 100 with the windings. The yoke 101′ is forced onto the star 100, in the sense that the coupling involves interference.

FIG. 61 shows the last step: the stator S1 has been completed and is pulled out of the spindle 501. The panel 511 of the closing device 510 is moved back to release the longitudinal opening 509; the apparatus 500 is now ready to start a new working cycle for manufacturing another stator S1.

The spindle 501 is preferably a spindle of variable geometry which can vary its diameter, so that to allow the star 100 to be locked and also the stator S1 to be pulled out.

Summarizing, the star 100 is thus fit on the spindle 501, the carriage 505 is brought to the second position at which it surrounds the star 100, however leaving one or more stator slots 106 accessible. A closing device 510 is operable for closing the stator slots left accessible by the carriage 505. The insertion of the linear portions 4a, 4b of the coils 4, according to the desired electric layout, is achieved by synchronizing the movement of the gripper system 400 with the rotations of the spindle 501 and the movements of the closing device 510. Once the coils 4 are all housed, a yoke 101′ is fit on the star 100 and the stator S1 is complete.

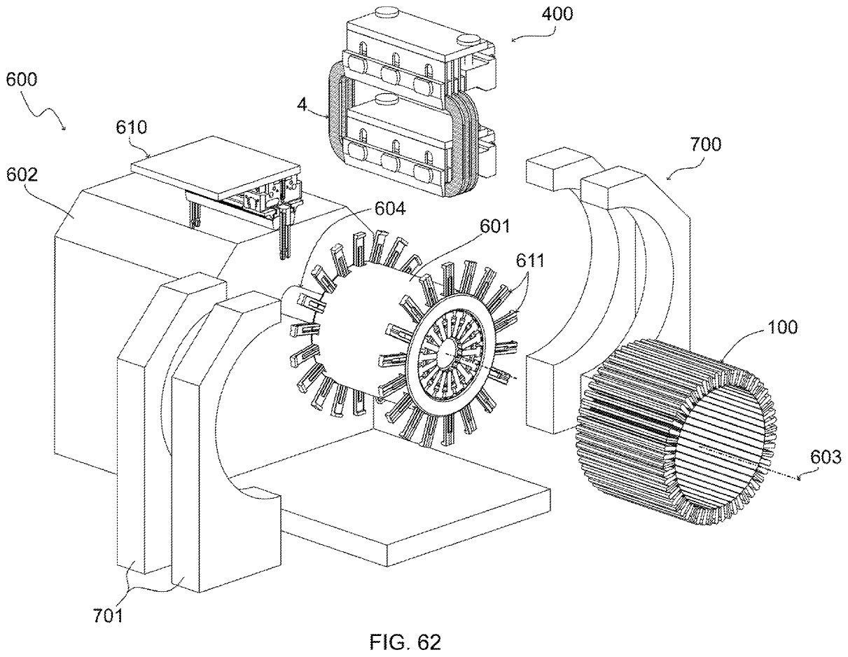

With reference to FIGS. 62-91, the method and apparatus 600 for implementing the second embodiment of the stator S2 will now be described. The gripper system 400 is the same as the one described above with reference to the first embodiment S1.

FIG. 62 is a perspective view of the apparatus 600, which comprises a supporting structure 602 bearing a spindle 601 cantileverly on a shaft 604. The shaft 604 and the spindle 601 are rotatable about a rotation axis 603 with respect to which the directions are defined longitudinal, transversal or radial. The rotation is imparted by an actuator inside the supporting structure 602 (not shown). The rotating spindle 601 has the task of supporting the star 100 during the insertion of the rectilinear portions 4a and 4b of the coils 4 into the stator slots 106.

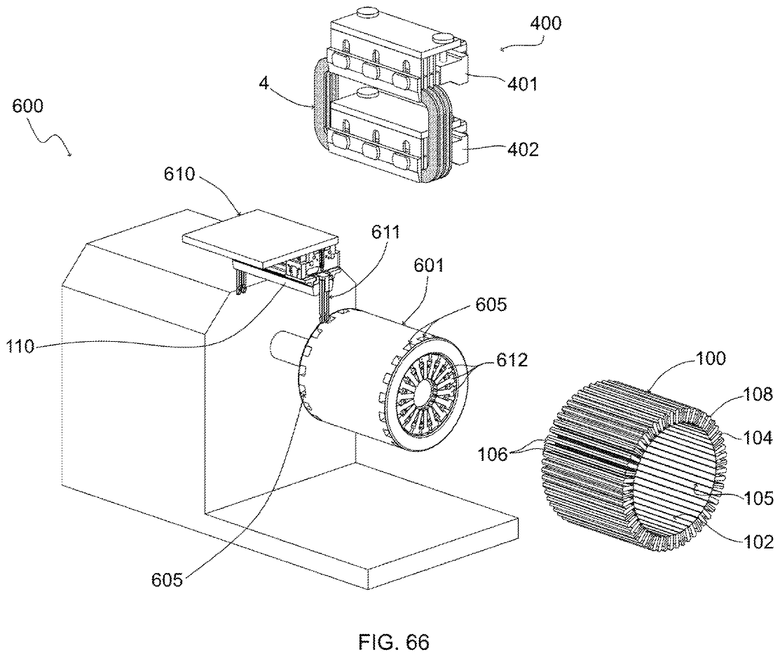

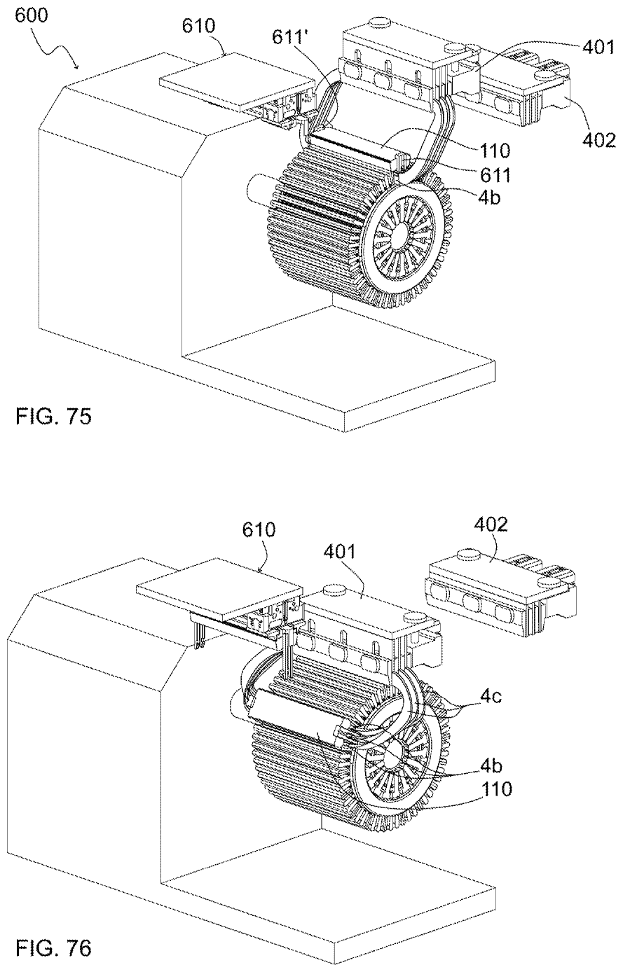

The apparatus 600 further comprises a system 610 for manipulating sectors 110 of the yoke 101″ (shown in FIGS. 35, 36, 63 and in FIG. 75) and whose operations exploit a plurality of fork-shaped elements 611. All the fork-shaped elements 611 inserted into corresponding radial seats 605 of the spindle 601 (FIG. 66) are shown in FIG. 62, but this is only a preview of a temporary configuration, as will be better explained below.

The apparatus 600 further comprises a system 700 of jaws 701 movable closer to and away from the spindle 601 for restraining the sectors 110 of the yoke 101″ and allowing the completed stator S2 to be unloaded.

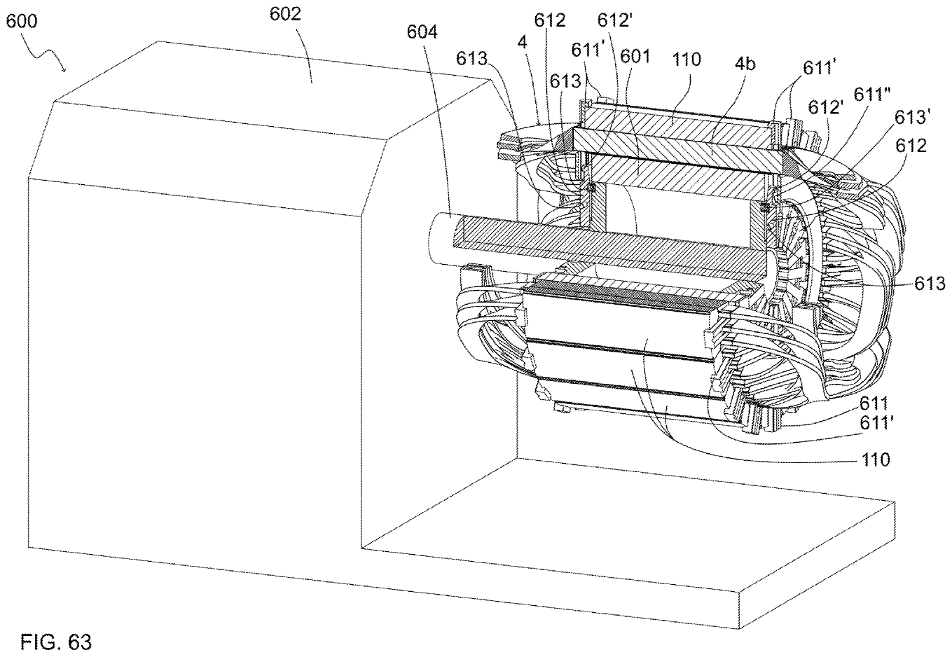

FIG. 63 is a perspective view of the apparatus 600 and a partial axisymmetric section of the spindle 601 on which the stator S2 was completed. This figure is useful in understanding the operation of the fork-shaped elements 611. Two fork-shaped elements 611 are used for each sector 110 of the yoke 101′, at the axial ends of the sector 110. The radially outer end 611′ of each fork-shaped element 611 has a tooth defining an undercut with an edge 110′ (FIG. 65) of the respective sector 110 of the yoke 101″, for restraining it on the spindle 601 while assembling the stator S2. The opposite end of the fork-shaped element 611 also has a tooth 611″ intended for engaging a corresponding tooth of a lever 612 present on the spindle 601. In practice, the spindle 601 is provided with as many levers 612 as the number of fork-shaped elements 611 to be engaged. The levers 612 extend radially from the hub of the spindle 601 and are hinged on pins 613 oriented circumferentially on the spindle 601. The levers 612 are counteracted by springs 613′, so that they initially move back when they are engaged by the end 611″ of a fork-shaped element 611 and then snap into a restraining position, with a tooth 612′ of the lever 612 engaging the tooth 611″ of the fork-shaped element 611. In order to achieve the opposite effect, i.e. the disengagement of the fork-shaped elements 611, it is sufficient to impart a thrust to the levers 612 from the outside, along the rotation axis 603, to cause the rotation of the levers 612 and disengage the teeth 611″.

The elements 611 are fork-shaped because the legs 614 extend from opposite sides with respect to the linear portions 4a, 4b of the coils 4 whenever the latter are inserted into the stator slots 106; in other words, the fork-shaped elements 611 straddle the linear portions 4a, 4b of the coils 4 to engage the levers 612 of the spindle 601.

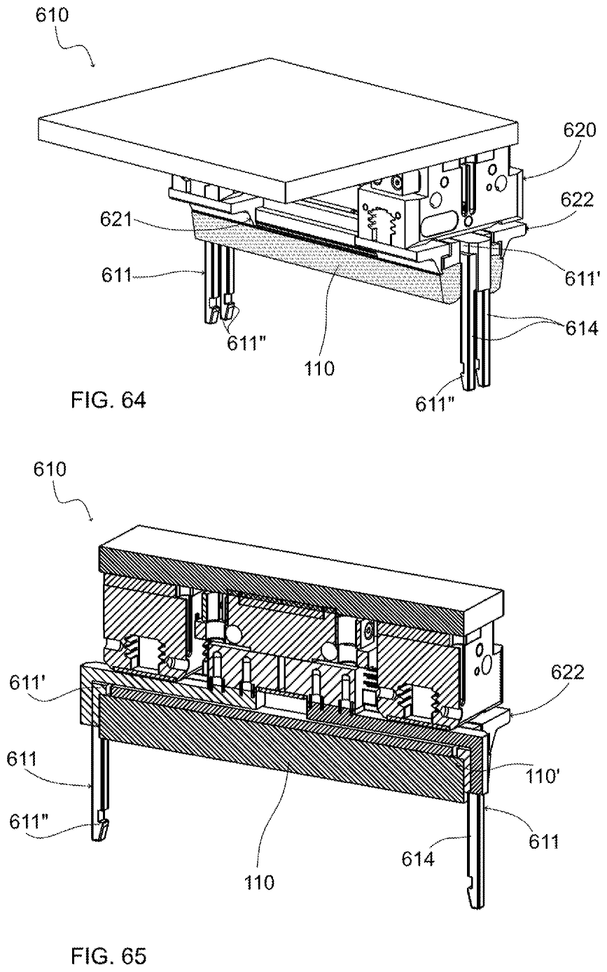

FIG. 64 is a perspective view of the system 610 for manipulating sectors 110 of the yoke 101″ and FIG. 65 is a sectional longitudinal and elevation view of the system 610 itself. In these two figures, the manipulation system 610 is shown while restraining a sector 110 of the yoke 101″. In practice, the manipulation system 610 comprises a gripper 620 provided with two jaws 621, 622 mutually movable closer to and away from one another for respectively restraining and releasing an individual sector 110 of the yoke 101″. The operation of the jaws 621, 622 can be electric or pneumatic.

As can be noted in FIGS. 64 and 65, each sector 110 of the yoke 101″ is moved by the system 610 with the fork-shaped elements 611 already coupled, i.e. pre-installed so that the upper tooth 611′ of the fork-shaped elements 611 engages the upper border 110′ of the sector 110 of the yoke 101″, and the legs 614 of each fork-shaped element 611 extend downward cantileverly, with the teeth 611″ accessible.

Initially, as shown in FIG. 66, the star 100 of the stator S2 is moved closer to the spindle 601 along the rotation axis 603, so that the stator teeth 104 are directed radially towards the outside and the stator slots 106 are radially arranged with respect to the rotation axis 603. The spindle 601 is stationary and the radial seats 605, into which the fork-shaped elements 611 are precisely radially inserted, are visible thereon. The gripper system 400 is ready with a coil 4. The manipulation system 610 is also ready with a sector 110 of the yoke 101″ and with two corresponding fork-shaped elements 611 pre-positioned on the sector 110.

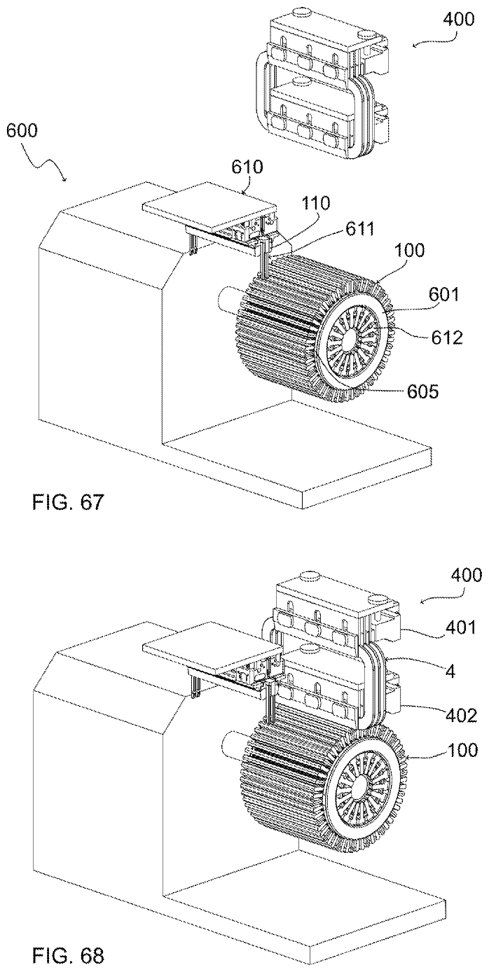

FIG. 67 shows a successive configuration over time with respect to the configuration shown in FIG. 66. The star 100 was fit on the spindle 601. It should be noted that the radial openings 605 stay at least partly uncovered, i.e. not intercepted by the star 100, for the insertion of the fork-shaped elements 611.

FIG. 68 shows a successive configuration over time with respect to the configuration shown in FIG. 67. The gripper system 400 is alongside the star 100 kept stationary by the spindle 601. The lower gripper 402 has lowered to the height of the tips 108 of the stator teeth 104 (FIG. 32), possibly abutting. In this position, the linear portions 4b of the coil 4 are ready for being inserted into the stator slots 106 arranged radially.

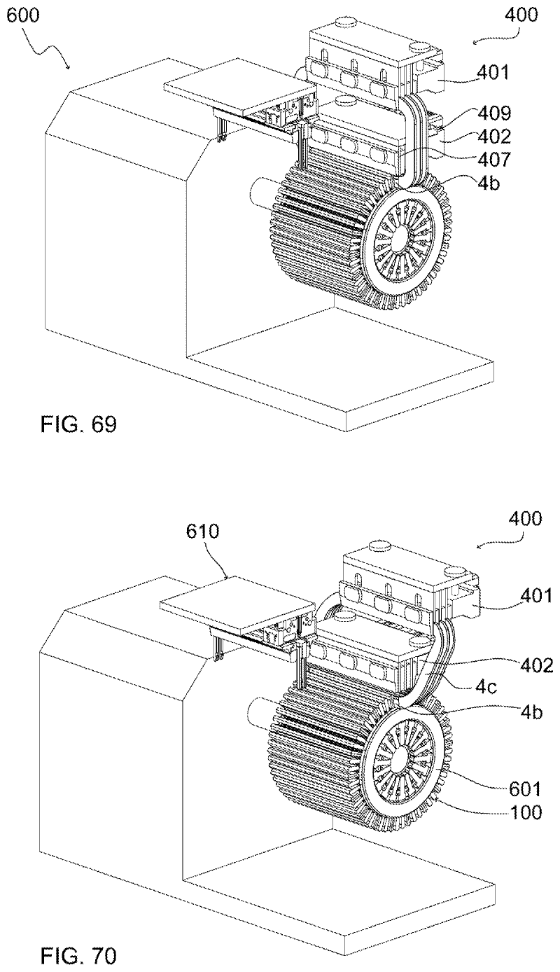

FIG. 69 shows a successive configuration over time with respect to the configuration shown in FIG. 68. The lower gripper 402 was operated to push the linear portions 4b of the coil 4 into the respective stator slots 106 of the star 100. In particular, the vertically movable plate 409 was lowered, thus causing the ejector elements 407 to be lowered. Simultaneously, the upper gripper 401 was lowered of a length corresponding to the run of the ejector elements 407 for not deforming the coil 4. The spindle 601 and the star 100 stay stationary.

FIG. 70 shows a successive configuration over time with respect to the configuration shown in FIG. 69. The spindle 601 and the star 100 still stay stationary. The upper gripper 401 moves back, staying at the same height, to make room for the manipulation system 610 which must move above the lower gripper 402. The displacement of the upper gripper causes the deformation of the coil 4 at the headers, i.e. at the non-linear portions 4c, while the linear portions 4b stay undeformed inside the stator slots 106 into which they were inserted, and the linear portions 4a stay undeformed between the jaws of the upper gripper 401. The coming out of the linear portions 4b of the coil 4 from the stator slots 106 is prevented by the same lower gripper 402 which temporarily closes the stator slots 106.

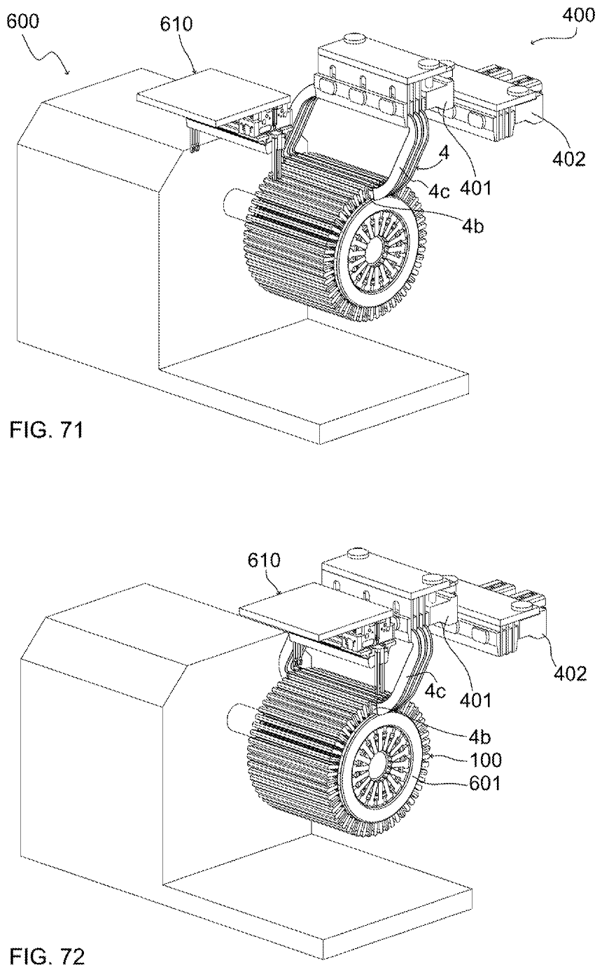

FIG. 71 shows a successive configuration over time with respect to the configuration shown in FIG. 70. The spindle 601 and the star 100 still stay stationary. The upper gripper 401 stays stationary with respect to the retracted position described with reference to FIG. 70. The lower gripper 402 is also retracted and moved away through the coil 4, passing below the upper gripper 401. In this configuration, there is no risk that the linear portions 4b of the coil 4 can come out from the stator slots 106, since the coil 4 has already been deformed at the non-linear portions 4c and is not subjected to stresses which can return the linear portions 4b towards the linear portions 4a.

FIG. 72 shows a successive configuration over time with respect to the configuration shown in FIG. 71. The spindle 601 and the star 100 still stay stationary; the grippers 401 and 402 also stay stationary with respect to the position shown in FIG. 71. At this point, the manipulation system 610 goes above the stator slots 106 of the star 100 that accommodated the linear portions 4b of the coil 4.

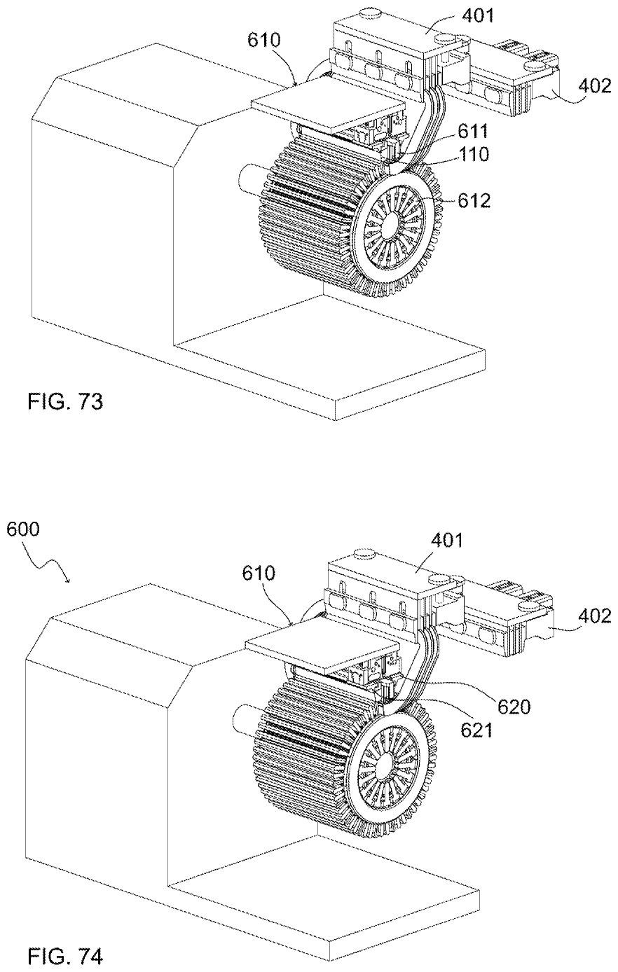

FIG. 73 shows a successive configuration over time with respect to the configuration shown in FIG. 72. The spindle 601 and the star 100 still stay stationary. The manipulation system 610, previously aligned with the stator slots 106 into which the linear portions 4b of the coil 4 were inserted, is lowered until brining the sector 110 of the yoke 101″ in abutment against the pointed ends 108 of the stator teeth 104 of those stator slots 106. Simultaneously, the fork-shaped elements 611 are inserted into the radial seats 605 (FIGS. 62-65), thus making the levers 612 snap. More in particular, the legs 614 of the fork-shaped element 611 are inserted into the respective radial seats 605 present in the spindle 601 and engage the lower teeth 611″ with the teeth 612′ of the levers 612 present on the spindle 601 (FIG. 63), thus making the levers 612 swing around the respective pin 613.

FIG. 74 shows a successive configuration over time with respect to the configuration shown in FIG. 73. The spindle 601 and the star 100 still stay stationary. The manipulation system 610, previously lowered until bringing the sector 110 of the yoke 101″ in abutment against the pointed ends 108 of the stator teeth 104 of the stator slots 106 that accommodated the linear portions 4b of the coil 4, stays stationary. The sector 110 of the yoke 101″ is restrained on the spindle 601 by the fork-shaped elements 611. The jaws 621 and 622 of the manipulation system 610 open to disengage the sector 110 of the yoke 101″ which, at this point, is no longer constrained to the system 610 but stays hooked to the star 100 by means of the fork-shaped elements 611.

FIG. 75 shows a successive configuration over time with respect to the configuration shown in FIG. 74. The spindle 601 and the star 100 still stay stationary. The manipulation system 610 previously unconstrained from the sector 110 of the yoke 101″ is moved away from the gripper system 400 and the spindle 601. The upper gripper 401 of the gripper system 400 is still gripping on the linear portions 4a of the coil 4, while the linear portions 4b are definitively encapsulated in the stator slots 106, now closed by the sector 110 of the yoke 101″.

FIG. 76 shows a successive configuration over time with respect to the configuration shown in FIG. 75. The spindle 601 rotates (anticlockwise in the figure), thus dragging the star 100 by an angle corresponding to an electric phase of the stator S2. Simultaneously, the upper gripper 401 is lowered to facilitate the deformation of the non-linear portions 4c of the coil 4 and the manipulation system 610 takes a new sector 110 of the yoke 101″ by the respective prearranged fork-shaped elements 611. In particular, the upper gripper 401 goes at the pointed ends 108 of the stator teeth 104, or in abutment against them, ready to release the linear portions 4a of the coil 4.

The rotation of the spindle 601 is thus intermittent and alternated with the insertion movements of the grippers 401.

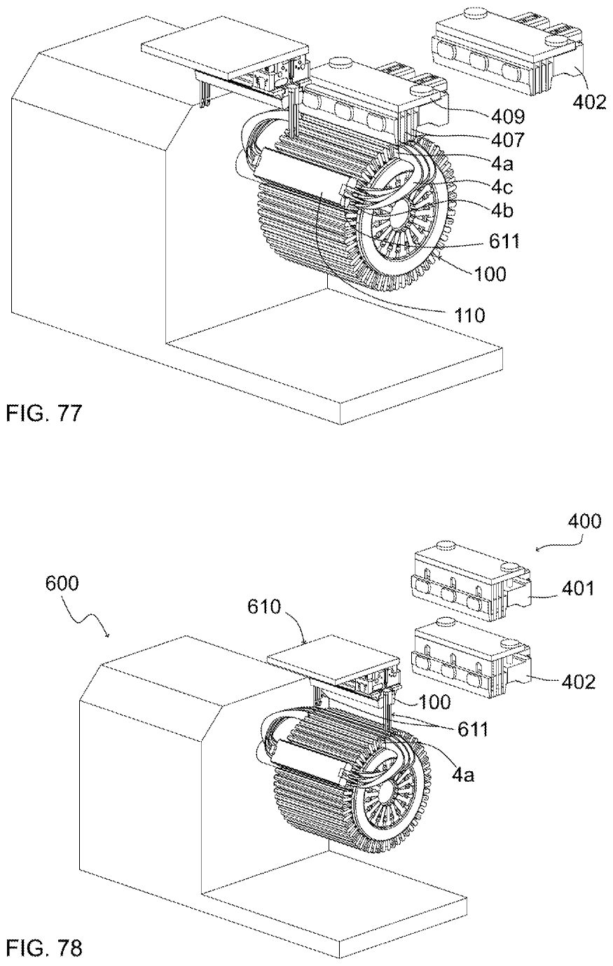

FIG. 77 shows a successive configuration over time with respect to the configuration shown in FIG. 76. The spindle 601 and the star 100 stay stationary with respect to the position previously assumed (FIG. 76). The plate 409 of the upper gripper 401 was lowered, thus causing the lowering of the ejector elements 407 and the insertion of the linear portions 4a of the coil into corresponding stator slots 106.

FIG. 78 shows a successive configuration over time with respect to the configuration shown in FIG. 77. The spindle 601 and the star 100 stay stationary with respect to the position previously assumed (FIG. 76). The gripper system 400 is moved away from the spindle 601 and the upper 401 and lower 402 grippers are opened and prepared for taking a new coil of the winding tool 20. The manipulation system 610 brings a new sector 110 of the yoke 101″ above the stator slots 106 that accommodated the linear portions 4a of the coil 4.

FIG. 79 shows a successive configuration over time with respect to the configuration shown in FIG. 78. The spindle 601 and the star 100 stay stationary with respect to the position previously assumed (FIG. 77). The manipulation system 610 rests the new sector 110 of the yoke 101″ on the stator slots 106 that accommodated the linear portions 4a of the coil 4 and pushes the fork-shaped elements 611 to be engaged with the levers 612 of the spindle 601 to restrain the sector 110 on the star 100.

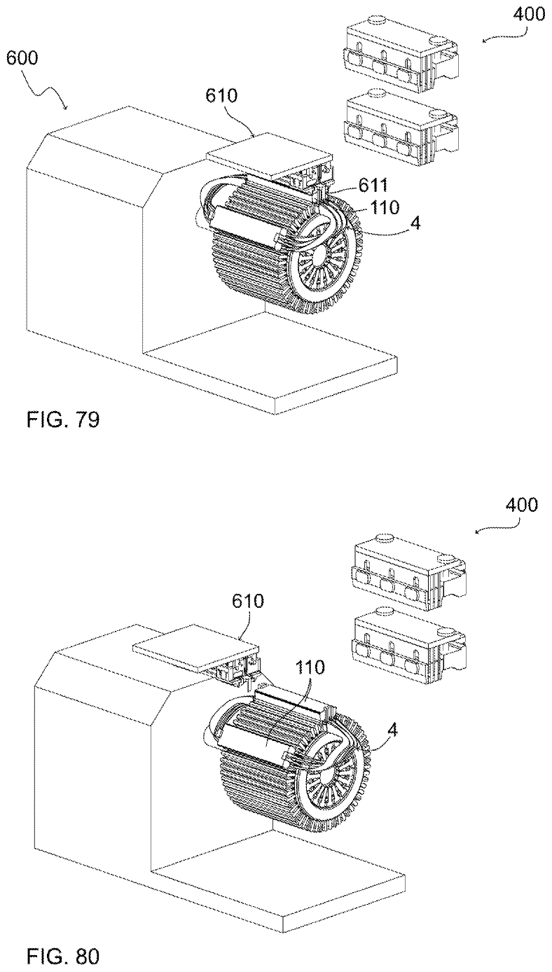

FIG. 80 shows a successive configuration over time with respect to the configuration shown in FIG. 79. The spindle 601 and the star 100 stay stationary with respect to the position previously assumed (FIG. 79). The manipulation system 610 released the new sector 110 of the yoke 101″ and moves away to take another sector 110 of the same yoke 101″. Now, the coil 4 is properly inserted into the star 100: the linear portions 4a and 4b are restrained in the respective stator slots 106 by the two sectors 110 of the yoke 101″ and by the four fork-shaped elements 611 engaging the respective levers 612.

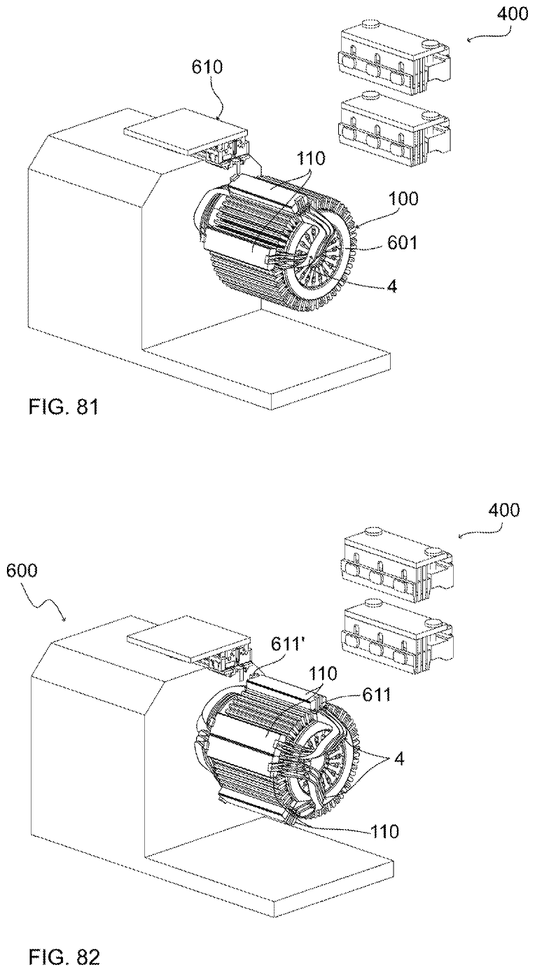

FIG. 81 shows a successive configuration over time with respect to the configuration shown in FIG. 80. The spindle 601 and the star 100 are rotated (anticlockwise) by an angle sufficient for providing, to the gripper system 400, other stator slots 106 to be filled with the linear portions 4b of a new coil 4 and are then once again stopped for staying stationary.

At this point, the steps described in the previous figures are repeated to complete the winding of the star 100.

FIG. 82 shows a successive configuration over time with respect to the configuration shown in FIG. 81, with two coils 4 positioned on the star 100 and four sectors 110 of the yoke 101″ anchored to the spindle 601, thanks to the levers 612.

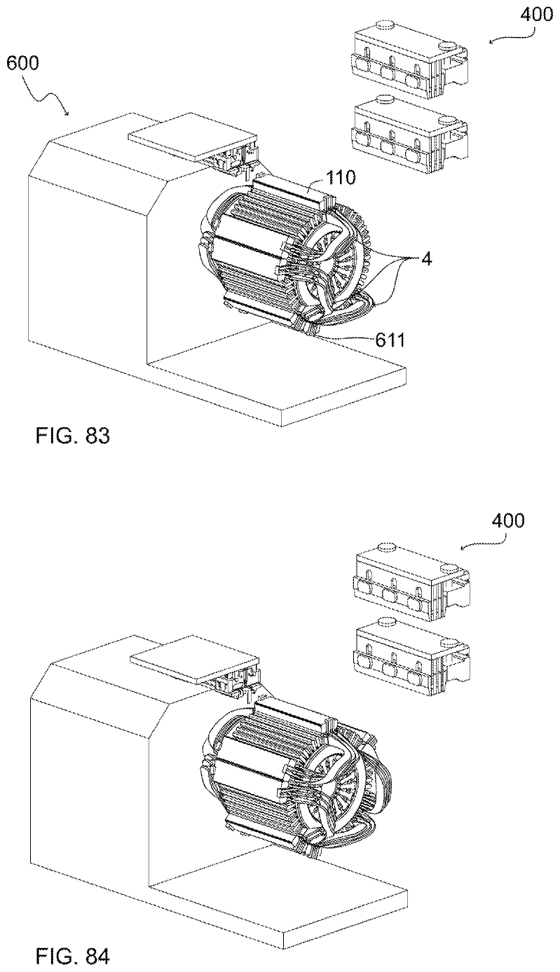

FIG. 83 shows a successive configuration over time with respect to the configuration shown in FIG. 82, with three coils 4 positioned on the star 100 and six sectors 110 of the yoke 101″ anchored to the spindle 601, thanks to the levers 612.

FIG. 84 shows a successive configuration over time with respect to the configuration shown in FIG. 83, with four coils 4 positioned on the star 100 and eight sectors 110 of the yoke 101″ anchored to the spindle 601, thanks to the levers 612.

The insertion of each new coil occurs according to the electrical layout and, thus, the steps of the stator S2; the angular offset between the linear portions 4a, 4b of all coils are electrically corrected.

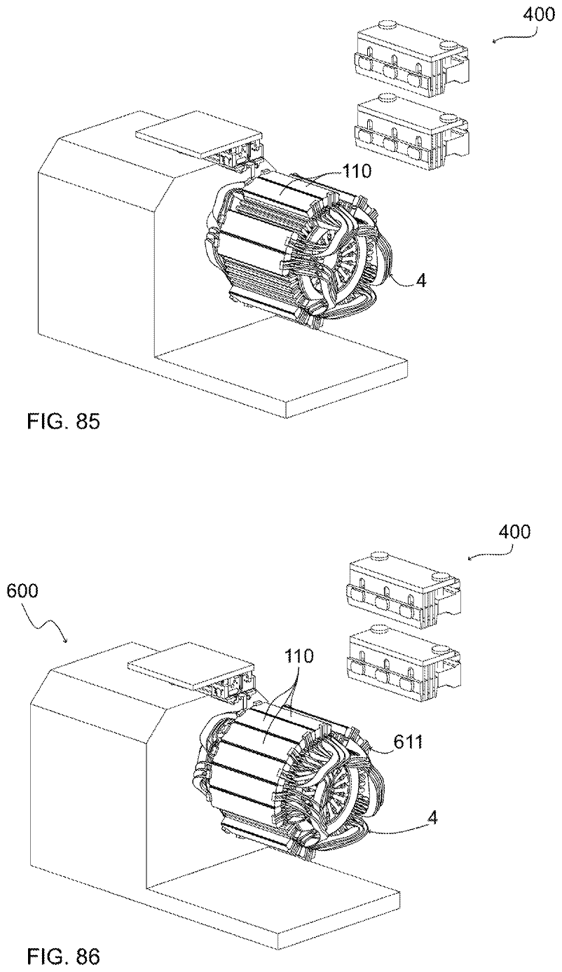

FIG. 86 shows a successive configuration over time with respect to the configuration shown in FIG. 85, with five coils 4 positioned on the star 100 and ten sectors 110 of the yoke 101″ anchored to the spindle 601.

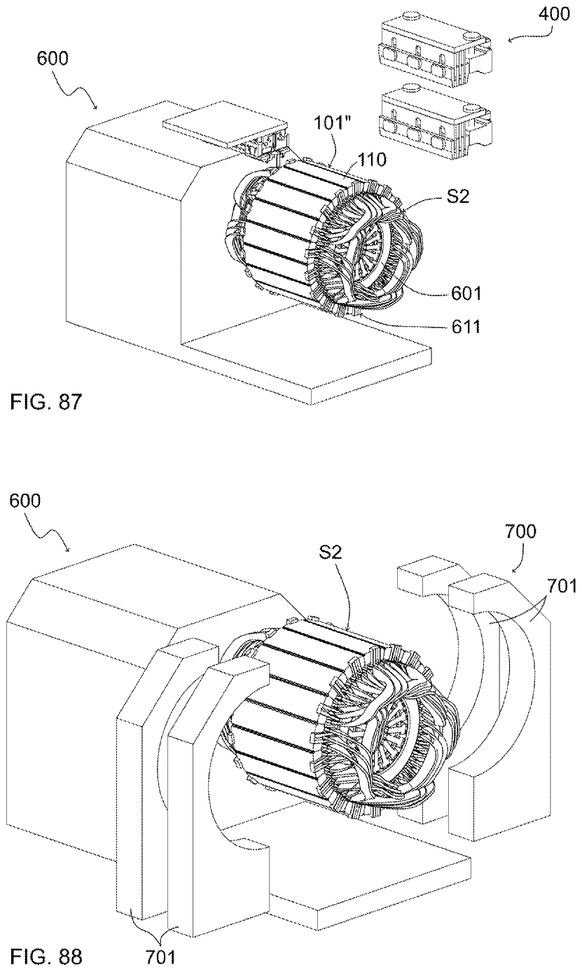

FIG. 87 shows the winding S2 completed with all windings. Nine coils 4, each with three linear portions 4a and three linear portions 4b and eighteen sectors 110 of the yoke 101″, were used in the example of the figure. Clearly, each sector 110 intercepts an angle at the center equal to 20°. All sectors 110 are anchored to the spindle 601 with the fork-shaped elements 611 and the yoke 101″ is completed. Now, the stator S2 just has to be pulled out of the spindle 601.

FIG. 88 shows the start of the removal. The spindle 601 and the stator S2 are stationary. The jaw system 700 is operated: the jaws 701 move closer for gripping the stator S2.

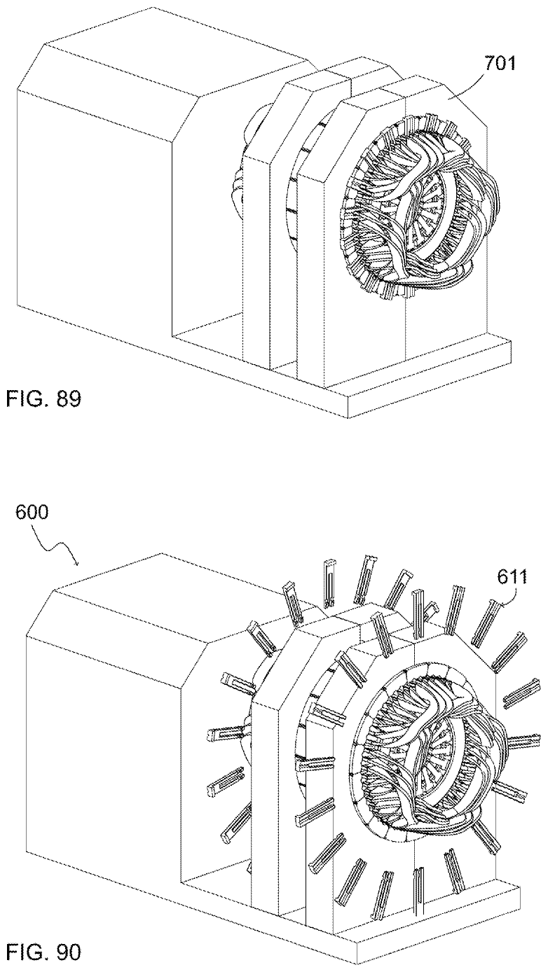

FIG. 89 shows the jaws 701 closed on the yoke 101″ of the stator S2, with the spindle 601 stationary.

At this point, as shown in FIG. 90, the fork-shaped elements 611, which restrained the sectors 110 on the spindle 601 up to this moment, are removed. The removal occurs by exerting a thrust on the levers 612 in axial direction, by appropriate means (not shown), for counteracting the thrust of the springs 613′ shown in FIG. 63.

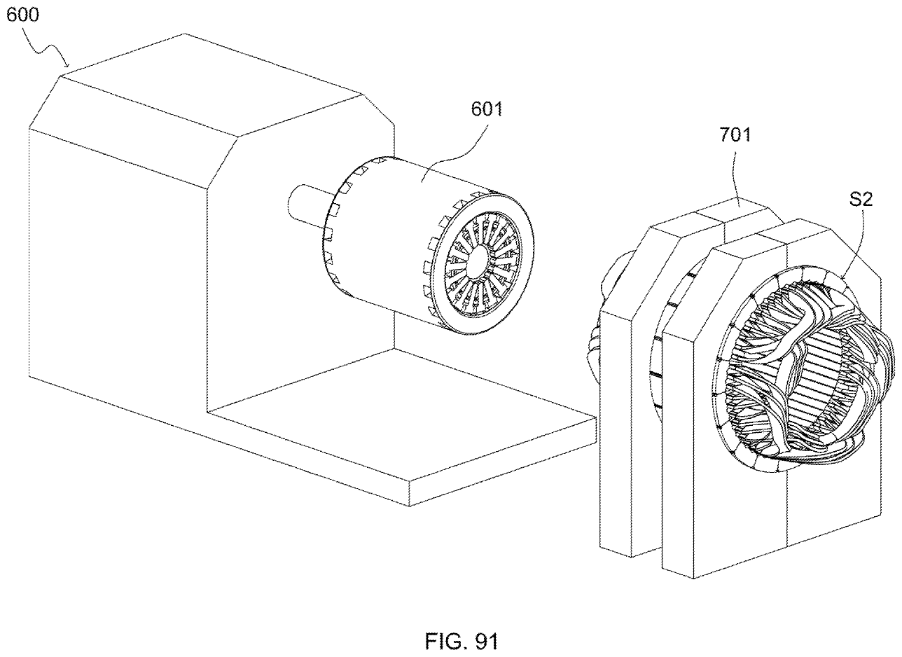

FIG. 91 shows the final step of pulling out the stator S2 of the spindle 601, which is now ready to start a new cycle for manufacturing a new stator S2. The yoke 101″ stays closed in the jaws 701 until the yoke 101″ is wrapped by appropriate means, for example metal straps; at this point, the jaws 701 open to release the stator S2.

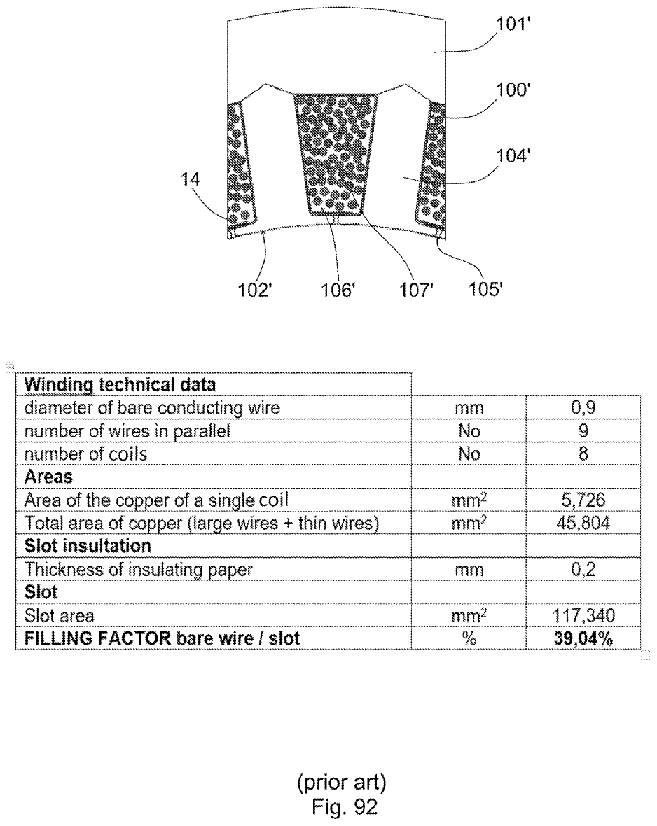

FIG. 92 is a schematic view of a layout for winding a star yoke stator according to the known art (a stator portion in cross section), similar to that of the stator of the motor M shown in FIG. 30. As can be noted, the winding 107′ inserted into the stator slots 106′ is not orderly: the conducting wires 14 are arranged randomly. The table of FIG. 92 details the technical characteristics of the winding by setting forth, for example, the diameter of the conducting wire 14 equal to 9.9 mm, the number of parallel wires arranged, the number of loops, the areas, the thickness of the insulating paper, the area of the stator slot 106′ equal to 117.340 mm².

This configuration, currently one of the most popular, reaches a filling factor (bare wire/slot) equal to about 39%.

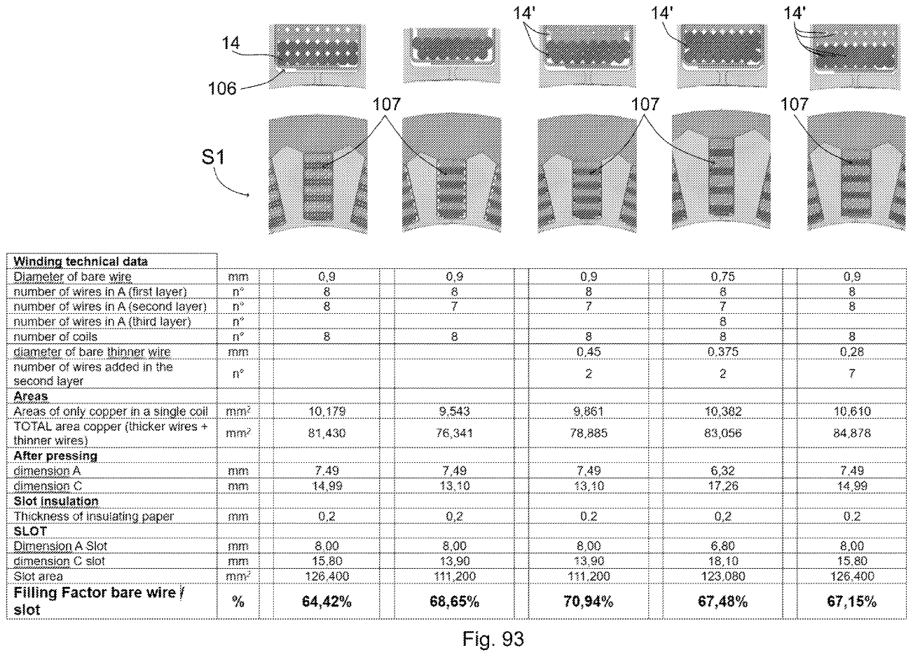

FIG. 93 is a view of five possible layouts for winding a star yoke stator S1 according to the present invention, in a cross sectional view of a stator slot 106, and further comprises a table of the technical requirements of the windings of each layout.

The difference from the configuration of the known art shown in FIG. 92 is immediately clear: the method and the apparatus according to the present invention allow to form windings 107 in which the conducting wire (main) 14 and possibly a conducting wire (complementary) 14′ of smaller diameter are arranged in an orderly way, according to the desired layout and made unchangeable thanks to the carburizing and pressing of the coils 4 described previously.

In the table, the diameter of the conducting wires 14, 14′ and other parameters are stated for each of the five layouts. The conducting wires 14, 14′ were pressed and carburized according to the description with reference to FIGS. 1-29. A thickness of 0.2 mm was considered for the insulating paper arranged between the windings 107 and the stator slot 106.

As can be noted by reading the last line below, the filling factor always is always above 64% for all layouts and almost reaches 71% in the third winding layout, in which eight-seven conducting wires 14 were provided for each layer, with a diameter of 0.9 mm, eight loops in total, two complementary wires 14′ with a diameter of 0.45 mm.

A rectangular stator slot 106 was considered in the examples shown. The dimensions are stated for each stator slot 106 of the different layouts.

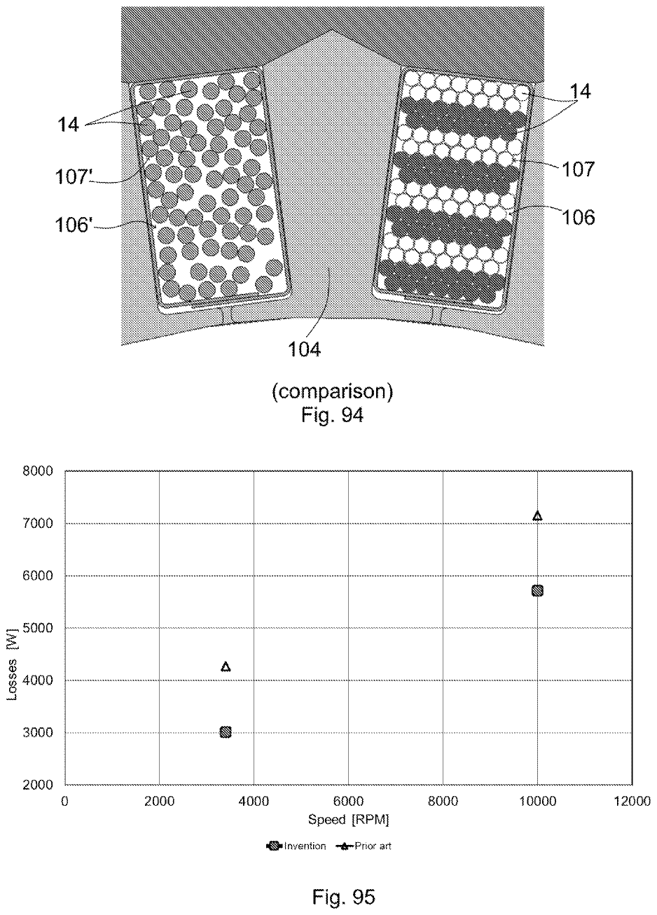

FIG. 94 is a cross sectional view of a portion of a hypothetic star yoke stator, with a stator slot 106′ (to the left) filled in the conventional way, compared to an identical stator slot 106 (to the right) filled with the method according to the present invention. The slots 106′ and 106 are identical and defined by the same star and by the same yoke. Although hypothetical, this image clearly shows the difference, with reference to the arrangement of the conducting wires 14, between the known solutions and the present invention, and makes it clear how the stators S1, S2 manufactured according to the method claimed are actually recognizable compared to the stators manufactured according to the known art. The following are housed in a slot having an area (in cross section) equal to 117.34 mm²:
in the slot 106′ to the left, eight loops of a winding formed by nine parallel copper wires 14 of a diameter equal to 0.9 mm (the outer diameter of the resin-coated wire 0.987 mm), for a total of seventy two wires for each slot 106′. A filling factor of about 39% is achieved in this configuration;
in the slot 106 to the right, eight loops of a winding formed by seven-eight parallel copper wires 14 of a diameter equal to 0.9 mm (the outer diameter of the resin-coated wire 0.987 mm), for a total of one hundred twenty wires for each slot 106. A filling factor of about 68.6% is achieved in this configuration.

In the left slot 106′, the conducting wires 14 are grouped but with a chaotic arrangement, not orderly; on the contrary in the right slot 106, the conducting wires 14 are grouped with an orderly arrangement, the same arrangement is achieved and kept in the linear portions 4a and 4b of the coil 4 used to make the winding object of the present invention. The orderly arrangement of the conducting wires 14 in the right slot 106 is equivalent to the one visible in FIG. 93. The diameter of the conducting wires 14 and the geometry of the stator slot being equal, in the left slot 106′, the filling factor is about 39% and the filling factor is about 68.6% in the right slot 106, i.e. significantly greater (more than 20%).

The present description provides sufficient information for distinguishing a stator directly formed with the method of the present invention from stators formed with the known arts. It is in fact clear that the filling factor is definitely greater and, especially in the stator S1, S2 according to the present invention, the arrangement of the conducting wires 14 in the slots 106 between the teeth 104 is orderly, in a way not found in the known art. In particular, by observing FIGS. 93-94, it can be noted that the conducting wires 14 are arranged in multiple loops, each loop being constituted by a certain number of wires (6, 7, 8, etc.) with an orderly matrix layout that cannot be changed. The stator S1, S2 is thus recognizable with respect to other known stators, simply by observing the number and arrangement of the conducting wires in the slots between the stator teeth.

FIG. 95 is a diagram of the leakage currents in the stator windings (ordinate) with respect to the number of revolutions (abscissa) of a motor made with a star yoke stator S′ according to the known art and of a motor made with a star yoke stator S1 according to the present invention, other technical characteristics being equal.

The comparison was carried out under equal conditions: same motor power/size, same standard rotor, same winding stack height, etc.

At 3400 revolutions per minute (RPM), the rated speed being considered herein, the conventional motor is affected by leakage currents in the stator windings of a value equal to 4270.205 W, whereas the motor with the stator S1 according to the present invention is affected by leakage currents equal to 3016.136 W; this is a better value of about 29.7%.

At 10,000 revolutions per minute (RPM), considering here the maximum speed, the conventional motor is affected by leakage currents in the stator windings of a value equal to 7155.682 W, the motor with the stator S1 according to the present invention is affected by leakage currents equal to 5716.293 W. This is a better value of about 20.1%.

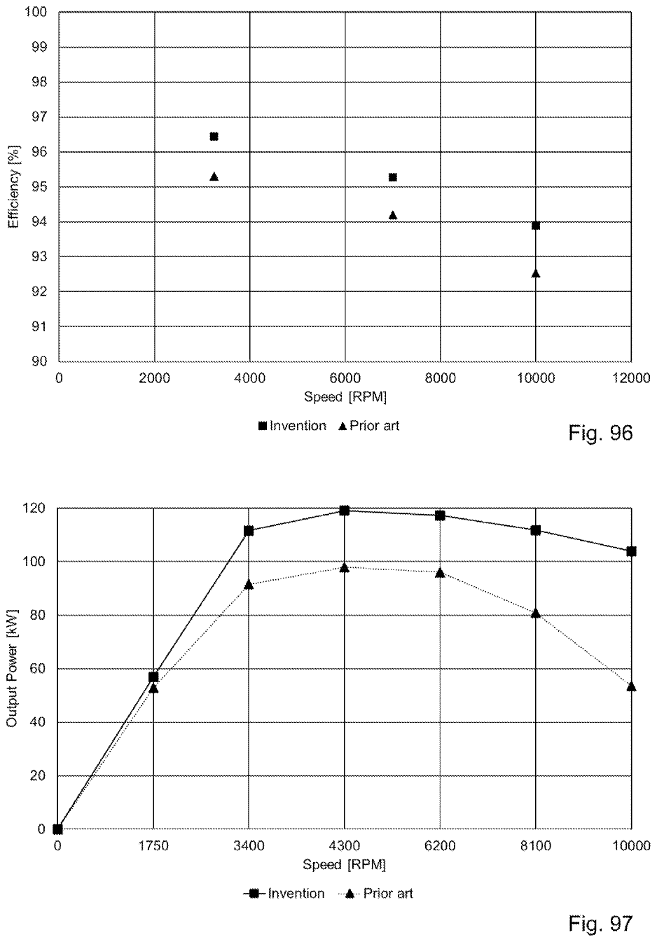

FIG. 96 is a diagram of the efficiency (ordinate) with respect to the number of revolutions (abscissa) of a motor made with a star yoke stator according to the known art and of a motor made with a star yoke stator according to the present invention, all conditions being equal.

The comparison was carried out under the same conditions: same motor power/size, same slot area, same standard rotor, same winding stack height, etc.

At 3250 revolutions per minute (RPM), the rated speed being considered herein, the conventional motor has an efficiency equal to 95.3%, the motor with the stator S1 according to the present invention has an efficiency equal to 96.4%; this is a better value of about 1.1%.

At 7000 revolutions per minute (RPM), the conventional motor has an efficiency equal to 94.2%, the motor with the stator S1 according to the present invention has an efficiency equal to 95.2%; this is a better value of about 1.1%.

At 10,000 revolutions per minute (RPM), the maximum speed being considered herein, the conventional motor has an efficiency equal to 92.5%, the motor with the stator S1 has an efficiency equal to 93.9%; this is a better value of about 1.45%.

FIG. 97 is a diagram of the output power (ordinate) with respect to the number of revolutions (abscissa) of a motor made with a star yoke stator according to the known art and of a motor made with a star yoke stator according to the present invention, all conditions being equal.

The comparison was carried out under the same conditions: same motor power/size, same slot area, same standard rotor, same winding stack height, etc.

As can be noted, the motor of the present invention, made with the stator S1, produces even greater power with respect to the motor based on the standard insertion of the windings. Observing FIG. 97, the difference is noticeable already at 1750 revolutions per minute and becomes evident beyond 3400 revolutions per minute. The following comparative table provides a quantitative comparison:

Comparative table

| Rotation | Output power, motor | Output power, motor |
|---|---|---|
| speed | of the invention | of the known art |
| [RPM] | [kW] | [kW] |
| 0 | 0 | 0 |
| 1750 | 56.9 | 52.8 |
| 3400 | 111.6 | 91.5 |
| 4300 | 119.1 | 97.9 |
| 6200 | 117.3 | 96 |
| 8100 | 111.8 | 80.8 |
| 10000 | 103.9 | 53.50 |

Thus, ultimately, the apparatus and the method according to the present invention allow to make stators and thus, electric motors which, for given sizes and substantial geometries, have significantly better performance than solutions obtained with conventional winding techniques.

1. A method of manufacturing a two-component stator with distributed winding, named star yoke stator,
the stator comprising:
an outer body, named yoke, and
a body inside the yoke, named star, having an inner cylindrical surface defining a housing volume of the rotor of an electric motor and a plurality of radial stator teeth jutting out from the cylindrical surface towards the yoke and between which there are stator slots intended to accommodate windings of a conducting wire,
the method comprising:
making coils of conducting wire, wherein one or more conducting wires are wound on a winding tool so that to form at least one coil comprising at least one linear portion which in turn comprises a plurality of individual linear portions of conducting wire and which is adapted to be inserted into one of said stator slots;
supporting the star on a rotation axis with at least one first stator slot accessible to a manipulator of the coils;
inserting, by means of the manipulator, a first linear portion of the coil into the at least one first stator slot and restraining a second linear portion of the coil;
rotating the star about said rotation axis by an angle, thus deforming the coil at the portions comprised between the linear portions, and making at least one second stator slot accessible to the manipulator;
inserting, by means of the manipulator, a second linear portion of the coil into the at least one second stator slot;
repeating steps D, E and F until completing the winding of the star, thus having inserted a linear portion of a coil into each stator slot;
constraining the star to the yoke.

2. Method according to claim 1, wherein during step E, the star is rotated by an angle corresponding to the angle between the first stator slot and the second stator slot, which slots can be adjacent or non-adjacent, and wherein, during steps D and F, the star is kept stationary, and wherein step E is alternated with any step D or F.

3-8. (canceled)

9. Method according to claim 1, further comprising a step of insulating the conducting wires, wherein an electrically insulating layer:
is applied at least on said linear portions of the coil, possibly after a pressing and/or carburizing step, whenever provided, or
is applied between said stator teeth before said step D of inserting linear portions of the coil.

10. Method according to claim 1, wherein, in said coil making step, a series of multiple coils is made on the same winding tool, so that a linear portion of a coil is spaced from the linear portion of the successive coil by a predetermined pitch distance.

11. Method according to claim 10, wherein:
before step E and during the inserting step D, first linear portions of the series of coils are contemporaneously inserted into corresponding stator slots of the star and,
after step E, second linear portions of the series of coils are contemporaneously inserted into corresponding stator slots of the star, so that the corresponding winding is distributed among multiple stator slots.

12. Method according to claim 1, wherein, between steps D and E, and between steps F and G, it is provided:
(D′, F′) to temporarily close the stator slot with the respective linear portion of the coil therein by means of a closing device of the stator slots which is movable between a retracted position, at which the stator slot is open in radial direction and is accessible to the manipulator, and a forward position, at which the stator slot is closed in radial direction and the linear portion of the coil is prevented from coming out.

13. Method according to claim 1, wherein, during the inserting step D, the first linear portions of each coil are kept coplanar to second linear portions by the manipulator.

14. Method according to claim 1, wherein steps C and G are carried out by supporting the star on a spindle and within a cylindrical surface of a winding apparatus, wherein the cylindrical surface has a longitudinal opening which provides access in radial direction to the first stator slots of the star, whereby only the stator slots into which to insert the linear portions of a coil from time to time stay accessible from the outside, whereas the rest of the star stays confined between the spindle and the cylindrical surface.

15. Method according to claim 14, wherein steps D and F are carried out by bringing the stator slots intended to accommodate the linear portions of the coil at the longitudinal opening, by a rotation of the star, and by keeping the star stationary during the insertion of the linear portions.

16. (canceled)

17. Method according to claim 1, wherein the yoke is made like a set of sectors, and step H is achieved by constraining a sector of yoke to the star, by means of a manipulation system for manipulating sectors of the yoke in sequence between steps E and F and between steps F and G, at the stator slots into which a linear portion of coil was inserted, thus achieving the closing of the stator slots from the outside.

18. Method according to claim 17, wherein step H is carried out by temporarily constraining the sectors of the yoke both to the star and a spindle onto which the star is supported, by means of removable fastening elements, and the completed yoke is kept together by a jaw system.

19. A two-component stator, named star yoke stator, directly obtained with the method according to claim 1.

20. An electric motor comprising a two-component stator according to claim 19.

21. An apparatus (500, 600) for making a star yoke stator,
the stator comprising:
an outer body, named yoke, and
a body inside the yoke, named star, having an inner cylindrical surface defining a housing volume of the rotor of an electric motor and a plurality of radial stator teeth jutting out from the cylindrical surface towards the yoke and between which there are stator slots intended to accommodate windings of a conducting wire,
the apparatus (500, 600) comprising:
at least one winding tool configured to carry out step A, wherein one or more conducting wires are wound on the winding tool so that to form coils comprising at least one linear portion which in turn comprises a plurality of individual linear portions of conducting wire and which is adapted to be inserted into one of said stator slots;
a spindle (501, 601) rotatable about a rotation axis and lockable in a plurality of angular positions, configured to:
support the star with at least one first stator slot of the star accessible to a manipulator of the coils, and to
rotate the star by an angle corresponding to making at least one second stator slot accessible to the manipulator of the coils, possibly deforming the coil at the portions comprised between the linear portions during step E,
a manipulator of the coils, which is configured to carry out step D by inserting a first linear portion of the coil into the corresponding stator slot and restraining a second linear portion of the same coil, and to carry out step F by inserting a second linear portion of the coil into the corresponding stator slot,
wherein the spindle is susceptible to intermittent rotations alternated with the movements of the manipulator for inserting linear portions of the coil.

22-25. (canceled)

26. Apparatus (500, 600) according to any claim 21, wherein the manipulator of the coils comprises a first gripper, or upper gripper, and a second gripper, or lower gripper, wherein the lower gripper is configured to take the first linear portions of a coil from the winding tool, to restrain and eject them into the first stator slots, and wherein the upper gripper is configured to take the second linear portions of a coil from the winding tool, to restrain and eject them into second stator slots.

27. Apparatus according to claim 26, wherein the upper gripper and the lower gripper are movable with respect to one another between:
an initial coplanar position, at which the coil is not deformed, and
a plurality of staggered positions, in which the grippers are on different planes and/or at different heights, to allow a linear portion of the coil at a time to be inserted into the stator slots at different angular positions of the star of the stator (S1) being assembled.

28. (canceled)

29. Apparatus according to claim 21, comprising a supporting structure to which the spindle is constrained, a carriage movable with respect to the spindle and/or the supporting structure between:
a first position at which the carriage does not intercept the spindle, and the star supported on the spindle is not confined in the carriage, and
a second position at which the carriage extends around the spindle and encloses the star supported on the spindle.

30. Apparatus according to claim 29, wherein the carriage has an inner cylindrical surface complementary to the star supported on the spindle and open outwardly at a longitudinal opening through which the manipulator of the coils is inserted to house the linear portions of the coils in the respective stator slots of the star.

31. Apparatus according to claim 30, comprising a closing device configured to close the longitudinal opening temporarily and on command.

32. Apparatus according to claim 31, wherein the closing device is a slide-like, or drawer-like, device mounted aboard the carriage and provided with a panel movable between:
a retracted position at which the panel does not intercept the longitudinal opening, thus allowing the manipulator to be inserted through the longitudinal opening and into the stator slots of the star supported on the spindle, and
a forward position at which the panel intercepts the longitudinal opening, thus preventing a linear portion of a coil from coming out of the stator slots.

33. Apparatus according to claim 21, comprising a system for manipulating sectors of the yoke, which is provided with at least one gripper with jaws movable to grip/release a sector of the yoke, wherein the gripper is movable to a position for releasing the sector and at which position the sector is anchored to the star and closes one or more stator slots provided with a linear portion (4a,4b) of a coil.

34. Apparatus according to claim 33, comprising one or more fastening elements transportable by the manipulation system together with each sector of yoke and configured to keep said sector of yoke constrained to the spindle while assembling the stator, the fastening elements being removable after the assembly is completed.

35. Apparatus according to claim 34, wherein the fastening elements are fork-shaped, engage the two longitudinal ends of the sector of the yoke and are insertable into corresponding seats present on the spindle, thus straddling the linear portions of the coils inserted into the stator slots of the star.

36. Apparatus according to claim 35, wherein the fork-shaped elements engage the respective sector of yoke and have at least one tooth insertable into a seat of the spindle, wherein the spindle comprises at least one lever and said tooth snap-engages the corresponding lever, and wherein the lever is movable to release the tooth and allow the respective fork-shaped element to be released.

37. Apparatus according to claim 36, wherein the seats for inserting the fork-shaped elements are arranged circumferentially on the spindle according to a pitch proportional or corresponding to the pitch between the sectors of the yoke, and the spindle comprises for each seat at least one lever swinging on a pin, counteracted by a spring and provided with a tooth intended to engage the tooth of the respective fork-shaped element.

38. Apparatus according to claim 37, wherein the spindle is cylindrical, the levers are arranged radially on the spindle and the pins are arranged tangentially, i.e. orthogonal to the respective lever.
